(19) United States
(12) Patent Application Publication
(10) Pub. No.: US 2012/0058697 A1
(43) Pub. Date: Mar. 8, 2012

(54) CONFORMAL PARTICLE COATINGS ON FIBER MATERIALS FOR USE IN SPECTROSCOPIC METHODS FOR DETECTING TARGETS OF INTEREST AND METHODS BASED THEREON

(76) Inventors: Aaron D. Strickland, Freeville, NY (US); Juan R. Hinestroza, Ithaca, NY (US); Carl A. Batt, Groton, NY (US)

(21) Appl. No.: 13/063,388

(22) PCT Filed: Mar. 31, 2010
(86) PCT No.: PCT/US10/29438

§ 371 Date: Nov. 17, 2011

Related U.S. Application Data
(60) Provisional application No. 61/165,678, filed on Apr. 1, 2009.

(51) Int. Cl. B32B 5/02; B05D 3/10; B05D 5/06; B32B 5/16; B05D 1/00

(52) U.S. Cl. 442/59; 428/323; 427/475; 427/162

(57) ABSTRACT

Textile fibers and other fibrous substrates functionalized with particles are provided for use in the detection of targets of interest by spectroscopic methods. In one embodiment, a substrate is provided that comprises a conformal coating on its surface, wherein the coating comprises a plurality of chemically functional particles that are spectroscopically enhancing. Methods for producing such functionalized textile fibers are also provided. These textiles can be used as platforms for spectroscopic detection, including surface-enhanced Raman scattering (SERS), surface-enhanced infrared absorption (SEIRA), and surface-enhanced fluorescence (SEF). Functionalized textile fibers for use in the signature detection methods are produced by performing layer-by-layer self-assembly of particles on natural and synthetic textile substrates.

### CROSS-REFERENCE TO RELATED APPLICATIONS

This application claims priority to and the benefit of co-pending U.S. provisional patent application Ser. No. 61/165,678, entitled “Use of conformal particle coatings on fiber materials in spectroscopic methods for detecting targets of interest,” by Aaron Strickland, filed Apr. 1, 2009, which is incorporated herein by reference in its entirety.

### STATEMENT REGARDING FEDERALLY SPONSORED RESEARCH OR DEVELOPMENT

The disclosed invention was made with government support under contract no. CHE-0725167 from the National Science Foundation and contract no. F06-CR02 from the U.S. Department of Commerce. The government has rights in this invention.

### TECHNICAL FIELD

This invention relates generally to applications of conformal coatings of particles on non-planar surfaces, and more specifically to methods for producing non-planar surfaces having unique optical and spectroscopic signatures for positive identification.

### BACKGROUND OF THE INVENTION

Polymers play an important role in the synthesis and applications of metal nanoparticles allowing the creation of materials with unique electronic, magnetic, optical and catalytic properties (Shenhar, R.; Norsten, T. B.; Rotello, V. M. Adv. Mater. 2005, 17, 657-669; Rotello, V. M. Nanoparticles: Building Blocks for Nanotechnology; Kluwer Academic Publishers: New York, 2004). In addition to the utilization of polymers as stabilizers during the synthesis of metal nanoparticles (NPs), to prevent agglomeration in solution (Grubbs, R. B. Polym. Reviews 2007, 47, 197-215) and for controlled interfacial assembly of metal nanoparticles (Rotello, V. M. Nanoparticles: Building Blocks for Nanotechnology; Kluwer Academic Publishers New York, 2004), the preparation of polymer-nanoparticle composites have been extensively studied (Shenhar, R.; Norsten, T. B.; Rotello, V. M. Adv. Mater. 2005, 17, 657-669). Incorporation of metal nanoparticles into polymer matrices has allowed the development of materials exhibiting unique properties arising from the nanoscale size and shape of the nanoparticles (Shenhar, R.; Norsten, T. B.; Rotello, V. M. Adv. Mater. 2005, 17, 657-669).

Metal nanoparticles have been supported on diverse substrates such as silica, metals or metal oxides, carbon, and polymers, tailored by their specific optical, electronic, catalytic, magnetic, or sensor applications (Rotello, V. M.; Building Blocks For Nanotechnology, Kluwer Academic Publishers, New York, 2004; Shipway, A. N.; Katz, E.; Willner, I., ChemPhysChem, 2000, 1, 18-52; Serp, P.; Corrias, M.; Kalck, P., Appl. Catal. A, 2003 253, 337-358). Natural cellulose fibers with nanoporous surface features have also been recently reported as substrates for the in situ synthesis of noble metal nanoparticles (He, J.; Kunitake, T.; Nakao, A., Chem. Mater., 2003, 15, 4401-4406). The metal ions were impregnated into the cellulose fibers by taking advantage of their inherent porosity followed by reduction of these ions into metal nanoparticles. The nanoporous structure and the high oxygen density of cellulose fibers appear to form an effective nanoreactor suitable for the in situ synthesis and stabilization of metal nanoparticles. A limiting feature of that approach, as revealed by the authors, is that this method is applicable only to porous cellulose fibers.

A large number of polymers have been processed into uniform fibers, with diameters in the range of several micrometers to tens of nanometers, using electrospinning techniques (Huang, Z. M.; Zhang, Y. Z.; Kotaki, M.; Ramakrishna, S. Compos. Sci. Technol. 2003, 63, 2223-2253; Li, D.; Xia, Y. Adv. Mater. 2004, 16, 1151-1170). The electrospinning process provides operational flexibility for incorporating other species into fibers. For example, metal nanoparticles have been incorporated into electrospun fibers, and unique properties of the resulted electrospun fibers were achieved by introducing these additives. Electrospun fiber mats of acrylonitrile and acrylic acid copolymers (PAN-AA) containing catalytic palladium (Pd) nanoparticles were prepared via electrospinning from homogeneous solutions of PAN-AA and PdCl₂ followed by reduction with hydrazine. The catalytic activities of the composite fibers were subsequently investigated (Demir, M. M.; Gulgun, M. A.; Menceloglu, Y. Z.; Erman, B.; Abramchuk, S. S.; Makhaeva, E. E.; Khokhlov, A. R.; Matveeva, V. G.; Sulman, M. G. Macromolecules 2004, 37, 1787-1792). Dodecanethiol-capped Au nanoparticles were mixed with PEO prior to electrospinning and one-dimensional arrays of Au nanoparticles within the electrospun nanofibers were observed (Kim, G.-M.; Wutzler, A.; Radusch, H.-J.; Michler, G. H.; Simon, P.; Sperling, R. A.; Parak, W. J. Chem. Mater. 2005, 17, 4949-4957). Ag nanoparticles have also been incorporated into various electrospun polymer fibers (Yang, Q. B.; Li, D. M.; Hong, Y. L.; Li, Z. Y.; Wang, C.; Qiu, S. L.; Wei, Y Synth. Met. 2003, 137, 973-974; Son, W. K; Youk, J, H,; Lee, S,; Park, W. H, Macromol. Rapid Commun, 2004, 25, 1632-1637; Xu, X. Y.; Yang, Q. B.; Wang Y. Z.; Yu, H. J.; Chen, X. S.; Jing, X. B. Europ. Polym. J. 2006, 42, 2081-2087; Hong, K. H.; Park, J. L.; Sul, I. H.; Youk, J. H.; Kang, T. J. J. Polym. Sci. Part B Polym. Phys. 2006, 44, 2468-2474) and these composite fibers were found to exhibit antibacterial activity (Son, W. K.; Youk, J. H.; Lee, T, S.; Park, W, H. Macromol. Rapid Commun. 2004, 25, 1632-1637; Xu, X. Y.; Yang, Q. B.; Wang Y. Z.; Yu, H. J.; Chen, X. S.; Jing, X. B. Europ. Polym. J. 2006, 42, 2081-2087; Hong, K. H.; Park, J. L.; Sul, I. H.; Youk, J. H.; Kang, T. J. J. Polym. Sci. Part B Polym. Phys. 2006, 44, 2468-2474). The formation of Ag nanoparticles was usually achieved either by reducing AgNO₃ into Ag nanoparticles in polymer solution prior to electrospinning (Yang, Q. B.; Li, D. M.; Hong, Y. L.; Li, Z. Y.; Wang, C.; Qiu, S. L.; Wei, Y Synth. Met. 2003, 137, 973-974) or by post treatments using UV radiation, heat or chemical reduction of the electrospun polymer/AgNO₃ composite fibers (Son, W, K; Youk, J. H.; Lee, T. S.; Park, W. H. Macromol. Rapid Commun. 2004, 25, 1632-1637; Xu, X. Y.; Yang, Q. B.; Wang Y. Z.; Yu, H. J.; Chen, X. S.; Jing, X. B. Europ. Polym. J. 2006, 42, 2081-2087; Hong, K. H.; Park, J. L.; Sul, I. H.; Youk, J. H.; Kang, T. J. J. Polym. Sci. Part B Polym. Phys. 2006, 44, 2468-2474).

To have the surface of the polymer fibers effectively covered with Ag nanoparticles, which is essential in applications where the amount of accessible sites is important, a large ratio of AgNO₃ relative to the polymer is usually incorporated into the polymer solution (Xu, X. Y.; Yang, Q. B.; Wang Y. Z.; Yu, H. J.; Chen, X. S.; Jing, X. B. Europ. Polym. J. 2006, 42, 2081-2087). Recently, it was reported that metal nanoparticles were synthesized on the surface of electrospun poly(4-vinylpyridine) fibers by taking advantage of the binding capability of pyridyl groups to metal ions and metal NPs (Dong, H.; Fey, E.; Gandelman, A. Chem. Mater. 2006, 18, 2008-2011).

2.1. Raman Spectroscopy and Surface-Enhanced Raman Scattering (SERS)

When light is directed onto a surface of assembled particles, the incident photons are absorbed, reflected and scattered differently depending on various properties of the particles including the elemental makeup, size, morphology, and spatial orientation. These optical properties have been extensively studied using various optical spectroscopies including infrared spectroscopy, Raman spectroscopy, fluorescence spectroscopy and reflectivity. The ability to tune the bulk optical properties of surfaces using rational assembly of particles has broad applications in positive identification of targets of interest. Positive identification via optical spectroscopic techniques can be useful in applications aimed at thwarting counterfeit items, brand verification, tagging and tracking targets of interest, friend/foe identification, and trace analyte detection.

Raman spectroscopy is a branch of vibrational spectroscopy in which the transitions between vibrational states are studied using the scattered radiation produced when a molecule absorbs a photon of light. When laser light collides with a molecule, most of the incident photons are elastically scattered with no change in frequency. The Raman effect occurs from the very small fraction of incident photons (e.g., ˜1 in every 10⁷ photons) that couple to distinct vibrational modes of the molecule, resulting in inelastically scattered radiation with a change in frequency. The energy difference between the inelastic scattered radiation and the incident light corresponds to the energy involved in changing the molecule's vibrational state. Plotting the intensity of this energy change verses the related frequency shift gives the Raman spectrum.

The Raman effect can be significantly enhanced by localizing molecules close to nanostructured noble metal surfaces (e.g., copper, silver, or gold). Typical enhancement factors are on the order of 10⁶ (Kneipp, K., et al., Ultrasensitive chemical analysis by Raman spectroscopy. Chem Rev, 1999. 99(10): p. 2957-76), and under appropriate conditions single molecule detection has been achieved (Nie, S, and S. R. Emory, Probing Single Molecules and Single Nanoparticles by Surface-Enhanced Raman Scattering. Science, 1997. 275(5303): p. 1102-6). The process is called surface-enhanced Raman scattering (SERS). The SERS effect is limited to a fairly narrow range of molecules that can make close contact with the noble metal surface (e.g., ≦50 Å). Nevertheless, this “limitation” can often be used to advantage in SERS-based analyses, that is, given the insensitivity of traditional Raman spectroscopy, analytes that are not localized near the noble metal surface are in a sense “invisible.” Combining this with the fact that air and water (and other complex sample matrices) are transparent in Raman makes for a very powerful detection platform. Furthermore, given the fact that a typical Raman (or SERS) spectrum ranges from 200 and 3500 cm-1 and Raman bands of many molecules are extremely narrow (e.g., 10-20 cm⁻¹), many different molecules can be detected simultaneously. For certain aspects of this invention focused on positive identification (e.g., friend-foe identification (ID), anti-counterfeit ID), judicious selection of the Raman-active molecules can give an infinite number of unique spectral signatures that would be impossible to forge.

2.2. Surface Enhanced Infrared Absorption (SEIRA) Spectroscopy

Similar to SERS, dramatic changes in the optical properties of molecules adsorbed on or near structured metal surfaces can also be observed using infrared spectroscopy. Surface enhanced infrared absorption (SEIRA) spectroscopy can be observed by direct mid-IR excitation of molecules that are localized close to roughened metal surfaces (e.g., molecules positioned at least ˜8 nm from namely, gold and silver nanoparticles or metal island films) (Hartstein, A., et al., Phys. Rev. Lett. 1980 45: p. 201). Specifically, direct mid-IR excitation of molecules can result in enhancement of vibrational bands that experience a change in dipole moment that is perpendicular to the roughened metal surface (Osawa, M., et al., Appl. Spectrosc. 1993, 47: p. 1497). Typically this enhancement is approximately 10¹-10³, which is much more modest than SERS enhancements, but can reveal complementary information to SERS with respect to molecular structure and can be controlled by proper orientation of the molecule to the surface. Given that the cross-section of IR absorption is much greater than that observed for Raman scattering, positive identification using SEIRA is sufficient for many applications.

2.3. Surface Enhanced Fluorescence (SEF)

Surface enhanced fluorescence (SEF) (also termed metal enhanced fluorescence or MEF) is the term for the phenomenon of the dramatic increase observed in the fluorescence emission when molecules are between ˜3 nm and 60 nm from the surface of metals (namely, silver and gold nanoparticles or island films) (Malicka, J., et al., Effects of fluorophore-to-silver distance on the emission of cyanine-dye-labeled oligonucleotides. Anal. Biochem., 2003, 315: p. 57-66). Thus, SERS or SEIRA effects have opposite distance dependency on the nanostructured surface than does the SEF effect (Champion, A., et al., Electronic energy transfer to metal surfaces: a test of classical image dipole theory at short distances. Chem. Phys. Lett., 1980, 73: p. 447-450). SEF requires the molecule to be a certain distance from the metal surface to prevent fluorescence quenching due to nonradiative energy transfer from the excited state of the molecule to the metal. The SEF phenomenon arises from the interaction of the dipole moment of the fluorophore and the surface plasmon of the metal. This interaction can lead to an increase in radiative decay and an increase in fluorescence efficiency (Lakowicz, J. R., et al., Effects of silver island films on fluorescence intensity, lifetimes, and resonance energy transfer. Anal. Biochem., 301: 261-277). Thus, even weakly emitting molecules having low quantum yields can be transformed into more efficient fluorophores when properly adsorbed to SEF-active surfaces (i.e., between 3-60 nm).

Although much work was been done on flat surfaces, there is a need in the art for methods for uniform deposition of particles (in the size range of 2-2000 nm) on curved surfaces such as fibers and conformal coatings formed by the particles. Conformal coatings can be defined as uniform coatings of non-planar, topographically uneven surfaces. This need is broad with respect to both the fiber material and fiber cross sectional diameter, and also the particle materials. Furthermore, there is a need to precisely control the placement of the particles across the entire surface of fibrous materials and the thickness of the particle coating. Further, there is a need in the art for new materials and methods for positive identification via optical spectroscopic techniques that can be used for anti-counterfeiting purposes, brand verification, tagging and tracking targets of interest, friend/foe identification, and trace analyte detection using SERS, SEIRA and SEF.

Citation or identification of any reference in Section 2, or in any other section of this application, shall not be considered an admission that such reference is available as prior art to the present invention.

### 3. SUMMARY OF THE INVENTION

Methods are provided for uniform deposition of particles in the size range of 2-2000 nm on curved surfaces such as fibers and coatings formed by the particles. In specific embodiments, the coating comprises a spectroscopically active molecule.

Conformal (i.e., uniform) coatings of chemically functional particles on polymeric, non-planar, topographically uneven surfaces, wherein the conformal coating comprises a spectroscopically active molecule, are also provided.

Methods are also provided for deposition of metal particles onto a fiber material via electrostatic interaction between modified fiber material surfaces and oppositely charged metal particles or metal ions.

A method is also provided for deposition of various nonmetallic, bimetallic or other charged particles onto a fiber material via electrostatic interaction between modified fiber material surfaces and oppositely charged particles.

A method is also provided for layer-by-layer deposition of polyelectrolytes over a fiber material (e.g., cotton fibers).

A conformal coating for deposition on a non-planar surface of a substrate is provided. The coating comprises a plurality of chemically functional particles, wherein:

the particles are functionalized with one or more species of spectroscopically-active molecules,

the particles have a cross-sectional diameter of 2-2000 nm,

the average distance between adjacent particles across the entire non-planar surface is no greater than 10 times the largest cross-sectional dimension of any particle in the plurality,

the attachment of the particles to the surface is through electrostatic self-assembly or covalent bonding, and

the particle-coated non-planar surface exhibits enhanced spectroscopic properties for localized spectroscopically-active molecules.

In one embodiment, the species of spectroscopically-active molecules are Raman-active, SERS-active, infrared-active, SEIRA-active, SEF-active or fluorescent molecules.

In another embodiment, the Raman-active, SERS-active, infrared-active or SEIRA-active molecules are spaced within 8 nm of the particle surface or have functionality that provides molecule coordination to the particles.

In another embodiment, the SEF-active or fluorescent molecules are spaced at a distance of between 3 nm and 60 nm from the particle surface.

In another embodiment, the Raman-active or SERS-active molecules are selected from the group consisting of fluorescein isothiocyanate, rhodamine β isothiocyanate, dimethyl yellow isothiocyanate, 4-4′-dipyridyl, and mercaptopyridine derivatives such as 2-mercaptopyridine, 2-mercaptopyridine N-oxide and 4-mercaptopyridine (4-MP).

In another embodiment, the particles are assembled on the non-planar surface to provide a uniform plasmon absorption band of the non-planar surface that is in the range of 400-2000 nm.

In another embodiment, the substrate is a polymer.

In another embodiment, the substrate comprises a plurality of fibers.

In another embodiment, the fibers have cross-sectional diameters of 10 nm-100 μm.

In another embodiment, the fibers are organic or inorganic.

In another embodiment, the inorganic fibers comprise glass or ceramic.

In another embodiment, the ceramic fibers comprise alumina, beryllia, magnesia, thoria, zirconia, silicon carbide, or quartz.

In another embodiment, the fibers are a bi-component or tri-component fibers.

In another embodiment, the substrate is a textile.

In another embodiment, the textile is a woven textile, a non-woven textile, a woven composite, a knit, a braid or a yarn.

In another embodiment, the substrate comprises natural or synthetic carbohydrate-based fibers.

In another embodiment, the natural or synthetic carbohydrate-based fibers comprise cellulose, cellulose acetate or cotton.

In another embodiment, the substrate comprises natural protein-based fibers.

In another embodiment, the natural protein-based fibers comprise wool, collagen or silk.

In another embodiment, the substrate comprises organic synthetic fibers capable of participating in hydrogen bonding.

In another embodiment, the organic synthetic fibers comprise polyamides, polycarboxylic acids, polysaccharides, polyalcohols, polyamines, polyaminoacids, polyvinylpyrrolidone, polyethylene oxide or specialized fibers of block copolymers having nucleobase functionality.

In another embodiment, the organic synthetic fibers are substitutionally inert.

In another embodiment, the substitutionally inert organic synthetic fibers comprise polyamides, polyesters, fluoropolymers, polyimides or polyolefins.

In another embodiment, the particles are metallic.

In another embodiment, the particles comprise metal or metal oxide.

In another embodiment, the particles are organic.

In another embodiment, the organic particles are selected from the group consisting of polystyrene sulfonate based particles, polyacrylate based particles, and polyglutamate based particles, polyalkylammonium salt based particles, and cyclic polydiallylammonium salt based particles.

In another embodiment, the particles are inorganic and non-metallic.

In another embodiment, the particles comprise SiO₂.

In another embodiment, the particles are spherical and/or non-spherical.

In another embodiment, the particles are functionalized.

In another embodiment, the particles are functionalized metal particles, functionalized metal oxide particles, functionalized non-metal oxide particles or functionalized organic polymeric particles.

A polymeric non-planar surface comprising the conformal coating is also provided.

A method for surface-bonding particles to a non-planar surface of a substrate to produce a conformal coating is provided. In one embodiment, the method comprises the steps of:

(a) providing a substrate comprising a non-planar surface;

(b) chemically modifying the non-planar surface to impart a surface charge;

(c) depositing complementary charged particles on the non-planar surface, and

(d) functionalizing the surface-bonded metallic particles with one or more species of spectroscopically-active molecules, thereby producing the conformal coating of surface-bonded particles, wherein:

the surface-bonded particles have cross-sectional diameters of 2-2000 nm,

the average distance between adjacent surface-bonded particles across the entire non-planar surface is no greater than 10 times the largest cross-sectional dimension of any of the surface-bonded particles, and

the attachment of the surface-bonded particles to the surface is through electrostatic self-assembly or covalent bonding.

A method for surface-bonding metallic particles to a non-planar surface of a substrate to produce a conformal coating is provided. In one embodiment, the method comprises the steps of:

(a) providing a substrate comprising a non-planar surface;

(b) depositing complementary charged metal ions or complementary charged metal complexes on the non-planar surface;

(c) treating the complementary charged metal ions or complementary charged metal complexes deposited on the non-planar surface with a treatment selected from the group consisting of treating with a reducing agent, treating with a base or heating; and

(d) functionalizing the surface-bonded metallic particles with one or more species of spectroscopically-active molecules, thereby producing the conformal coating of surface-bonded metallic particles, wherein:

the surface-bonded particles have cross-sectional diameters of 2-2000 nm,

the average distance between adjacent surface-bonded particles across the entire non-planar surface is no greater than 10 times the largest cross-sectional dimension of any of the surface-bonded particles, and

the attachment of the surface-bonded particles to the surface is through electrostatic bonding.

A method for surface-bonding particles to a chemically modified non-planar surface of a substrate to produce a conformal coating is also provided. In one embodiment, the method comprises the steps of:

(a) providing a substrate comprising a chemically modified non-planar surface; and

(b) covalently attaching chemically functional particles to the chemically modified non-planar surface; and

(c) functionalizing the surface-bonded metallic particles with one or more species of spectroscopically-active molecules, thereby producing the conformal coating of surface-bonded particles, wherein:

the surface-bonded particles have cross-sectional diameters of 2-2000 nm,

the average distance between adjacent surface-bonded particles across the entire non-planar surface is no greater than 10 times the largest cross-sectional dimension of any of the surface-bonded particles, and

the attachment of the surface-bonded particles to the surface is through covalent bonding.

A method for surface-bonding particles to a non-planar surface of a substrate to produce a conformal coating is also provided. In one embodiment, the method comprises the steps of:

(a) providing a substrate comprising a non-planar surface wherein the non-planar surface comprises hydrogen bond donors/acceptors; and

(b) depositing chemically functional particles on the non-planar surface; and

(c) functionalizing the surface-bonded metallic particles with one or more species of spectroscopically-active molecules, thereby producing the conformal coating of surface-bonded particles, wherein:

the chemically functional particles comprise hydrogen bond donors/acceptors,

hydrogen bonding occurs between the hydrogen bond donors/acceptors on the particles and complementary hydrogen bond donors/acceptors on the non-planar surface,

the surface-bonded particles have cross-sectional diameters of 2-2000 nm,

the average distance between adjacent surface-bonded particles across the entire non-planar surface is no greater than 10 times the largest cross-sectional dimension of any of the surface-bonded particles, and

the attachment of the surface-bonded particles to the surface is through electrostatic self-assembly mediated by hydrogen bonding.

A method for surface-bonding particles to a non-planar surface of a substrate to produce a conformal coating is also provided. In one embodiment, the method comprises the steps of:

(a) providing a substrate comprising a non-planar surface;

(b) plasma-treating the non-planar surface to impart a surface charge;

(c) depositing complementary charged particles on the non-planar surface, producing the conformal coating of surface-bonded particles; and

(d) functionalizing the surface-bonded metallic particles with one or more species of spectroscopically-active molecules, thereby producing the conformal coating of surface-bonded particles, wherein:

the surface-bonded particles have cross-sectional diameters of 2-2000 nm,

the average distance between adjacent surface-bonded particles across the entire non-planar surface is no greater than 10 times the largest cross-sectional dimension of any of the surface-bonded particles, and

the attachment of the surface-bonded particles to the surface is through electrostatic self-assembly.

A method for surface-bonding metallic particles to a non-planar surface of a substrate to produce a conformal coating is also provided. In one embodiment, the method comprises the steps of:

(a) providing a substrate comprising a non-planar surface;

(b) plasma-treating the non-planar surface to impart a surface charge;

(c) depositing complementary charged metal ions or complementary charged metal complexes on the non-planar surface;

(d) treating the complementary charged metal ions or complementary charged metal complexes deposited on the non-planar surface with a treatment selected from the group consisting of treating with a reducing agent, treating with a base or heating; and

(e) functionalizing the surface-bonded metallic particles with one or more species of spectroscopically-active molecules, thereby producing the conformal coating of surface-bonded particles, wherein:

the surface-bonded particles have cross-sectional diameters of 2-2000 nm,

the average distance between adjacent surface-bonded particles across the entire non-planar surface is no greater than 10 times the largest cross-sectional dimension of any of the surface-bonded particles, and

the attachment of the surface-bonded particles to the surface is through electrostatic bonding.

In one embodiment, the species of spectroscopically-active molecules are Raman-active, SERS-active, infrared-active, SEIRA-active, SEF-active or fluorescent molecules.

In another embodiment, the Raman-active, SERS-active, infrared-active or SEIRA-active molecules are spaced within 8 nm of the particle surface or have functionality that provides molecule coordination to the particles.

In another embodiment, the SEF-active or fluorescent molecules are spaced at a distance of between 3 nm and 60 nm from the particle surface.

In another embodiment, the Raman-active or SERS-active molecules are selected from the group consisting of fluorescein isothiocyanate, rhodamine B isothiocyanate, dimethyl yellow isothiocyanate, 4-4′-dipyridyl, and mercaptopyridine derivatives such as 2-mercaptopyridine, 2-mercaptopyridine N-oxide and 4-mercaptopyridine (4-MP).

In another embodiment, the particles are assembled on the non-planar surface to provide a uniform plasmon absorption band of the non-planar surface that is in the range of 400-2000 nm.

In another embodiment, the substrate comprises a carbohydrate-based polymer or a protein-based polymer.

In another embodiment, the substrate comprises a plurality of fibers.

In another embodiment, the fibers have cross-sectional diameters of 10 nm-100 μm.

In another embodiment, the fibers are organic or inorganic.

In another embodiment, the inorganic fibers comprise glass or ceramic.

In another embodiment, the ceramic fibers comprise alumina, beryllia, magnesia, thoria, zirconia, silicon carbide, or quartz.

In another embodiment, the fiber is a bi-component or tri-component fiber.

In another embodiment, the substrate comprises natural or synthetic carbohydrate-based fibers.

In another embodiment, the natural or synthetic carbohydrate-based fibers comprise cellulose, cellulose acetate or cotton.

In another embodiment, the substrate comprises natural protein-based fibers.

In another embodiment, the natural protein-based fibers comprise wool, collagen or silk.

In another embodiment, the surface comprises organic synthetic fibers.

In another embodiment, the organic synthetic fibers comprise polyamides, polycarboxylic acids, polysaccharides, polyalcohols, polyamines, polyaminoacids, polyvinylpyrrolidone, polyethylene oxide or specialized fibers of block copolymers having nucleobase functionality.

In another embodiment, the organic synthetic fiber is substitutionally inert.

In another embodiment, the substitutionally inert organic synthetic fiber comprises polyamides, polyesters, fluoropolymers, polyimides or polyolefins.

In another embodiment, the substrate is a textile.

In another embodiment, the textile is a woven textile, a non-woven textile, a woven composite, a knit, a braid or a yarn.

In another embodiment, the textile is a composite of synthetic fiber and natural fiber, a composite of synthetic fibers, or a composite of natural fibers including, but not limited to, cotton and nylon blends, cotton and wool blends, cotton and polyester blends.

In another embodiment, the textile is a composite of natural fibers, organic synthetic fibers or non-organic synthetic fibers.

In another embodiment, the particles are metallic.

In another embodiment, the metallic particles comprise metal or metal oxide.

In another embodiment, the metallic particles comprise metal or metal oxide.

In another embodiment, the particles are organic.

In another embodiment, the organic particles are polystyrene sulfonate based particles, polyacrylate based particles, and polyglutamate based particles, polyalkylammonium salt based particles, and cyclic polydiallylammonium salt based particles.

In another embodiment, the particles are inorganic and non-metallic.

In another embodiment, the particles comprise SiO₂.

In another embodiment, the particles are spherical and/or non-spherical.

In another embodiment, the particles have a cross-sectional diameter of 2-2000 nm.

In another embodiment, the particles are functional devices comprising an organic or an inorganic component.

In another embodiment, a charged organic molecule, an organic molecule that becomes charged after reacting with the non-planar surface or an ionizing chemical reagent is used to chemically modify the non-planar surface to impart the surface charge.

In another embodiment, a charged organic molecule, an organic molecule that becomes charged after reacting with the non-planar surface or an ionizing chemical reagent is used to treat the complementary charged metal ions or complementary charged metal complexes deposited on the non-planar surface.

In another embodiment, the non-planar surface is chemically modified with an organic molecule that comprises:
a first functional group that reacts at the repeating functional groups of the non-planar surface; and
a second functional group that allows covalent attachment of chemically modified particles.

In one embodiment, the chemically modified particles comprise surface groups that allow covalent attachment of the chemically modified non-planar surface.

In another embodiment, the chemically modified particles are functionalized metal particles, functionalized metal oxide particles, functionalized non-metal oxide particles or functionalized organic polymeric particles.

In another embodiment, the non-planar substrate comprises a carbohydrate-based polymer or a protein-based polymer having positive charge, and the complementary charged metal complexes have negative charge.

In another embodiment, the positive charge is imparted using an alkyl ammonium salt of the formula (R₁, R₂, R₃, R₄)—N⁺, wherein:
R₁ comprises a reactive group suitable for functionalizing the primary alcohol of the carbohydrate backbone or the primary amines of the protein backbone,
the reactive group is selected from the group consisting of epoxides, alkyl iodides/bromide/chlorides, sulfonic acid esters, and activated carboxylic acids, and
R₂-R₄ are selected from the group consisting of aliphatic carbon chains and groups comprising a 5- or 6-membered cyclic ammonium salt.

In another embodiment, the positive charge is imparted using a cationic N-alkylated aromatic heterocycle.

In another embodiment, the cationic N-alkylated aromatic heterocycle is selected from the group consisting of pyridinium and imidazolium derivatives having the following general structure:

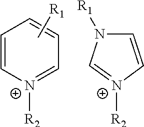

wherein:

R₁ comprises a reactive group suitable for functionalizing the primary alcohol of the carbohydrate backbone or the primary amines of the protein backbone, and R₂ is H, CH₃, CH₂CH₃ or similar aliphatic carbon chains.

In another embodiment, the reactive group is selected from the group consisting of epoxides, alkyl iodides, alkyl bromides, alkyl chlorides, sulfonic acid esters, and activated carboxylic acids.

In another embodiment, the cationic N-alkylated aromatic heterocycle is selected from the group consisting of pyridinium and imidazolium derivatives having the following general structure:

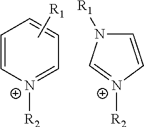

wherein:

R₁ is H, and

R₂ comprises a reactive group suitable for functionalizing the primary alcohol of the carbohydrate backbone or the primary amines of the protein backbone.

In another embodiment, the reactive group is selected from the group consisting of epoxides, alkyl iodides, alkyl bromides, alkyl chlorides, sulfonic acid esters and activated carboxylic acids.

In another embodiment, the positive charge is imparted using a sulfonium salt of the formula (R₁, R₂, R₃)—S⁺, wherein:

R₁ comprises a reactive group suitable for functionalizing the primary alcohol of the carbohydrate backbone or the primary amines of the protein backbone, and

R₂ and R₃ are aliphatic carbon chains.

In another embodiment, the reactive group is selected from the group consisting of epoxides, alkyl iodides, alkyl bromides, alkyl chlorides, sulfonic acid esters and activated carboxylic acids.

In another embodiment, the non-planar substrate comprises a carbohydrate-based polymer having negative charge, and the complementary charged metal ions have positive charge.

In another embodiment, the non-planar surface comprises a polymer having negative charge, and the complementary charged metal ions have positive charge.

In another embodiment, the negative charge is imparted using carboxylates of the formula R—CH₂—COO—, wherein R comprises a reactive group for functionalizing the primary alcohol of the carbohydrate backbone.

In another embodiment, the reactive group is selected from the group consisting of epoxides, alkyl iodides, alkyl bromides, alkyl chlorides and sulfonic acid esters.

In another embodiment, the plasma is oxygen plasma, the surface charge is negative, and the particles are positively charged.

In another embodiment, the plasma is oxygen plasma, the surface charge is negative, and the complementary charged metal ions or metal complexes are positively charged.

In another embodiment, the plasma is ammonia/helium plasma, the surface charge is positive, and the complementary charged particles are negatively charged.

In another embodiment, the plasma is ammonia/helium plasma, the surface charge is positive, and the complementary charged metal ions or metal complexes are negatively charged.

In another embodiment, the depositing step is conducted in an aqueous solution.

In another embodiment, the treating step is conducted in an aqueous or organic solution.

In another embodiment, the methods of the invention can be carried out at a temperature range above 273° K.

In another embodiment, the methods of the invention can be carried out at pH greater than 1.

In another embodiment, the complementary charged metal ions are positively charged and the surface-bonded metallic particles produced are metal oxide particles.

In another embodiment, the non-planar surface is a carbohydrate-based polymer or a protein based polymer having a positive surface charge, and the complementary charged particles are negatively charged.

In another embodiment, the positive charge is imparted using an alkyl ammonium salt of the formula (R₁, R₂, R₃, R₄)—N⁺, wherein: R₁ comprises a reactive group suitable for functionalizing the primary alcohol of the carbohydrate backbone or the primary amines of the protein backbone, and R₂-R₄ are aliphatic carbon chains or groups comprising a 5- or 6-membered cyclic ammonium salt.

In another embodiment, the reactive group is selected from the group consisting of epoxides, alkyl iodides, alkyl bromides, alkyl chlorides, sulfonic acid esters, and activated carboxylic acids.

In another embodiment, the positive charge is imparted using cationic N-alkylated aromatic heterocycles.

In another embodiment, the aromatic heterocycles are selected from the group consisting of pyridinium and imidazolium derivatives having the following general structure:

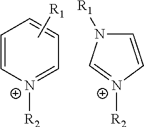

wherein:

R₁ comprises a reactive group suitable for functionalizing the primary alcohol of the carbohydrate backbone or the primary amines of the protein backbone, and R₂ is an aliphatic carbon chain.

In another embodiment, the reactive group is selected from the group consisting of epoxides, alkyl iodides, alkyl bromides, alkyl chlorides, sulfonic acid esters, and activated carboxylic acids.

In another embodiment, the aromatic heterocycles are selected from the group consisting of pyridinium and imidazolium derivatives having the following general structure:

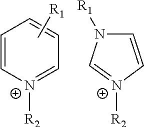

wherein:

R₁ is H, and

R₂ comprises a reactive group suitable for functionalizing the primary alcohol of the carbohydrate backbone or the primary amines of the protein backbone.

In another embodiment, the reactive group is selected from the group consisting of epoxides, alkyl iodides, alkyl bromides, alkyl chlorides, sulfonic acid esters and activated carboxylic acids.

In another embodiment, the positive charge is imparted using a sulfonium salt of the formula (R₁, R₂, R₃)—S⁺, wherein R₁ comprises a reactive group suitable for functionalizing the primary alcohol of the carbohydrate backbone or the primary amines of the protein backbone, and R₂ and R₃ are aliphatic carbon chains.

In another embodiment, the reactive group is selected from the group consisting of epoxides, alkyl iodides/bromide/chlorides, sulfonic acid esters and activated carboxylic acids.

In another embodiment, the non-planar surface is a carbohydrate-based polymer having a negative surface charge, and the complementary charged particles are positively charged.

In another embodiment, the non-planar surface is a polymer having a negative surface charge, and the particles are positively charged.

In another embodiment, the complementary charged particles are metal or metal oxide particles functionalized with a chemical reagent having at least one group capable of binding to the metal or metal oxide and at least one group that is charged.

In another embodiment, the complementary charged particles are organic polymeric particles having positively charged surfaces.

In another embodiment, the positively charged surfaces comprise polyalkylammonium salts or cyclic polydiallylammonium salts.

In another embodiment, the complementary charged particles are organic polymeric particles having negatively charged surfaces.

In another embodiment, the negatively charged surfaces comprise polystyrene sulfonate, polyacrylic acid or polyglutamic acid.

In another embodiment, the negative charge is imparted using carboxylates of the formula R—CH₂—COO—, wherein R comprises a reactive group for functionalizing the primary alcohol of the carbohydrate backbone.

In another embodiment, the reactive group is selected from the group consisting of epoxides, alkyl iodides, alkyl bromides, alkyl chlorides and sulfonic acid esters.

In another embodiment, the negative charge is imparted using phosphonates of the formula R₁—CH₂—PO₃R₂, wherein R₁ comprises a reactive group suitable for functionalizing the primary alcohol of the carbohydrate backbone including, but not limited to epoxides, alkyl iodides/bromides/chlorides, and sulfonic acid esters, and R₂ is an aliphatic carbon chains.

In another embodiment, the method comprises the step of phosphorylating the primary alcohol of the carbohydrate backbone using a suitable phosphorylating agent to confer the negative charge.

In another embodiment, the phosphorylating agent is an enzymatic phosphorylating agent.

In another embodiment, the negative charge is imparted using sulfonates of the formula R—CH₂—SO₃⁻, wherein R comprises a reactive group suitable for functionalizing the primary alcohol of the carbohydrate backbone.

In another embodiment, the reactive group is selected from the group consisting of epoxides, alkyl iodides, alkyl bromides, alkyl chlorides and sulfonic acid esters.

In another embodiment, the method comprises the step of alkylating the primary alcohol of the carbohydrate backbone using 1,3-propane sultone or 1,4-butane sultone to confer the negative charge.

In another embodiment, the negative charge is imparted using sulfonates of the formula R—CH₂—OSO₃⁻, wherein R comprises a reactive group suitable for functionalizing the primary alcohol of the carbohydrate backbone.

In another embodiment, the reactive group is selected from the group consisting of epoxides, alkyl iodides, alkyl bromides, alkyl chlorides and sulfonic acid esters.

In another embodiment, the method comprises the step of alkylating the primary alcohol of the carbohydrate backbone using 5- or 6-membered ring sulfate esters to confer the negative charge.

In another embodiment, the depositing step is conducted in an aqueous suspension.

In another embodiment, the depositing step is conducted at a temperature above 273° K.

In another embodiment, the depositing step is conducted at a pH above 1.

In another embodiment, the chemically functional particles comprise surface groups that are capable of hydrogen bonding with the non-planar surface, or are functionalized to produce surface groups capable of hydrogen bonding with the non-planar surface.

In another embodiment, the particles are metal or metal oxide particles, and functionalized with a chemical reagent that has at least one reactive group that is capable of binding to the metal or metal oxide particles and at least one group that is a hydrogen bond donor/acceptor.

In another embodiment, the hydrogen bond donors/acceptor is selected from the group consisting of carboxylic acids, amides, imides, amines, alcohols and nucleobases.

In another embodiment, the chemically functional particles are organic polymeric particles bearing hydrogen bonding donors/acceptors.

In another embodiment, the hydrogen bonding donors/acceptors are polymers or copolymers comprising polyamides, polycarboxylic acids, polysaccharides, polyalcohols, polyamines, polyaminoacids, polyvinylpyrrolidone or polyethylene oxide, or specialized block copolymers having nucleobase functionality.

In another embodiment, the substrate comprises organic synthetic fibers with surface groups that are capable of hydrogen bonding with the particles.

In another embodiment, the substrate is selected from the group consisting of polyamides, polycarboxylic acids, polysaccharides, polyalcohols, polyamines, polyaminoacids, polyvinylpyrrolidone, polyethylene oxide or specialized fibers of block copolymers having nucleobase functionality.

In another embodiment, the substrate comprises nylon fibers or a combination of nylon fibers.

In another embodiment, the depositing step is conducted in an aqueous suspension.

In another embodiment, the depositing step is conducted at a temperature above 273° K.

In another embodiment, the depositing step is conducted at a pH greater than 1.

In another embodiment, the method comprises controlling hydrogen bonding interactions between the non-planar surface and the particles by controlling the pH.

A conformal coating produced by any of the methods of the invention is also provided.

A surface-bonded particle produced by any of the methods of the invention is also provided.

A method for producing enhanced spectroscopic properties in a material is also provided. The method can comprise applying the conformal coating to a non-planar surface of the material. In one embodiment, the spectroscopic properties are selected from the group consisting of Raman, infrared and fluorescence spectroscopic properties.

A method for regulating the absorption, reflection or scattering of light by a substrate is also provided. The method can comprise applying the conformal coating to a non-planar surface of the substrate. In one embodiment, the light is UV, visible, near infrared or infrared.

The invention also provides an article with enhanced spectroscopic properties comprising a substrate and the conformal coating deposited on a non-planar surface of the substrate. In one embodiment, the spectroscopic properties are selected from the group consisting of Raman, infrared and fluorescence spectroscopic properties.

The invention also provides an article comprising a substrate and the conformal coating deposited on a non-planar surface of the substrate, wherein the absorption, reflection or scattering of light by the substrate is regulated by the conformal coating. In one embodiment, the light is UV, visible, near infrared or infrared.

A method for applying a surface-enhanced Raman scattering (SERS) spectroscopic signature to a fiber material is also provided. In one embodiment, the method comprises the step of applying a conformal coating to the fiber material, wherein:

the conformal coating comprises metallic particles that are Raman-enhancing to the fiber material,

the metallic particles are functionalized with a Raman-active molecule, and

the Raman-active molecule has a measureable and recognizable SERS spectrum or signature.

A method for applying a surface-enhanced infrared absorption (SEIRA) spectroscopic signature to a fiber material is also provided. In one embodiment, the method comprises the step of applying a conformal coating to the fiber material, wherein:

the conformal coating comprises metallic particles that are near-infrared or mid-infrared enhancing to the fiber material,

the metallic particles are functionalized with a SEIRA-active molecule, and

the SEIRA-active molecule has a measureable and recognizable SEIRA spectrum or signature.

A method for applying a surface-enhanced fluorescence (SEF) spectroscopic signature to a fiber material is also provided. In one embodiment, the method comprises the step of applying a conformal coating to the fiber material, wherein:

the conformal coating comprises metallic particles that are SEF-enhancing to the fiber material,

the metallic particles are functionalized with a fluorescent molecule, and

the fluorescent molecule has a measureable and recognizable fluorescent spectrum or signature.

A fiber material is also provided, wherein the fiber material comprises a conformal coating of non-reflective particles, wherein the conformal coating reduces the reflectance of the underlying fiber material in the range of 0.7-3.0 μm. In another embodiment, the range is 400 nm and 2000 nm.

In one embodiment, the particles are selected from the group consisting of polystyrene sulfonate based particles, polyacrylate based particles, and polyglutamate based particles, polyalkylammonium salt based particles, and cyclic polydiallylammonium salt based particles.

A method for decreasing a near-infrared and mid-infrared reflectance signature of a fiber material is also provided. In one embodiment, the method comprises the step of providing a fiber material, wherein:

the fiber material comprises a conformal coating of non-reflective particles, and

the conformal coating reduces the reflectance of the underlying fiber material in the range of 0.7-3.0 p.m. In another embodiment, the range is 400 nm and 2000 nm.

A fiber material is also provided, wherein the fiber material comprises a conformal coating of reflective particles, and wherein the fiber material is highly reflective in the range of 0.7-3.0 p.m. In another embodiment, the range is 400 nm and 2000 nm.

A method for increasing a near-infrared and mid-infrared reflectance signature of a fiber material is also provided. In one embodiment, the method comprises the step of providing a fiber material, wherein:

the fiber material comprises a conformal coating of reflective particles, and

the conformal coating is highly reflective in the range of 0.7-3.0 μm. In another embodiment, the range is 400 nm and 2000 nm.

A fiber material is also provided, wherein the fiber material comprises a conformal coating of particles having a desired reflectance maximum, and wherein the desired reflectance maximum of the fiber material coincides with an excitation source with a wavelength within the range of 400 nm and 2000 nm.

A fiber material is also provided, wherein the fiber material comprises a conformal coating of particles having a desired reflectance maximum, and wherein the desired reflectance maximum of the fiber material does not coincide with an excitation source with a wavelength within the range of 400 nm and 2000 nm. In another embodiment, the desired reflectance maximum of the fiber-particle composite material is decreased with respect to the fiber material alone.

A method for coinciding a desired reflectance maximum of a fiber material with an excitation source is provided. In one embodiment, the method comprises the step of providing a fiber material comprising a conformally particle coating, wherein the desired reflectance maximum of the fiber material coincides with an excitation source that has a wavelength within the range of 400 nm and 2000 nm.

A fiber material is also provided, wherein the fiber material comprises a conformal coating of particles having a desired reflectance signature, and wherein the desired reflectance signature has an output that is measurable by a reflectance spectroscopic reader.

### 4. BRIEF DESCRIPTION OF THE DRAWINGS

The present invention is described herein with reference to the accompanying drawings, in which similar reference characters denote similar elements throughout the several views. It is to be understood that in some instances, various aspects of the invention may be shown exaggerated or enlarged to facilitate an understanding of the invention.

FIGS. 1A-F. Field Emission Scanning Electron Microscopy (FESEM) images: assembly of Ag NPs from Ag colloidal solutions with various pH values, (a) pH 3.0, (b) pH 4.0, (c) pH 5.0, (d) pH 6.0, (e) pH 7.0, and (f) pH 9.7.

FIGS. 2A-B. Transmission Electron Microscopy (TEM) images at low magnification (a) and high magnification (b) of Ag NPs on nylon 6 nanofibers obtained from immersing the fibers in a solution of Ag NPs with pH 5.

FIG. 3. Ultra Violet visible (UV-vis) spectra for (a) diluted solution of as-synthesized Ag NPs at a ratio of 1:1 with water, (b) nylon 6 nanofiber mat, (c) wet Ag-nylon 6 nanofiber mat, and (d) dried Ag-nylon 6 nanofiber mat.

FIGS. 4A-B. Antibacterial results of nylon 6 nanofiber mats without (left) and with (right) Ag NPs on E. coli after incubation for (a) a 2 hour contact time, (b) a 24 hour contact time. The extraction of bacterial solution after the contact time was diluted to 10¹, 10², and 10³ times. Then the extraction and three diluents were incubated on four zones of a nutrient agar plate at 37 Celsius for 18 hours.

FIGS. 5A-D. TEM images: (a) and (b) assembly of Au NPs on nylon 6 nanofibers at pH 5; (c) and (d) assembly of Pt NPs on nylon 6 fibers at pH 5.

FIGS. 6A-B. (A) UV-vis spectra for (a) half-diluted solution of Au NPs and (b) Au-nylon 6 nanofiber mat; (B) UV-vis spectra for (a) half-diluted solution of Pt NPs and (b) Pt-nylon 6 nanofiber mat.

FIG. 7A. Direct assembly using (left) negatively charged nanoparticles (NPs) in a colloidal suspension onto cationic cellulose, and (right) positively charged NPs in a colloidal suspension onto anionic cellulose.

FIG. 7B. In-situ synthesis of metallic NPs using (left) negatively charged metal complexes on cationic cellulose, (right) positively charged metal ions on anionic cellulose.

FIG. 8. Synthesis of cationic cellulose.

FIG. 9. Synthesis of anionic cellulose.

FIGS. 10A-D. Direct assembly of Au NPs on cotton synthesized using 1% citrate. (A-B) TEM images of the cross sections of cotton fibers coated with Au NPs, (C) FESEM image of the surface of a cotton fiber coated with Au NPs, (D) Energy Dispersive X-ray Analysis (EDX) of a cotton fiber coated with Au NPs.

FIGS. 11A-D. Direct assembly of Pt NPs on cotton. (A-B) TEM images of the cross sections of cotton fibers coated with Pt NPs, (C) FESEM image of the surface of a cotton fiber coated with Pt NPs, (D) EDX spectra of a cotton fiber coated with Pt NPs.

FIGS. 12A-C. In-situ formation of Ag NPs on cotton, synthesized from 5 mM AgNO₃ metallic precursor solution. (A) TEM images of the cross sections of cotton fibers coated with Ag NPs, (B) FESEM image of the surface of a cotton fiber coated with Ag NPs, (C) Energy Dispersive Spectroscopy (EDS) analysis of a cotton fiber coated with Ag NPs.

FIGS. 13A-D. In-situ formation of Au NPs on cotton, synthesized from 5 mM NaAuCl₄ metallic precursor solution. (A-B) TEM images of the cross sections of cotton fibers coated with Au NPs, (C) FESEM image of the surface of a cotton fiber coated with Au NPs, (D) EDX spectra of a cotton fiber coated with Au NPs.

FIGS. 14A-D. In-situ formation of Pd NPs on cotton, synthesized from 5 mM Na₂PdCl₄ metallic precursor solution. (A-B) TEM images of the cross sections of cotton fibers coated with Pd NPs, (C) FESEM image of the surface of a cotton fiber coated with Pd NPs, (D) EDX spectra of a cotton fiber coated with Pd NPs.

FIGS. 15A-C. In-situ formation of Cu NPs on cotton first coated with Pd NPs, synthesized from CuSO₄ metallic precursor solution. (A) FESEM image of the surface of a cotton fiber coated with Cu NPs, (B) SEM image of the surface of a cotton fiber coated with Cu NPs, (C) EDS analysis of a cotton fiber coated with Cu NPs.

FIGS. 16A-B. In-situ formation of ZnO NPs on cotton, synthesized from 10 mM Zn(OAc)₂ metallic precursor solution. (A) SEM image of the surface of a cotton fiber coated with Zn NPs, (B) EDS analysis of a cotton fiber coated with ZnO NPs.

FIGS. 17A-B. SEM images of the surface of a cationic cotton fiber coated with (A) polystyrene sulfonate spheres size 1 micron in diameter, (B) polystyrene sulfonate mushroom cap particles size 1.2 microns in diameter.

FIG. 18A. Antibacterial results of cotton swatches without (left) and with (right) Ag NPs on E. coli after incubation for 24 h contact time. The extraction of bacterial solution after the contact time was diluted to 10¹, 10², and 10³ times. Then the extraction and three diluents were incubated on four zones of a nutrient agar plate at 37 Celsius for 18 hours.

FIG. 18B. Antibacterial results of cotton swatches without (left) and with (right) Ag NPs on S. aureus after incubation for 24 h contact time. The extraction of bacterial solution after the contact time was diluted to 10¹, 10², and 10³ times. Then the extraction and three diluents were incubated on four zones of a nutrient agar plate at 37 Celsius for 18 hours.

FIG. 19A. Antibacterial results of cotton swatches (i) without NP coating, (ii) coated with Cu NPs, on S. aureus after incubation for 18 hours.

FIG. 19B. Antibacterial results of cotton swatches (i) without NP coating, (ii) coated with Cu NPs, on E. coli after incubation for 18 hours.

FIG. 20. Results from a biofilm inhibition assay. P. aeruginosa cells were grown in the presence of Au-cotton and Cu-cotton composite fibers and assayed for biofilm formation by staining with crystal violet.

FIG. 21. Synthesis of particle coatings on fibers via self-assembly by pH-induced hydrogen bonding using metal nanoparticles (NPs) and nylon 6 nanofibers as an example.

FIG. 22A illustrates the general platform for detection. Although this figure illustrates SERS-based detection, this general platform for detection can be applied to SEIRA-based detection and SEF-based detection.

FIG. 22B shows a schematic of positive identification using textile-based SERS-active substrates.

FIGS. 23A-C. A) This composite image illustrates high surface coverage of Ag/Au/Pt particles over cotton fibers at the centimeter (optical scan-left), micron (FESEM-top) and nanoscale (TEM-bottom). B) TEM images of Au and Ag particles deposited onto nylon 6 nanofibers. C) Atom force microscopy (left; 7×7 μm image) and SEM (right; scale bar=100 μm) images of wool fibers coated with a nanolayer of PSS and PAH.

FIG. 24. Left: Commercially available compounds used as Raman reporters for the SERS studies using Ag particle-coated cotton fibers. Right: The SERS spectra shown are representative of the data obtained for the various Raman reporters using silver SERS-active cotton substrates.

FIG. 25 shows a SERS based analysis of Ag-coated anionic cotton fibers tagged with multiplex tags of 2-MP and 4-MP in concentrations that varied from 5% 2-MP/95% 4-MP (bottom-most spectrum) to 95% 2-MP/5% 4-MP (top-most spectrum). The plot at the lower right shows that the ratio of region 2: region 4 (signature peaks for both 2-MP and 4-MP) varies directly with the concentration of 2-MP and 4-MP present.

FIGS. 26A-D. Representative SERS spectra of Ag particle-coated cotton and nylon 6 nanofiber substrates treated with 2-mercaptopyridine (2-MP). A) Spectra of cotton substrates treated with 10 μM 2-MP using variable laser power and magnification. Spectra shown in B) and C) correspond to nylon 6 substrates treated with 10 μM 2-MP using variable laser power (e.g., 100% represents 8 mW incident at the sample using a 50× objective) and 50× and 5× objectives, respectively. D) Spectra of nylon 6 substrates treated with various concentrations of 2-MP using a 50× objective and 1% laser power (e.g., 100% represents 8 mW incident at the sample using a 50× objective).

FIG. 27. One method for producing metal particle coated cotton.

FIG. 28. Production of particle-coated cationic wool.

FIG. 29. Illustration of layer-by-layer (LBL) assembly of Au and Ag particles on nylon fibers.

FIG. 30. Electrospinning setup for the production of SERS-, SEIRA-, or SER-active Ag and Au particle/nylon 6 nanofiber-coated textiles containing a Raman reporter molecule as an example.

FIG. 31. Top left shows a transmission electron microscopic image of a cross-section of a SERS-, SEIRA-, or SER-active cotton coated with silver particles. Top right shows diagrams of synthesis of SERS-active particle-coated cationic and anionic cotton. Bottom left shows a transmission electron microscopic image of SERS-, SEIRA-, or SER-active nylon coated with gold particles. Bottom right shows a diagram of the synthesis of particle-coated Nylon 6 nanofibers.

FIG. 32. An example of LBL self-assembly of a SERS-active tag. In this embodiment, a citrate stabilized metal particle-coated substrate was treated with 2-mercaptopyridine (2-MP), a Raman reporter.

FIG. 33A shows a SERS based analysis of Ag-coated anionic cotton fiber tagged with 2-MP. Control, anionic cotton. The inset at the right shows a detail of the spectrum for the tagged Ag-treated anionic cotton fiber from 1000-1600 cm⁻¹.

FIG. 33B shows a SERS based analysis of Ag-coated anionic cotton fiber tagged with a single tag, 2-MP at a concentration of 1 μM. The spectra shown on the left result from various combinations of microscope objectives and laser power of the Raman microscope over a 10 sec integration time. At the lowest combination of objective power (5×) and laser power (0.1%) tested (lower-most spectrum), the fingerprint of the Raman reporter tag was successfully detected. This represents extremely low laser power, approximately 10 μW, over a 10 sec integration time.

FIG. 34 shows spectra obtained on a Renishaw In Via micro-spectrometer from various Ag-coated nylon nanofiber samples. Ag-coated nylon samples were prepared at varying pH and subsequently incubated with an aqueous solution of 2-MP at a concentration of 1 micromolar. The data shows the variation in signal that is obtained for the different Ag-coated nylon samples. Optimum SERS signal (with respect to signal intensity) is obtained for Ag-coated nylon sample prepared at pH 3 or 4. Laser power=1% of ˜8 mW ˜80 μW, 10-sec extended scan (500-2000 cm-1).

FIG. 35 shows the basic configuration of a night vision device (NVD), which comprises a photo cathode, a microchannel plate, and a phosphor screen, and shows the general principles of image enhancement using the NVD, wherein photons of the unenhanced image are multiplied to produce the NVD image.

FIG. 36 shows US Army camouflage standards for Foliage Green, Urban Gray and Desert Sand camouflage.

FIG. 37 shows the basic principles of measuring specular reflectance (left) and diffuse reflectance (right).

FIG. 38 shows how diffuse reflectivity can be measured using an integrating sphere and a detector, a method well known in the art.

FIG. 39 shows the paths of reflected and transmitted light after incident light encounters a sample (in this example, an optical filter) with an antireflective coating.

FIG. 40 shows the effect of a single layer (top) and multilayer (bottom) thin film on the paths of reflected and transmitted light after incident light encounters a substrate with an anti-reflective single or multiple layer coating.

FIG. 41 shows the deposition process of anti-reflective multiple layer coating on textile fibers using the methods disclosed herein. Polystyrene (PS) particles comprise a co-polymer of polystyrene and polystyrene sulfonate. The left illustration depicts the starting components of the deposition process; that is, cationic camouflaged fabric and anionic polystyrene/polystyrene sulfonate particles. The middle illustration shows the deposition process—where the cationic fabric is immersed in a vessel containing an aqueous solution of the particles. The right illustration shows an optical image of the PS-coated camouflage fabric and a scanning electron image of the same PS-coated camouflage fabric.

FIG. 42 shows a comparison of reflectivity by particle size for Desert Sand coated nylon/cotton blend camouflage fabric (US Army Natick Soldier Center). % reflectance is plotted as a function of wavelength (nm) from 600-850 nm. Comparisons were made among Desert Sand fabric coated with 0.2 μm polystyrene (PS) spheres, 0.5 μm PS spheres, 1.0 μm PS spheres, 1.2 μm PS “mushroom caps,” and with PAH-coated and untreated Desert Sand fabric. Mushroom cap is a generic term used herein to describe PS particles that have the appearance of a mushroom; that is, the particles have both a convex-shaped side and a concave-shaped side (refer to FIG. 48A).

FIG. 43 shows a comparison of reflectivity by particle size for Desert Sand coated nylon/cotton blend camouflage fabric. % reflectance is plotted as a function of wavelength (nm) from 960-1500 nm. Comparisons were made among Desert Sand fabric coated with 0.2 μm PS spheres, 0.5 μm PS spheres, 1.0 μm PS spheres, 1.2 μm PS “mushroom caps,” and with PAH-coated and untreated Desert Sand fabric. % reflectance varied directly with size of the particles as indicated by the arrows shown in the figures

FIG. 44 shows a comparison of reflectivity by particle size for Urban Gray coated nylon/cotton blend camouflage fabric (US Army Natick Soldier Center). % reflectance is plotted as a function of wavelength (nm) from 600-850 nm. Comparisons were made among Urban Gray fabric coated with 0.2 μm PS spheres, 0.5 μm PS spheres, 1.0 μm PS spheres, 1.2 μm PS “mushroom caps,” and with PAH-coated and untreated Urban Gray fabric.

FIG. 45 shows a comparison of reflectivity by particle size for Urban Gray coated nylon/cotton blend camouflage fabric. % reflectance is plotted as a function of wavelength (nm) from 960-1460 nm. Comparisons were made among Urban Gray fabric coated with 0.2 μm PS spheres, 0.5 μm PS spheres, 1.0 μm PS spheres, 1.2 μm PS “mushroom caps,” and with PAH-coated and untreated Urban Gray fabric.

FIG. 46 shows a comparison of reflectivity by particle size for Foliage Green coated nylon/cotton blend camouflage fabric (US Army Natick Soldier Center). % reflectance is plotted as a function of wavelength (nm) from 600-850 nm. Comparisons were made among Foliage Green fabric coated with 0.2 μm PS spheres, 0.5 μm PS spheres, 1.0 μm PS spheres, 1.2 μm PS “mushroom caps,” and with PAH-coated and untreated Foliage Green fabric.

FIG. 47 shows a comparison of reflectivity by particle size for Foliage Green coated nylon/cotton blend camouflage fabric. % reflectance is plotted as a function of wavelength (nm) from 960-1500 nm. Comparisons were made among Foliage Green fabric coated with 0.2 μm PS spheres, 0.5 μm PS spheres, 1.0 μm PS spheres, 1.2 μm PS “mushroom caps,” and with PAH-coated and untreated Foliage Green fabric.

FIGS. 48A-D are scanning electron micrographs of particle coatings on nylon/cotton blend camouflage fabric (US Army Natick Soldier Center). (A) 1.2 μm PS “mushroom caps”, (B) 1.0 μm PS spheres, (C) 0.5 μm PS spheres, (D) 0.2 μm PS spheres. Scale bars are indicated in each figure.

FIG. 49 shows a comparison of reflectivity by particle size for cationic cotton fabric. % reflectance is plotted as a function of wavelength (nm) from 600-850 nm. Comparisons were made among cotton fabric coated with 0.2 μm PS spheres, 0.5 μm PS spheres, 1.0 μm PS spheres, 1.2 μm PS “mushroom caps,” and with untreated cationic cotton fabric.

FIG. 50 shows a comparison of reflectivity by particle size for cationic cotton fabric. % reflectance is plotted as a function of wavelength (nm) from 960-1500 nm. Comparisons were made among cotton fabric coated with 0.2 μm PS spheres, 0.5 μm PS spheres, 1.0 μm PS spheres, 1.2 μm PS “mushroom caps,” and with untreated cationic cotton fabric.

FIG. 51 compares the change in % reflectance across fabrics (Desert Sand, Urban Gray and Foliage Green camouflage fabric and cationic cotton fabric) coated with 0.2 μm PS spheres. Change in % reflectance is plotted as a function of wavelength (nm) from 600-1500 nm.

FIG. 52 compares the change in % reflectance across fabrics (Desert Sand, Urban Gray and Foliage Green camouflage fabric and cationic cotton fabric) coated with 0.5 μm PS spheres. Change in % reflectance is plotted as a function of wavelength (nm) from 600-1500 nm.

FIG. 53 compares the change in % reflectance across fabrics (Desert Sand, Urban Gray and Foliage Green camouflage fabric and cationic cotton fabric) coated with 1.0 μm PS spheres. Change in % reflectance is plotted as a function of wavelength (nm) from 600-1500 nm.

FIG. 54 compares the change in % reflectance across fabrics (Desert Sand, Urban Gray and Foliage Green camouflage fabric and cationic cotton fabric) coated with 1.2 μm PS mushroom caps. Change in % reflectance is plotted as a function of wavelength (nm) from 600-1500 nm

### 5. DETAILED DESCRIPTION OF THE INVENTION

For clarity of disclosure, and not by way of limitation, the detailed description of the invention is divided into the subsections set forth below.

5.1. Conformal Coatings, Conformally Coated Non-Planar Surfaces and Methods for Producing them

5.1.1. Chemical Modification of the Non-Planar Surface to Impart a Surface Charge

A conformal coating is provided for deposition on a non-planar surface of a substrate comprising a plurality of chemically functional particles, wherein:

the particles have a cross-sectional diameter of 2-2000 nm,

the average distance between adjacent particles across the entire non-planar surface is no greater than 10 times the largest cross-sectional dimension of any particle in the plurality, and

the attachment of the particles to the surface is through electrostatic self-assembly or covalent bonding.

The invention also provides a method for producing conformally coated non-planar surfaces. The method can comprise the steps of providing a substrate comprising a non-planar surface and chemically modifying the non-planar surface to impart a surface charge. The method can further comprise depositing complementary charged metal ions, complementary charged metal complexes or complementary charged particles on the non-planar surface.

The invention also provides a method for producing a surface-bonded particle comprising:

(a) providing a substrate comprising a non-planar surface;
(b) chemically modifying the non-planar surface to impart a surface charge; and
(c) reacting a complementary charged metal ion, complementary charged metal complex or complementary charged particle with the chemically modified non-planar surface, producing the surface-bonded metallic particle, wherein the bond between the particle and the non-planar surface is a covalent or electrostatic bond.

In a specific embodiment, the invention provides a method for surface-bonding particles to a non-planar surface of a substrate to produce a conformal coating comprising the steps of:

(a) providing a substrate comprising a non-planar surface;
(b) chemically modifying the non-planar surface to impart a surface charge; and
(c) depositing complementary charged particles on the non-planar surface, producing the conformal coating of surface-bonded particles, wherein:
the surface-bonded particles have cross-sectional diameters of 2-2000 nm, the average distance between adjacent surface-bonded particles across the entire non-planar surface is no greater than 10 times the largest cross-sectional dimension of any of the surface-bonded particles, and the attachment of the surface-bonded particles to the surface is through electrostatic self-assembly or covalent bonding.

In one embodiment, the non-planar surface is a carbohydrate-based polymer or a protein based polymer with a positive surface charge and the particle surface is negatively charged.

In another embodiment, the positive charge is imparted using an alkyl ammonium salt of the formula (R₁, R₂, R₃, R₄)—N⁺, wherein R₁-R₄ groups are defined as follows: R₁ contains a reactive group suitable for functionalizing the primary alcohol of the carbohydrate backbone or the primary amines of the protein backbone including, epoxides, alkyl iodides/bromide/chlorides, sulfonic acid esters, and activated carboxylic acids such as N-hydroxy succinimidyl esters for amine attachment; and R₂-R₄ are H, CH₃, CH₂CH₃ or similar aliphatic carbon chains, and groups comprising a 5- or 6-membered cyclic ammonium salt.

In another embodiment, the positive charge is imparted using cationic N-alkylated aromatic heterocycles including, but not limited to, pyridinium and imidazolium derivatives having the following general structures:

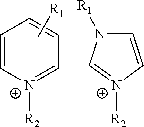

wherein R₁ and R₂ groups are defined as follows: R₁ contains a reactive group suitable for functionalizing the primary alcohol of the carbohydrate backbone or the primary amines of the protein backbone including, epoxides, alkyl iodides/bromide/chlorides, sulfonic acid esters, and activated carboxylic acids such as N-hydroxy succinimidyl esters for amine attachment; and R₂ is H, CH₃, CH₂CH₃ or similar aliphatic carbon chains.

In another embodiment, R₁ is H, and R₂ contains a reactive group suitable for functionalizing the primary alcohol of the carbohydrate backbone or the primary amines of the protein backbone including, epoxides, alkyl iodides/bromide/chlorides, sulfonic acid esters, and activated carboxylic acids such as N-hydroxy succinimidyl esters for amine attachment.

In another embodiment, the positive charge is imparted using a sulfonium salt of the formula (R₁, R₂, R₃)—S⁺, wherein R₁-R₃ groups are defined as follows: R₁ contains a reactive group suitable for functionalizing the primary alcohol of the carbohydrate backbone or the primary amines of the protein backbone including, epoxides, alkyl iodides/bromide/chlorides, sulfonic acid esters, and activated carboxylic acids such as N-hydroxy succinimidyl esters for amine attachment; and R₂ and R₃ are H, CH₃, CH₂CH₃ or similar aliphatic carbon chains.

In another embodiment, the non-planar surface is a carbohydrate-based polymer with a negative surface charge and the particle is positively charged.

In another embodiment, the particle is a metal or metal oxide and is functionalized with a chemical reagent having at least one group capable of binding to the metal or metal oxide and at least one group that is charged.

In another embodiment, the particle is an organic polymeric particle having a positively charged surface including, but not limited to, polyalkylammonium salts and cyclic polydiallylammonium salts.

In another embodiment, the particle is an organic polymeric particle having a negatively charged surface including, but not limited to, polystyrene sulfonate, polyacrylic acid, and polyglutamic acid.

In another embodiment, the negative charge is imparted using carboxylates of the formula R—CH₂—COO—, wherein R contains a reactive group for functionalizing the primary alcohol of the carbohydrate backbone including, but not limited to, epoxides, alkyl iodides/bromides/chlorides, and sulfonic acid esters.

In another embodiment, the negative charge is imparted using phosphonates of the formula R₁—CH₂—PO₃R₂⁻, wherein R₁ and R₂ are defined as follows: R₁ contains a reactive group suitable for functionalizing the primary alcohol of the carbohydrate backbone including, but not limited to epoxides, alkyl iodides/bromides/chlorides, and sulfonic acid esters; and R₂ is H, CH₃, CH₂CH₃ or similar aliphatic carbon chains.

In another embodiment, the negative charge is imparted by phosphorylating the primary alcohol of the carbohydrate backbone using a suitable phosphorylating agent including, but not limited to, enzymatic phosphorylating agents such as Baker's yeast hexokinase, phosphorus oxychloride, and 5- or 6-membered ring phosphate esters.

In another embodiment, the negative charge is imparted using sulfonates of the formula R—CH₂—SO₃⁻, wherein R contains a reactive group suitable for functionalizing the primary alcohol of the carbohydrate backbone including, but not limited to epoxides, alkyl iodides/bromides/chlorides, and sulfonic acid esters.

In another embodiment, the negative charge is imparted by alkylation of the primary alcohol of the carbohydrate backbone using 1,3-propane sultone or 1,4-butane sultone.

In another embodiment, the negative charge is imparted using sulfonates of the formula R—CH₂—OSO₃⁻, wherein R contains a reactive group suitable for functionalizing the primary alcohol of the carbohydrate backbone including, but not limited to epoxides, alkyl iodides/bromides/chlorides, and sulfonic acid esters.

In another embodiment, the negative charge is imparted by alkylation of the primary alcohol of the carbohydrate backbone using 5- or 6-membered ring sulfate esters.

In another embodiment, the particles are deposited as aqueous suspensions.

In another embodiment, the particle deposition is conducted at a temperature above of 273° K (Kelvin).

In another embodiment, the particle deposition is conducted at a pH above 1.

5.1.2. Depositing Complementary Charged Metal Ions or Complementary Charged Metal Complexes on Substrates Bearing a Surface Charge

In another embodiment, the method can comprise depositing complementary charged metal ions or complementary charged metal complexes on substrates bearing a surface charge. The surfaces can then be treated with reducing agents, base, and/or heating to create metal or metal oxide particles.

Chemically treating the surface can comprise using a charged organic molecule, an organic molecule that becomes charged after reacting with the non-planar surface, or an ionizing chemical reagent.

The non-planar surface can be a carbohydrate-based polymer or a protein based polymer with a positive surface charge and the metal complex is negatively charged.

In another embodiment, a method is provided for producing a surface-bonded metallic particle comprising:

(a) providing a substrate comprising a non-planar surface;

(b) depositing a complementary charged metal ion or complementary charged metal complex on the non-planar surface; and

(c) treating the complementary charged metal ion or complementary charged metal complex deposited on the non-planar surface with a treatment selected from the group consisting of treating with a reducing agent, treating with a base or heating to create metal or metal oxide particles, producing the surface-bonded metallic particle.

In a specific embodiment, the invention provides a method for surface-bonding metallic particles to a non-planar surface of a substrate to produce a conformal coating comprising the steps of:

(a) providing a substrate comprising a non-planar surface;
(b) depositing complementary charged metal ions or complementary charged metal complexes on the non-planar surface; and
(c) treating the complementary charged metal ions or complementary charged metal complexes deposited on the non-planar surface with a treatment selected from the group consisting of treating with a reducing agent, treating with a base or heating, producing the conformal coating of surface-bonded metallic particles, wherein: the surface-bonded particles have cross-sectional diameters of 2-2000 nm, the average distance between adjacent surface-bonded particles across the entire non-planar surface is no greater than 10 times the largest cross-sectional dimension of any of the surface-bonded particles, and the attachment of the surface-bonded particles to the surface is through electrostatic self-assembly.

In a specific embodiment, the positive surface charge can be imparted using an alkyl ammonium salt of the formula (R₁, R₂, R₃, R₄)—N⁺, wherein R₁-R₄ groups are defined as follows: R₁ contains a reactive group suitable for functionalizing the primary alcohol of the carbohydrate backbone or the primary amines of the protein backbone including, epoxides, alkyl iodides/bromide/chlorides, sulfonic acid esters, and activated carboxylic acids such as N-hydroxy succinimidyl esters for amine attachment; and R₂-R₄ are H, CH₃, CH₂CH₃ or similar aliphatic carbon chains, and groups comprising a 5- or 6-membered cyclic ammonium salt.

In another specific embodiment, the positive charge is imparted using cationic N-alkylated aromatic heterocycles including, but not limited to, pyridinium and imidazolium derivatives having the following general structures:

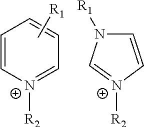

wherein R₁ and R₂ groups are defined as follows: R₁ contains a reactive group suitable for functionalizing the primary alcohol of the carbohydrate backbone or the primary amines of the protein backbone including, epoxides, alkyl iodides/bromide/chlorides, sulfonic acid esters, and activated carboxylic acids such as N-hydroxy succinimidyl esters for amine attachment; and R₂ is H, CH₃, CH₂CH₃ or similar aliphatic carbon chains.

In another embodiment, R₁ is H, and R₂ contains a reactive group suitable for functionalizing the primary alcohol of the carbohydrate backbone or the primary amines of the protein backbone including, epoxides, alkyl iodides/bromide/chlorides, sulfonic acid esters, and activated carboxylic acids such as N-hydroxy succinimidyl esters for amine attachment.

In another embodiment the positive charge can be imparted by using a sulfonium salt of the formula (R₁, R₂, R₃)—S⁺, wherein R₁-R₃ groups are defined as follows: R₁ contains a reactive group suitable for functionalizing the primary alcohol of the carbohydrate backbone or the primary amines of the protein backbone including, epoxides, alkyl iodides/bromide/chlorides, sulfonic acid esters, and activated carboxylic acids such as N-hydroxy succinimidyl esters for amine attachment; and R₂ and R₃ are H, CH₃, CH₂CH₃ or similar aliphatic carbon chains.

In one embodiment, the negative charge can be imparted using phosphonates of the formula R₁—CH₂—PO₃R₂, wherein R₁ and R₂ groups are defined as follows: R₁ contains a reactive group suitable for functionalizing the primary alcohol of the carbohydrate backbone including, but not limited to epoxides, alkyl iodides/bromides/chlorides, and sulfonic acid esters; and R₂ is H, CH₃, CH₂CH₃ and similar aliphatic carbon chains.

In another embodiment, the negative charge can be imparted by phosphorylating the primary alcohol of the carbohydrate backbone using a suitable phosphorylating agent including, but not limited to, enzymatic phosphorylating agents such as Baker's yeast hexokinase, phosphorus oxychloride, and 5- or 6-membered ring phosphate esters.

In another embodiment, the negative charge can be imparted using sulfonates of the formula R—CH₂—SO₃⁻, wherein R contains a reactive group suitable for functionalizing the primary alcohol of the carbohydrate backbone including, but not limited to epoxides, alkyl iodides/bromides/chlorides, and sulfonic acid esters.

In another embodiment, the negative charge can be imparted by alkylation of the primary alcohol of the carbohydrate backbone using 1,3-propane sultone or 1,4-butane sultone.

In another embodiment, the negative charge can be imparted using sulfonates of the formula R—CH₂—OSO₃⁻, wherein R contains a reactive group suitable for functionalizing the primary alcohol of the carbohydrate backbone including, but not limited to epoxides, alkyl iodides/bromides/chlorides, and sulfonic acid esters.

In another embodiment, the negative charge can be imparted by alkylation of the primary alcohol of the carbohydrate backbone using 5- or 6-membered ring sulfate esters.

In another embodiment, the method can comprise covalently attaching chemically modified particles to a chemically modified non-planar surface. The non-planar surface can be chemically modified with an organic molecule that has a functional group that will react at the repeating functional groups of the non-planar surface and has another functional group that allows covalent attachment of chemically modified particles.

According to this embodiment, the charged metal ion or charged metal complex can be deposited onto the non-planar surface in aqueous solutions. The in situ particle formation can be conducted in aqueous or organic solutions. Heating can be at a temperature range above 273° K. The pH of the solution can be above 1.

In another embodiment, the in situ particle formation is done by reducing positive metal ions or negative metal ion complexes deposited onto the non-planar surface using reducing agents that include, but are not limited to, NaBH₄, NaBH₃CN, hydrazine, sodium citrate, and sodium ascorbate.

In another embodiment, the in situ particle formation is done by conversion of positive metal ions deposited onto the non-planar surface into metal oxide particles.

5.1.3. Covalently Attaching Chemically Modified Particles that Contain Surface Groups

In another embodiment, the method can comprise attaching chemically modified particles that contain surface groups that allows covalent attachment to the chemically modified non-planar surfaces.

In another embodiment, the chemically modified particles can be functionalized metal particles (e.g., Au, Ag, Cu, Pt, Pd), functionalized metal oxide particles (e.g. ZnO, Ti O₂, SnO), functionalized non-metal oxide particles (e.g. SiO₂), or functionalized organic polymeric particles (e.g., polyacrylic acid).

In another embodiment, the particles can comprise copper oxide, barium sulfate, magnesium oxide, zirconium oxide, yttrium-stabilized zirconium oxide, or barium titanate.

In a specific embodiment, a method is provided for surface-bonding particles to a chemically modified non-planar surface of a substrate to produce a conformal coating comprising the step of:

(a) providing a substrate comprising a chemically modified non-planar surface; and
(b) covalently attaching chemically functional particles to the chemically modified non-planar surface, producing the conformal coating of surface-bonded particles, wherein the surface-bonded particles have cross-sectional diameters of 2-2000 nm, the average distance between adjacent surface-bonded particles across the entire non-planar surface is no greater than 10 times the largest cross-sectional dimension of any of the surface-bonded particles, and the attachment of the surface-bonded particles to the surface is through covalent bonding.

Also provided is a method for producing a surface-bonded particle comprising: (a) providing a substrate comprising a chemically modified non-planar surface; and (b) covalently attaching a chemically functional particle to the chemically modified non-planar surface, producing the surface-bonded particle.

5.1.4. Hydrogen Bonding Between Hydrogen Bond Donors/Acceptors on Non-Planar Surface and Complementary Hydrogen Bond Donors/Acceptors on Particles

In another embodiment, the method can comprise employing hydrogen bonding between hydrogen bond donors/acceptors on the non-planar surface and complementary hydrogen bond donors/acceptors on the particles.

The particles can have surface groups that are capable of hydrogen bonding, or the particles can be functionalized to give surface groups capable of hydrogen bonding with the non-planar surface.

In one embodiment, metal or metal oxide particles are functionalized using a chemical reagent that has at least one reactive group that is capable of binding the metal or metal oxide particles and at least one group that is a hydrogen bond donor and/or acceptor.

The hydrogen bond donors/acceptors can include, but are not limited to, the following classes of compounds: carboxylic acids, amides, imides, amines, alcohols, and nucleobases (e.g., adenine and thymine).

In a specific embodiment, a method is provided for surface-bonding particles to a non-planar surface of a substrate to produce a conformal coating comprising the step of:

(a) providing a substrate comprising a non-planar surface wherein the non-planar surface comprises hydrogen bond donors/acceptors;

(b) depositing chemically functional particles on the non-planar surface, producing the conformal coating of surface-bonded particles, wherein:

the chemically functional particles comprise hydrogen bond donors/acceptors,

hydrogen bonding occurs between the hydrogen bond donors/acceptors on the particles and complementary hydrogen bond donors/acceptors on the non-planar surface,

the surface-bonded particles have cross-sectional diameters of 2-2000 nm,

the average distance between adjacent surface-bonded particles across the entire non-planar surface is no greater than 10 times the largest cross-sectional dimension of any of the surface-bonded particles, and

the attachment of the surface-bonded particles to the surface is through electrostatic self-assembly mediated through hydrogen bonding.

A method is also provided for producing a surface-bonded particle comprising:

(a) providing a substrate comprising a non-planar surface wherein the non-planar surface comprises hydrogen bond donors/acceptors;

(b) reacting a chemically functional particle with the non-planar surface, wherein:

the chemically functional particle comprises a hydrogen bond donor/acceptor, and hydrogen bonding occurs between the hydrogen bond donor/acceptor on the chemically functional particle and a complementary hydrogen bond donor/acceptor on the non-planar surface, producing the surface-bonded particle.

In another embodiment, the particles are organic polymeric particles bearing hydrogen bonding donors/acceptors including, but not limited to, polymers and copolymers comprised of polyamides, polycarboxylic acids (e.g., acrylic acid), polysaccharides (e.g., cellulose, cellulose acetate), polyalcohols (e.g., polyvinylalcohol), polyamines, polyaminoacids (e.g., polylysine), polyvinylpyrrolidone, polyethylene oxide, and specialized fibers of block copolymers having nucleobase functionality (e.g., adenine and thymine).

In another embodiment, the non-planar surface is comprised of fibers of nylons or combinations of nylons including, but not limited to, nylon-6, nylon-6,6, and nylon-12, and wherein the particles are metal particles with carboxylic acid surface groups.

In another embodiment, the particles are deposited as aqueous suspensions.

In another embodiment, the particle deposition is conducted at a temperature above 273° K.

In another embodiment, the particle deposition is conducted above a pH range of 1.

In another embodiment, the conformal coating of particles is controlled by pH in order to maximize the hydrogen bonding interactions between the non-planar surface and the particles.

5.1.5. Plasma Treating Non-Planar Surface

In another embodiment, the method can comprise the step of plasma treating the non-planar surface to impart a surface charge. The method can further comprise subsequently depositing complementary charged particles. In one embodiment, the non-planar surface can be a polymer with a negative surface charge and the particle can be positively charged.

In a specific embodiment, a method is provided for surface-bonding particles to a non-planar surface of a substrate to produce a conformal coating comprising the steps of:

(a) providing a substrate comprising a non-planar surface;
(b) plasma-treating the non-planar surface to impart a surface charge; and
(c) depositing complementary charged particles on the non-planar surface, producing the conformal coating of surface-bonded particles, wherein the surface-bonded particles have cross-sectional diameters of 2-2000 nm, the average distance between adjacent surface-bonded particles across the entire non-planar surface is no greater than 10 times the largest cross-sectional dimension of any of the surface-bonded particles, and the attachment of the surface-bonded particles to the surface is through electrostatic self-assembly.

A method is also provided for producing a surface-bonded particle comprising:

(a) providing a substrate comprising a non-planar surface;
(b) plasma treating the non-planar surface to impart a surface charge; and
(c) depositing a complementary charged particle on the plasma-treated non-planar surface, producing the surface-bonded particle.

In another embodiment, the method can comprise the step of plasma treating the non-planar surface to impart a surface charge, followed by depositing complementary charged metal ions or complementary charged metal complexes.

The method can further comprise treating such surfaces with reducing agents, base, and/or heating to create metal or metal oxide particles.

In a specific embodiment, a method is provided for surface-bonding metallic particles to a non-planar surface of a substrate to produce a conformal coating comprising the steps of:
(a) providing a substrate comprising a non-planar surface;
(b) plasma treating the non-planar surface to impart a surface charge;
(c) depositing complementary charged metal ions or complementary charged metal complexes on the non-planar surface; and
(d) treating the complementary charged metal ions or complementary charged metal complexes deposited on the non-planar surface with a treatment selected from the group consisting of treating with a reducing agent, treating with a base or heating, producing the conformal coating of surface-bonded metallic particles, wherein:

the surface-bonded particles have cross-sectional diameters of 2-2000 nm,

the average distance between adjacent surface-bonded particles across the entire non-planar surface is no greater than 10 times the largest cross-sectional dimension of any of the surface-bonded particles, and

the attachment of the surface-bonded particles to the surface is through electrostatic self-assembly.

A method is also provided for producing a surface-bonded metallic particle comprising:

(a) providing a substrate comprising a non-planar surface;
(b) plasma treating the non-planar surface to impart a surface charge;
(c) depositing a complementary charged metal ion or complementary charged metal complex with the plasma-treated non-planar surface; and
(d) treating the complementary charged metal ion or complementary charged metal complex deposited on the non-planar surface with a treatment selected from the group consisting of treating with a reducing agent, treating with a base or heating, producing the surface-bonded metallic particle.

The charged metal ion or charged metal complex can be deposited onto the non-planar surface in aqueous solutions. The in situ particle formation can be conducted in aqueous or organic solutions. Heating can be at a temperature range above 273° K. The pH of the solution can be above 1.

In another embodiment, the in situ particle formation is done by reducing positive metal ions or negative metal ion complexes deposited onto the non-planar surface using reducing agents that include, but are not limited to, NaBH₄, NaBH₃CN, hydrazine, sodium citrate, and sodium ascorbate.

In another embodiment, the in situ particle formation is done by conversion of positive metal ions deposited onto the non-planar surface into metal oxide particles.

In another embodiment, the non-planar surface is treated with oxygen plasma to give a negative surface charge and the metal ion is positively charged.

In another embodiment, the non-planar surface is treated with ammonia/helium plasma to give a positive surface charge and the metal ion complex is negatively charged.

In another embodiment, the non-planar surface is a carbohydrate-based polymer with a negative surface charge and the metal ion is positively charged.

In another embodiment, the attachment of the particle to the surface can be accomplished through either through electrostatic self-assembly or covalent bonding.

The non-planar surface can be a polymer with a negative surface charge and the metal ion is positively charged. For example, the negative charge is imparted using carboxylates of the formula R—CH₂—COO—, wherein R contains a reactive group for functionalizing the primary alcohol of the carbohydrate backbone including, but not limited to epoxides, alkyl iodides/bromides/chlorides, and sulfonic acid esters.

In one embodiment, the particle is a metal or metal oxide and is functionalized with a chemical reagent having at least one group capable of binding to the metal or metal oxide and at least one group that is charged.

In another embodiment, the particle is an organic polymeric particle having a positively charged surface including, but not limited to, polyalkylammonium salts and cyclic polydiallylammonium salts.

In another embodiment, the particle is an organic polymeric particle having a negatively charged surface including, but not limited to, polystyrene sulfonate, polyacrylic acid, and polyglutamic acid.

In another embodiment, the negative charge is imparted using carboxylates of the formula R—CH₂—COO—, wherein R contains a reactive group for functionalizing the primary alcohol of the carbohydrate backbone including, but not limited to, epoxides, alkyl iodides/bromides/chlorides, and sulfonic acid esters.

In another embodiment, the negative charge is imparted using phosphonates of the formula R₁—CH₂—PO₃R₂, wherein R₁ and R₂ are defined as follows: R₁ contains a reactive group suitable for functionalizing the primary alcohol of the carbohydrate backbone including, but not limited to epoxides, alkyl iodides/bromides/chlorides, and sulfonic acid esters; and R₂ is H, CH₃, CH₂CH₃ or similar aliphatic carbon chains.

In another embodiment, the negative charge is imparted by phosphorylating the primary alcohol of the carbohydrate backbone using a suitable phosphorylating agent including, but not limited to, enzymatic phosphorylating agents such as Baker's yeast hexokinase, phosphorus oxychloride, and 5- or 6-membered ring phosphate esters.

In another embodiment, the negative charge is imparted using sulfonates of the formula R—CH₂—SO₃⁻, wherein R contains a reactive group suitable for functionalizing the primary alcohol of the carbohydrate backbone including, but not limited to epoxides, alkyl iodides/bromides/chlorides, and sulfonic acid esters.

In another embodiment, the negative charge is imparted by alkylation of the primary alcohol of the carbohydrate backbone using 1,3-propane sultone or 1,4-butane sultone.

In another embodiment, the negative charge is imparted using sulfonates of the formula R—CH₂—OSO₃⁻, wherein R contains a reactive group suitable for functionalizing the primary alcohol of the carbohydrate backbone including, but not limited to epoxides, alkyl iodides/bromides/chlorides, and sulfonic acid esters.

In another embodiment, the negative charge is imparted by alkylation of the primary alcohol of the carbohydrate backbone using 5- or 6-membered ring sulfate esters.

In another embodiment, the particles are deposited as aqueous suspensions.

In another embodiment, the particle deposition is conducted at a temperature above of 273° K.

In another embodiment, the particle deposition is conducted at a pH above 1.

In another embodiment, the method can comprise the step of treating the non-planar surface iteratively, i.e., by a layer-by-layer treatment process. The iterative process uses sequential chemical modification steps to form a plurality of layers (multilayers) of particles. The chemical modification steps can be performed using electrostatic self-assembly, covalent attachment, or combinations of both.

5.2. Polymeric, Non-Planar, Topographically Uneven Surfaces

A conformal (i.e., uniform) coating of chemically functional particles on a polymeric, non-planar, topographically uneven surface is provided. The conformal coating can be produced by the methods of the invention described in Section 5.1.

In one embodiment, the polymeric, non-planar, topographically uneven surface can comprise one or more fibers having a diameter in the range of 10 nm-100 μm.

Many types of fibers known in the art are suitable for use according to the methods of the invention. The fibers can be organic or inorganic. In one embodiment, the fibers comprise one or more components including, but not limited to, bi- and tri-component fibers in which one of the components is either organic or inorganic.

In another embodiment, the fibers are part of a textile including, but not limited to, woven textile, non-woven textile, woven composite, knit, braid and yarn.

In another embodiment, the fibers are inorganic fibers including, but not limited to, glass fibers based on silica and ceramic fibers comprising alumina, beryllia, magnesia, thoria, zirconia, silicon carbide, and/or quartz.

The polymeric, non-planar, topographically uneven surface can comprise natural or synthetic carbohydrate-based fibers including, but not limited to, cellulose, cellulose acetate, and cotton. In another embodiment, the surface can comprise natural protein-based fibers including, but not limited to, wool, collagen, and silk.

The polymeric, non-planar, topographically uneven surface can comprise organic synthetic fibers capable of participating in hydrogen bonding, which include, but are not limited to, fibers of polyamides (e.g. nylons, aramids, and acrylamides), polycarboxylic acids (e.g., acrylic acid), polysaccharides (e.g., cellulose, cellulose acetate), polyalcohols (e.g., polyvinylalcohol), polyamines, polyaminoacids (e.g., polylysine), polyvinylpyrrolidone, polyethylene oxide, and specialized fibers of block copolymers having nucleobase functionality (e.g., adenine and thymine).

In another embodiment, the polymeric, non-planar, topographically uneven surface can comprise an organic synthetic fiber that is substitutionally inert including, but not limited to, polyamides (e.g. nylons, aramids, etc.), polyesters, fluoropolymers, polyimides, and polyolefins (e.g., polyethylenes such as TYVEK®, polypropylene).

In certain embodiment wherein the fibers are part of a textile material, the textile material can be a composite of synthetic fiber and natural fiber, a composite of synthetic fibers, or a composite of natural fibers including, but not limited to, cotton and nylon blends, cotton and wool blends, cotton and polyester blends.

In other embodiments, the textile material can be a composite of organic and/or inorganic fibers including, but not limited to synthetic fibers (organic and/or inorganic) and/or natural fibers.

5.3. Conformal Coating on a Polymeric, Non-Planar, Topographically Uneven Surface

A conformal (i.e., uniform) coating of chemically functional particles on a polymeric, non-planar, topographically uneven surface is provided. The conformal coating can be produced by the methods of the invention described in Section 5.1.

The conformal coating produced by the methods of the invention can comprise particles having a cross-sectional diameter ranging from 2 to 2,000 nanometers.

In one embodiment, the average distance between adjacent particles across the entire non-planar surface can be no greater than 10 times the largest cross sectional dimension of particle.

In one embodiment, the particles can be metallic wherein “metallic” indicates metal particles (e.g., Au, Ag, Cu, Pt, Pd) and metal oxide particles (e.g. ZnO, TiO₂, SnO₂).

In another embodiment, the particles can comprise copper oxide, barium sulfate, magnesium oxide, zirconium oxide, yttrium-stabilized zirconium oxide, or barium titanate.

In another embodiment, the particles can be organic and can include, but are not limited to, polystyrene sulfonate based particles, polyacrylate based particles, and polyglutamate based particles, polyalkylammonium salt based particles, and cyclic polydiallylammonium salt based particles.

In another embodiment, the particles can be inorganic and non-metallic and include, but are not limited to, SiO₂.

As described above, in certain embodiments, particles can be conformally coated on a non-planar surface by chemically modifying the non-planar surface to impart a surface charge, covalently attached to a chemically modified non-planar surface, or deposited on a plasma-treated non-planar surface imparted with a surface charge. According to these embodiments, the coating particles can be hybrid particles including, but not limited to, semiconductor quantum dots and core/shell particles comprising materials selected from the group consisting of metals, metal oxides, polymers, and non-metal oxides (e.g., SiO₂).

In another embodiment, the particles can be spherical and/or non-spherically shaped, e.g., rods, cubes, polygons, polyhedra, etc.

In another embodiment, the particles can actively function as devices (e.g., sensor, particles that mediate controlled release of agents, etc.).

The particles can also be functionalized with organic and/or inorganic components. Chemically modified particles can be, for example, functionalized metal particles (e.g., Au, Ag, Cu, Pt, Pd), functionalized metal oxide particles (e.g., ZnO, TiO₂, SnO), functionalized non-metal oxide particles (e.g. SiO₂), or functionalized organic polymeric particles (e.g., polyacrylic acid).

In another embodiment, the particles derive from an intermediate substrate comprised of charged non-planar surfaces complexed with oppositely charged metal ions or oppositely charged metal complexes.

5.4. Textile Fibers Functionalized with Particles for Use in Spectroscopic Detection Methods

Textile fibers and other fibrous substrates functionalized with particles are provided for use in the detection of targets of interest by spectroscopic methods.

In one embodiment, a substrate is provided that comprises a conformal coating on its surface, wherein the coating comprises a plurality of chemically functional particles. Conformal coatings on substrates (including but not limited to non-planar substrates) and methods of making such coatings are described hereinabove and in international published application WO2009/129410A1 (PCT/US09/40853 filed Apr. 16, 2009), entitled “Conformal Particle Coatings on Fibrous Material.”

Particles can have a cross-sectional diameter of 2-2000 nm, and the average distance between adjacent particles across the entire non-planar surface is no greater than 10 times the largest cross-sectional dimension of any particle in the plurality. The attachment of the particles to the surface can be through electrostatic self-assembly or covalent bonding. ‘Particles’ are also referred to herein as ‘nanoparticles’ (NPs), although as described above, they can range in size up to 2 μm (2000 nm).

In one embodiment, the substrate is a fiber. In another embodiment, the substrate is a polymer.

In another embodiment, the substrate comprises a plurality of fibers.

In another embodiment, the fibers have cross-sectional diameters of 10 nm-100 μm.

In another embodiment, the fibers are organic or inorganic.

In another embodiment, the inorganic fibers comprise glass or ceramic.

In another embodiment, the ceramic fibers comprise alumina, beryllia, magnesia, thoria, zirconia, silicon carbide, or quartz.

In another embodiment, the fibers are a bi-component or tri-component fibers.

In another embodiment, the substrate is a textile.

In another embodiment, the textile is a woven textile, a non-woven textile, a woven composite, a knit, a braid or a yarn.

In another embodiment, the substrate comprises natural or synthetic carbohydrate-based fibers.

In another embodiment, the natural or synthetic carbohydrate-based fibers comprise cellulose, cellulose acetate or cotton.

In another embodiment, the substrate comprises natural protein-based fibers.

In another embodiment, the natural protein-based fibers comprise wool, collagen or silk.

In another embodiment, the substrate comprises organic synthetic fibers capable of participating in hydrogen bonding.

In another embodiment, the organic synthetic fibers comprise polyamides, polycarboxylic acids, polysaccharides, polyalcohols, polyamines, polyaminoacids, polyvinylpyrrolidone, polyethylene oxide or specialized fibers of block copolymers having nucleobase functionality.

In another embodiment, the organic synthetic fibers are substitutionally inert.

In another embodiment, the substitutionally inert organic synthetic fibers comprise polyamides, polyesters, fluoropolymers, polyimides or polyolefins.

In another embodiment, the particles are metallic.

In another embodiment, the particles comprise metal or metal oxide.

In another embodiment, the particles are organic.

In another embodiment, the organic particles are selected from the group consisting of polystyrene sulfonate based particles, polyacrylate based particles, and polyglutamate based particles, polyalkylammonium salt based particles, and cyclic polydiallylammonium salt based particles.

In another embodiment, the particles are inorganic and non-metallic. In another embodiment, the particles comprise SiO₂.

In another embodiment, the particles can be spherical and/or non-spherical, e.g., rods, cubes, polygons, stars, mushroom or mushroom ‘caps,’ or any other particle shape known in the art.

In another embodiment, the particles are functionalized. In a specific embodiment, the particles are functionalized with a spectroscopically-active molecule, as described in more detail hereinbelow.

In another embodiment, the particles are functionalized metal particles, functionalized metal oxide particles, functionalized non-metal oxide particles or functionalized organic polymeric particles.

In one embodiment, the detection of the fiber by spectroscopic methods is increased. In another embodiment, the detection of the fiber by spectroscopic methods is decreased.

5.5. Textile fibers functionalized with metallic particles for use in SERS, SEIRA and SEF Spectroscopic Detection Methods

In one embodiment, a textile fiber functionalized with noble metal (‘metal’ or ‘metallic’) particles is provided. Methods for producing such functionalized textile fibers are also provided. These textiles can be used as platforms for detection of surface-enhanced Raman scattering (SERS), enhanced infrared absorption (SEIRA), and/or surface-enhanced fluorescence (SEF).

According to the methods disclosed herein, such textile substrates will be robust, can be prepared through simple processing, and will give very high and uniform metal particle surface coverage of the fiber surfaces. The resulting nanostructured composite materials display a number of properties that cannot be realized with textiles currently known in the art.

The fiber material for use in methods for detecting SERS, SEIRA and SEF signatures can be organic or inorganic and can be part of textiles, wherein the textiles can include but are not limited to woven textiles, non-woven textiles, woven composites, braids, or yarns. Fibers and textiles for use in the methods of the invention are described in detail herein, in particular in Sections 5.2 and 5.4.

In one embodiment, functionalized textile fibers for use in the signature detection methods are produced by performing layer-by-layer (LBL) self-assembly of metallic particles on natural and synthetic textile substrates (e.g., cotton, nylon, and wool). Such methods are known in the art. In a specific embodiment, the methods described in hereinabove and in WO2009/129410A1 are used.

In specific embodiments, metallic particles can be deposited on the surface of cationic or anionic cotton fibers using electrostatic interactions or in situ metal ion reduction (using methods described hereinabove and in WO2009/129410A1).

Metallic particles can be deposited on the surface of nylon-6 nanofibers using hydrogen bond-mediated electrostatic interactions (using methods described hereinabove and in WO2009/129410A1).

The metallic, bimetallic or multimetallic particles (also referred to collectively herein as ‘metal’ or ‘metallic’ particles) for use in methods for detecting SERS, SEIRA or SEF signatures can be metal particles that comprise, e.g., Au, Ag, Cu, or combinations thereof. Such metallic particles are known in the art to be Raman-enhancing, SERS-enhancing, SEIRA-enhancing and/or SEF-enhancing applications in which such spectroscopic signatures are to be detected.

Metallic particles for use in SERS-, SEIRA- or SEF-enhancing applications are preferably assembled on fiber material to provide a uniform plasmon absorption band of the fiber material that is in the range of 400-2000 nm. The magnitude of the enhancement—or of the spectroscopic signal in general—is unique to the spectroscopically (i.e., SERS-, SEIRA- and SEF-) active fibers provided herein, as substantially less (and in some cases no) enhanced Raman, IR or fluorescent signal will be observed for the organic chemicals absorbed onto aqueous suspensions of metallic particles, or absorbed onto textile fibers (e.g., cotton, nylon) alone.

In addition, metallic particles for use in SEF-enhancing applications are preferably chosen to minimize radiationless energy transfer between the particle coating and the fluorescent molecule or molecules.

In a specific embodiment, the metallic particles are functionalized with one or more species of Raman (SERS)-active (‘Raman reporter’) molecules for use in applications wherein a SERS signature is detected.

In another specific embodiment, the metallic particles are functionalized with one or more species of infrared (SEIRA)-active molecules for use in applications wherein a SEIRA signature is detected.

In another specific embodiment, the metallic particles are functionalized with one or more species of SEF-active molecules for use in applications wherein a SEF signature is detected.

Particle-coated textiles can be chemically functionalized without affecting the particle-textile electrostatic interactions. The particle-coated textiles can be treated with aqueous solutions of the SERS, SEIRA or SEF active molecules using methods known in the art. Substrates can be treated with any of the various art-known and/or commercially available organic chemicals that act as SERS, SEIRA or SEF active molecules.

The resulting fibers will exhibit enhanced signal of the absorbed chemicals using the appropriate excitation (e.g., for SERS, SEIRA and SEF, near-infrared laser excitation at 785 nm).

Combinations of two or more SERS-, SEIRA- or SEF-active species can be used in multiplex format.

In a preferred embodiment, SERS- or SEIRA-active molecules are spaced within 8 nm of the enhancing particle surface and/or have functionality that provides molecule coordination to the enhancing particles. Molecular coordination to SERS, SEIRA, and SEF surfaces is known in the art. The molecules will have distinguishable spectral signatures using the appropriate spectroscopic reader.

In another preferred embodiment, the fluorescent (SEF-active) molecule or molecules for use in a SEF spectroscopic signature application method are spaced at a distance of between 3 nm and 60 nm from the surface of the fluorescence enhancing particle. The molecules will have distinguishable spectral signatures using a fluorescence spectroscopic reader.

Any Raman-active molecule known in the art can be used, including, but not limited to, fluorescein isothiocyanate, rhodamine β isothiocyanate, dimethyl yellow isothiocyanate, 4-4′-dipyridyl, and mercaptopyridine derivatives such as 2-mercaptopyridine, 2-mercaptopyridine N-oxide and 4-mercaptopyridine (4-MP), thiophenol and derivatives thereof.

Any infrared-active molecule known in the art can be used. Although some may be more active than others, any molecule known in the art to give an infrared vibrational spectrum can be used. Generally, infrared-active molecules have to have a permanent dipole, and a given IR band in a spectrum reflects the amount of energy that was absorbed at each wavelength. Thus, a molecule having a carbonyl group is ‘IR active.’ Specifically, in SEIRA, vibrational modes of molecules with a change in dipole moment perpendicular to the surface are enhanced (A. Hartstein, J. R. Kirtley, J. C. Tsang, Phys. Rev. Lett. 45 (1980) 201).

Any SEF-active molecule known in the art can be used. Although some may be more active than others, any fluorescent molecule could be used. A particular advantage of SEF is that weakly emitting fluorescent materials (some dyes, proteins, DNA) that have very low intrinsic quantum yields can be transformed into excellent fluorophores. Positioning the molecule next to the metal surface such that the dipole moment of the fluorophore interacts with the surface plasmon of the metal surface can lead to an increase in radiative decay rate and stronger fluorescence emission.

Standard methods of SERS, SEIRA or SEF spectroscopy can be used to detect multiple targets (i.e., spectroscopically active molecules) on fiber(s) (e.g., single fiber, a woven swatch or a fiber mat).

In a specific embodiment, Raman spectra of the chemicals absorbed onto SERS-active fibers can be obtained at a distance of at least 50 millimeters using very low laser power (e.g., ˜10 nanowatts).

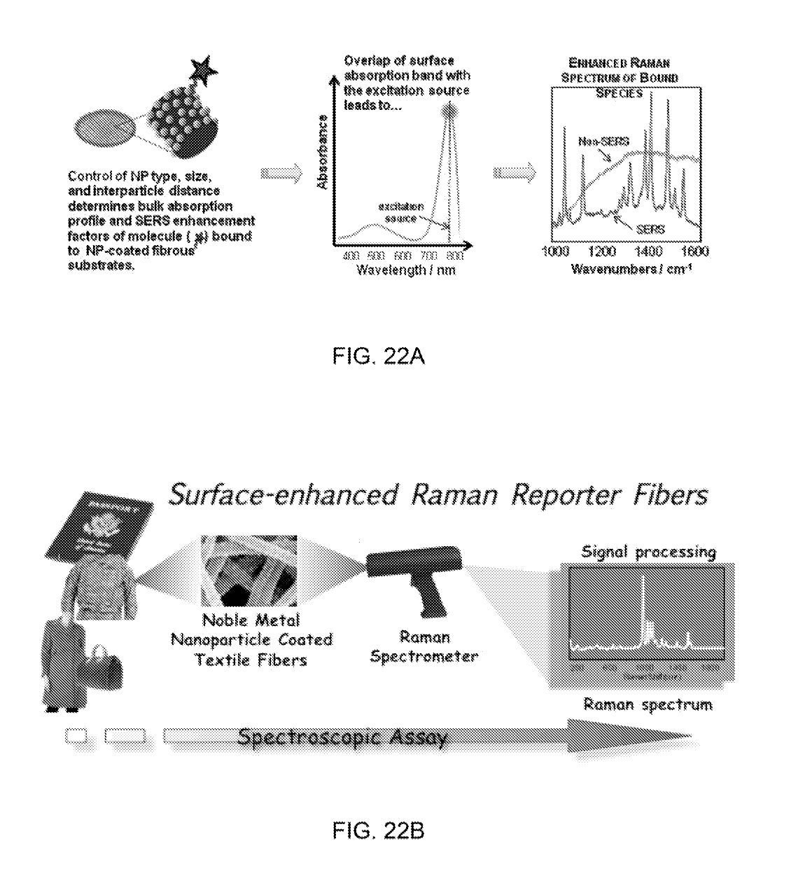

SERS-, SEIRA- and SEF-active textile substrates containing unique spectral fingerprints can be used in a variety of positive identification methods (FIG. 22B). The importance of this technology is far reaching, and can be used in military applications, e.g., for friend-or-foe identification or anti-counterfeiting applications, and in many domestic markets applications such as the commercial clothing industry for anti-counterfeiting and brand verification.

In another embodiment, a method is provided for applying a surface-enhanced Raman scattering (SERS) spectroscopic signature to a fiber material. The method comprises the step of applying a conformal coating, wherein the conformal coating comprises metallic particles that are Raman-enhancing to the fiber material, and a Raman-active molecule (or a multiplex of different Raman-active species or molecules), wherein the Raman-active molecule has a measureable and recognizable SERS spectrum or signature.

In another embodiment, a method is provided for applying a surface-enhanced infrared absorption (SEIRA) spectroscopic signature to a fiber material. The method comprises the step of applying a conformal coating, wherein the conformal coating comprises metallic particles that are SEIRA-enhancing to the fiber material, and a near-infrared (NIR) or mid-infrared (MIR) active molecule (or a multiplex of different NIR- or MIR-active species or molecules), wherein the NIR- or MIR-active molecule has a measureable and recognizable infrared spectrum or signature. NIR- and MIR-active species are well known in the art. Examples of such molecules include, but are not limited to, para-mercaptoanaline, thiophenol, and para-nitrobenzoic acid.

In another embodiment, a method is provided for applying a surface-enhanced fluorescence (SEF) spectroscopic signature to a fiber material. The method comprises the step of applying a conformal coating, wherein the conformal coating comprises metallic particles that are SEF-enhancing to the fiber material, and a fluorescent molecule (or a multiplex of different fluorescent molecules), wherein the fluorescent molecule has a measureable fluorescent spectrum. Any fluorescent molecule known in the art can be used, including, but are not limited to, fluorescent dyes such as fluorescein, rhodamine, malachite green, cyber green, and derivatives of these fluorescent dyes. The metallic nanoparticle size and packing density are preferably chosen to minimize radiationless energy transfer between the nanoparticle coating and the fluorescent molecule or molecules.

5.6. Textile Fibers Functionalized with Particles for Use in Near-Infrared (NIR) and Mid-Infrared (MIR) Detection Methods

In another embodiment, a fiber material is provided that comprises a conformal coating of non-reflective particles that reduces the reflectance of the underlying fiber material in the range of 0.7-3.0 μm. In another embodiment, the range is 400 nm and 2000 nm.

The particles can be metallic or non-metallic, but are preferably non-metallic. In another embodiment, the particles are selected from the group consisting of polystyrene sulfonate based particles, polyacrylate based particles, and polyglutamate based particles, polyalkylammonium salt based particles, and cyclic polydiallylammonium salt based particles. In a specific embodiment, the particles comprise polystyrene (PS). In another specific embodiment, the particles are spherical or non-spherical (e.g., mushroom-shaped, ‘mushroom caps’) and comprise a co-polymer of polystyrene and polystyrene sulfonate. According to this embodiment, the SO₃— group of the polystyrene sulfonate allows for deposition on a cationic fiber by electrostatic assembly.

In a specific embodiment, the reflectance signature is produced by a laser excitation source (e.g., part of a night vision device (NVD)).

A method is also provided for decreasing the near-infrared and mid-infrared (0.7-3.0 μm) reflectance signature of a fiber material. The method comprises providing a fiber material comprising the conformal coating of non-reflective particles that reduces the reflectance of the underlying fiber material in the range of 0.7-3.0 μm. In another embodiment, the range is 400 nm and 2000 nm.

In another embodiment, a fiber material is provided that comprises a conformal coating of reflective particles and is highly reflective in the range of 0.7-3.0 μm. In another embodiment, the range is 400 nm and 2000 nm.

According to this embodiment, the particles are preferably metallic. In a specific embodiment, the reflectance signature is produced by a laser excitation source (e.g., part of a night vision device (NVD)). Examples of highly reflective particles include, but are not limited to, silver, gold, copper, copper oxide, barium sulfate, magnesium oxide, zirconium oxide, yttrium-stabilized zirconium oxide, barium titanate, etc.

A method is also provided for selectively increasing or enhancing the near-infrared and mid-infrared (0.7-3.0 μm) reflectance signature of a fiber material. The method comprises providing a fiber material that comprises a conformal coating of particles and is highly reflective in the range of 0.7-3.0 p.m. In another embodiment, the range is 400 nm and 2000 nm.

In another embodiment, the reflectance maximum of the fiber material having a conformally particle coating is designed to coincide (or not coincide) with an excitation source with a wavelength within the range of 400 nm and 2000 nm.

A method is also provided for coinciding (or not coinciding) a fiber material with an excitation source by providing a fiber material with a conformally particle coating that is designed to coincide (or not coincide) with an excitation source with a wavelength within the range of 400 nm and 2000 nm.

In another embodiment, a fiber material having a conformal particle coating is provided wherein the reflectance signature of the fiber material unique and has a measurable output using a reflectance spectroscopic reader.

5.7. Methods for Functionalizing Textile Fibers with Nanoparticles for Use in Spectroscopic Applications

The rational design of conformal coatings of particles on fiber materials to affect the absorption, reflection and scattering of incident light are disclosed hereinabove and in WO2009/129410A1 (PCT/US09/40853 filed Apr. 16, 2009, entitled “Conformal Particle Coatings on Fibrous Material”). In one embodiment, particles are conformally deposited onto fibers (e.g., modified cellulose/cotton fibers, nylon-6 nanofibers or wool) using methods described hereinabove and in international published application WO2009/129410A1. In particular, Example 1 hereinbelow, as well as Example 1 of WO2009/129410A1 (both entitled “Efficient Assembly of Metal Nanoparticles on Electrospun Nylon 6 Nanofibers by Control of Interfacial Hydrogen Bonding Interactions”) disclose an efficient, one-step route for uniformly assembling preformed particles on the surface of nanofibers (electrospun nylon 6 nanofibers are used in the example) that is driven by interfacial hydrogen bonding interactions. Metallic particles (Ag, Au, and Pt) are assembled on the nanofibers by controlling the interfacial hydrogen bonding interactions between the amide groups in the nanofiber backbone and the carboxylic acid groups capped on the surface of metallic particles.

In Example 1, nylon 6 nanofiber mats, produced by electrospinning, were immersed into pH-adjusted solutions of metallic particles. One factor determining the assembly phenomena was identified as the hydrogen bonding interactions between the amide groups in the nylon 6 backbone and the carboxylic acid groups capped on the surface of the metallic particles.

The assembly of particles is strongly dependent on the pH of the media, which affects the protonation of the carboxylate ions on the particles and hence, influences the hydrogen bonding interaction between nanofibers and particles. High surface coverage of the nanofibers by the particles can be achieved at pH intervals from 3 to 6, whereas only low surface coverage is achieved when the pH is greater than 7.

Particles can be supported on various and diverse substrates such as silica, metals or metal oxides, and polymers in order to tailor those systems for their specific optical, electronic, catalytic, magnetic, or sensor applications (Rotello, V. M., Nanoparticles: Building Blocks for Nanotechnology. Nanostructure Science and Technology, ed. D. J. Lockwood. 2004, New York: Kluwer Academic/Plenum Publishers. 304; Serp, P., M. Corrias, and P. Kalck, Carbon nanotubes and nanofibers in catalysis. Appl. Catal., A, 2003. 253(2): p. 337-358; Shipway, A. N., E. Katz, and I. Willner, Nanoparticle arrays on surfaces for electronic, optical, and sensor applications. ChemPhysChem, 2000. 1(1): p. 18-52). Derivatization of textile substrates can be accomplished using a layer-by-layer (LBL) approach (cotton: Hyde, K., H. Dong, and J. P. Hinestroza, Effect of surface cationization on the conformal deposition of polyelectrolytes over cotton fibers. Cellulose (Dordrecht, Neth.), 2007. 14(6): p. 615-623; Hyde, K., M. Rusa, and J. Hinestroza, Layer-by-layer deposition of polyelectrolyte nanolayers on natural fibers: Cotton. Nanotechnology, 2005. 16(7): p. 422-428); nylon: Dong, H., et al., Assembly of Metal Nanoparticles on Electrospun Nylon 6 Nanofibers by Control of Interfacial Hydrogen-Bonding Interactions. Chem. Mater., 2008. 20(21): p. 6627-6632); wool: Hinestroza, J., unpublished work, 2005).

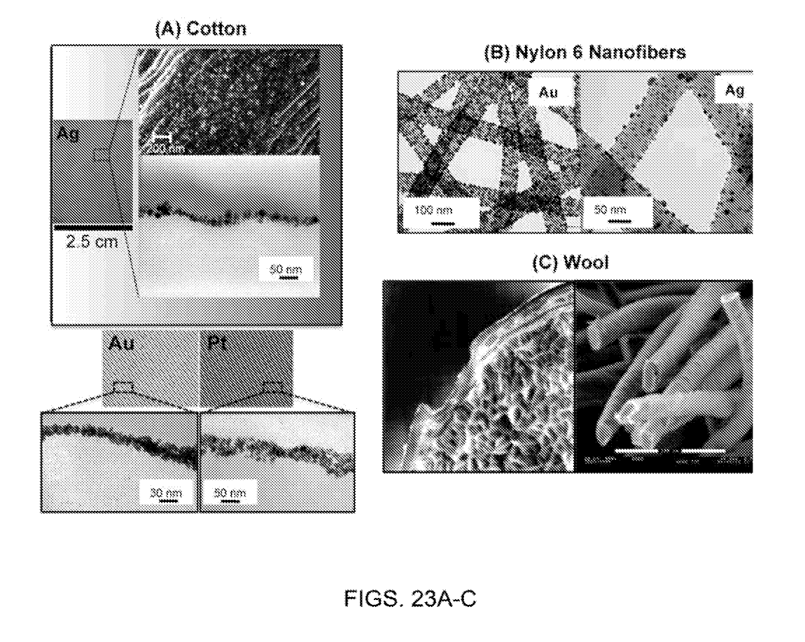

As shown in FIG. 23A cationically modified cotton substrates can be coated with a uniform layer of citrate-stabilized particles using, e.g., electrostatic assembly. The thickness of the individual nanolayers can be tuned at the molecular level by controlling the immersion time, ionic strength of the solution, the pH of the solution as well as the temperature. The method yields a highly uniform surface coverage of metallic particles in this particular example.

The LBL processing of textiles or fabrics is simple, scalable, and compatible with existing wet processing equipment available in textile manufacture. The numerous electrostatic interactions between particles and fibers result in a very stable composite material, and at the same time, the composite has the look and feel of the native material. In addition to natural cellulose/cotton, particles can be efficiently assembled onto nylon (e.g., nylon 6) nanofibers by controlling interfacial hydrogen bonding interactions (FIG. 23B).

A factor determining the assembly phenomena is the hydrogen bonding interactions between the amide groups in the nylon (e.g., nylon 6) backbone and the carboxylic acid groups capped on the surface of the metallic particles. As with particle-cotton composites, the assembly is strongly dependent on the pH of the media, and the conditions can be optimized using methods known in the art to maximize the hydrogen bonding interactions within the particle-nylon composites. The particle-nylon composites are stable for at least one year while being stored under ambient conditions.

To produce modified wool fibers, the wool fibers can be derivatized with a nanolayer of polyelectrolytes, including poly(sodium 4-styrene sulfonate) (PSS) and poly(allylamine hydrochloride) (PAH). Native wool fibers are treated to give cationic functional groups (via a reaction with lysine residues of the proteins on the surface of the wool), followed by controlling the electrostatic bonding between the resulting cationic wool fibers and deposited polyelectrolyte (FIG. 23C).

The above embodiments illustrate very uniform particle-coated textile substrates with high surface coverage. The LBL methodology can be used to produce flexible, multifunctional textiles having unique physico-chemical and optical/spectroscopic properties.

Composite Ag and Au particle functionalized textile substrates are shown in FIGS. 23A-C). Such textile substrates are an attractive class of SERS-active substrate. In addition to containing gold or silver, these substrates exhibit several features that are important in providing large SERS enhancements. Most notably, textile SERS-active substrates have a high density of particle aggregates and interparticle junctions, which are known to give large SERS enhancements due to plasmon hybridization between adjacent particles (Genov, D. A., et al., Resonant Field Enhancements from Metal Nanoparticle Arrays. Nano Lett., 2004. 4(1): p. 153-158; Nordlander, P., et al., Plasmon Hybridization in Nanoparticle Dimers. Nano Lett., 2004. 4(5): p. 899-903). Instead of being random aggregates, the methodology for particle deposition on the surface of the textile fibers, as disclosed in WO2009/129410A1, is controlled by self-assembly. This self-assembly results in a highly uniform coating of densely packed particles, which gives large SERS enhancement factors for molecules localized near the metal surface. The widespread use of cotton, nylon and wool textiles creates a potentially new arena for SERS-based detection, not only in the realm of trace analyte detection, but also qualitative diagnostics such as friend-or-foe identification, anti-counterfeit applications, and tagging, tracking, and identification applications.

SERS-active substrates for detecting SERS signatures can be produced using LBL-based processes known in the art as described above. LBL-based processes known in the art (such as those disclosed in WO2009/129410A1) can be used to control the deposition of metallic particles on textiles such that particle size and interparticle junctions are optimized for maximum SERS activity. SERS-active substrates can be optimized, using methods known in the art, to any relevant excitation source. Proper control of materials at nanoscale metallic surfaces can lead to very large SERS enhancements.

The overall enhancement factors of the SERS-active fibers can be defined by the combined contributions from the metal particle composition, the average interparticle distance (as described above), and the average size of the individual particles. It is well known that huge SERS enhancements can be achieved when the SERS-active substrate exhibits an absorption band (or plasmon band) that corresponds to the wavelength of the excitation source (Nie, S, and S. R. Emory, Probing Single Molecules and Single Nanoparticles by Surface-Enhanced Raman Scattering. Science, 1997. 275(5303): p. 1102-6). Particle size, composition and interparticle distance can all be used, using art-known methods of analysis, to give highly enhanced SERS, such that the average excitation band of the SERS-active fibers is in resonance with the wavelength of the laser source.

The interparticle distance is preferably relatively constant for a given particle-textile composite. Because there is a finite number of particle binding sites on textile fibers, fibers coated with the various particle sizes exhibit different relative interparticle distances. Deposition of metallic particles on various textile substrates can be accomplished as described below.

The methods described herein can also be readily modified by those skilled in the art to produce active substrates that are suitable for use in SEF and SEIRA spectroscopic applications, as well as for substrates for use in detecting decreasing or increasing near-infrared and mid-infrared reflectance, and in coated textiles with coatings that coincide with a NVD laser excitation source or have unique, identifiable reflectance.

5.8. Fibers and Textiles for Use in Spectroscopic Applications

Many types of fibers known in the art and described herein (see, e.g., Sections 5.2 and 5.4) are suitable for use in the methods provided herein for detecting SERS, SEF, SEIRA signatures, for detecting decreasing or increasing near-infrared and mid-infrared reflectance, and detecting signatures in coated textiles with coatings that coincide with a desired laser excitation source or that have unique, identifiable reflectance.

The fibers can be organic or inorganic and can be part of a textile, wherein the textile can include but is not limited to, woven textile, non-woven textile, woven composite, knit, braid and yarn.

In one embodiment, the fibers comprise one or more components including, but not limited to, bi- and tri-component fibers in which one of the components is either organic or inorganic.

In another embodiment, the fibers are inorganic fibers including, but not limited to, glass fibers based on silica and ceramic fibers comprising alumina, beryllia, magnesia, thoria, zirconia, silicon carbide, and/or quartz.

The textile substrate can comprise natural or synthetic carbohydrate-based fibers including, but not limited to, cellulose, cellulose acetate, and cotton. In another embodiment, the substrate can comprise natural protein-based fibers including, but not limited to, wool, collagen, and silk.

The textile substrate can comprise organic synthetic fibers capable of participating in hydrogen bonding, which include, but are not limited to, fibers of polyamides (e.g. nylons, aramids, and acrylamides), polycarboxylic acids (e.g., acrylic acid), polysaccharides (e.g., cellulose, cellulose acetate), polyalcohols (e.g., polyvinylalcohol), polyamines, polyaminoacids (e.g., polylysine), polyvinylpyrrolidone, polyethylene oxide, and specialized fibers of block copolymers having nucleobase functionality (e.g., adenine and thymine)

The textile substrate can comprise an organic synthetic fiber that is substitutionally inert including, but not limited to, polyamides (e.g. nylons, aramids, etc.), polyesters, fluoropolymers, polyimides, and polyolefins (e.g., polyethylenes such as TYVEK® or polypropylene).

In certain embodiment wherein the fibers are part of a textile material, the textile material can be a composite of synthetic fiber and natural fiber, a composite of synthetic fibers, or a composite of natural fibers including, but not limited to, cotton and nylon blends, cotton and wool blends, cotton and polyester blends.

In other embodiments, the textile material can be a composite of organic and/or inorganic fibers including, but not limited to synthetic fibers (organic and/or inorganic) and/or natural fibers.

5.9. Methods for Preparing Cotton-Based Sers-Active Textiles

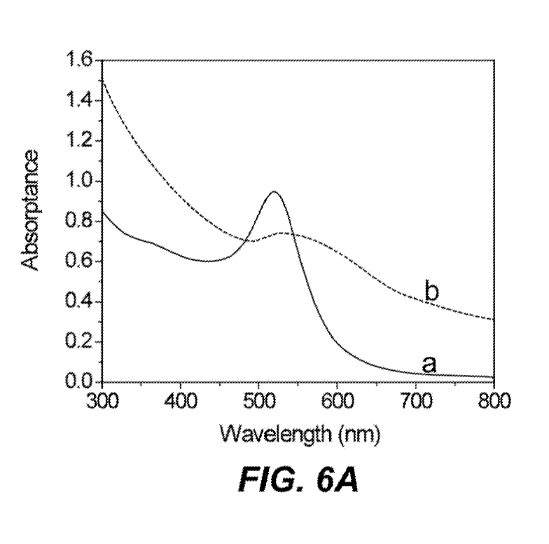

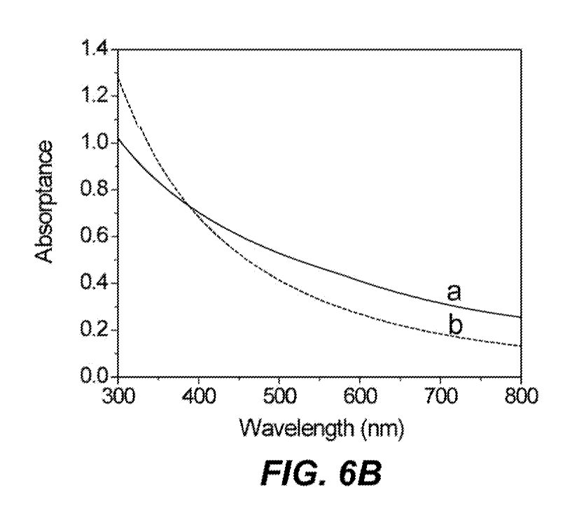

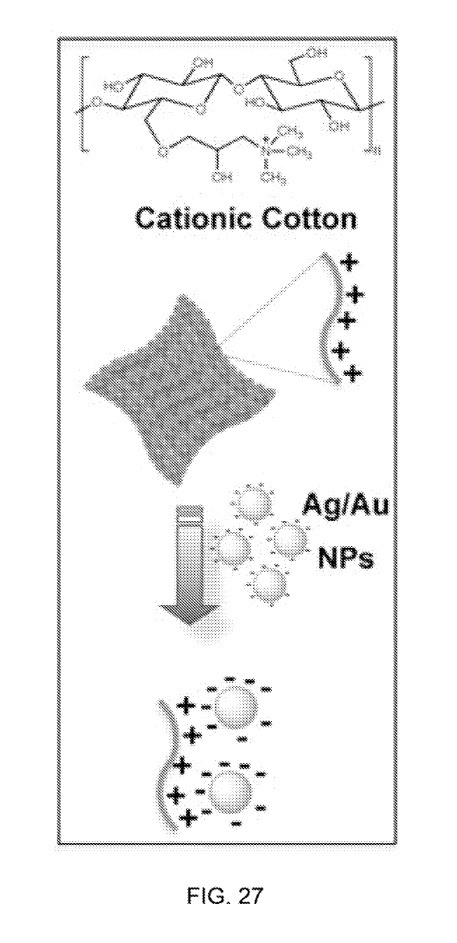

One embodiment of the method for self-assembling particles on cotton substrates is illustrated in FIG. 27. The first step in this method is performing chemical treatment of the cotton to produce cationic surface groups. Using methods known in the art for cotton (Hyde, K., M. Rusa, and J. Hinestroza, Layer-by-layer deposition of polyelectrolyte nanolayers on natural fibers: Cotton. Nanotechnology, 2005. 16(7): p. 422-428), cationic base substrates can be prepared, e.g., by treatment with 2,3-epoxypropyltrimethylammonium chloride in an aqueous alkaline solution. This compound reacts with the hydroxyl groups of cellulose creating cationic surface groups (FIG. 6). The modified cotton can be washed with water to remove excess reagents and dried at elevated temperatures in a commercial dryer (e.g., ˜60° C.).

Citrate stabilized metallic (e.g., Ag and Au) particles can be prepared that have varying sizes using methods known in the art (Brown, K. R., D. G. Walter, and M. J. Natan, Seeding of colloidal Au nanoparticle solutions. 2. Improved control of particle size and shape. Chem. Mater., 2000. 12(2): p. 306-313; Lee, P. C. and D. Meisel, Adsorption and surface-enhanced Raman of dyes on silver and gold sols. J. Phys. Chem., 1982. 86(17): p. 3391-5). In one embodiment, a preferred particle size regime of 20-100 nm is used. The prepared citrate stabilized metallic particles are then deposited onto the cationic cotton as disclosed hereinabove. This electrostatic self-assembly process can be controlled to give a nanolayer of deposited particles on cotton. The thickness of the individual nanolayers can be tuned at the molecular level by controlling the immersion time, ionic strength and pH of the solution, as well as the temperature, using methods known in the art. Cationically modified cotton substrates can be immersed in an aqueous suspension of metallic particles and analyzed by SERS as described herein.

Optimizing the particle deposition process with respect to the amount of particle solution required to treat a specified amount of cotton can be performed using methods known in the art. For example, 3 cm×4 cm swatches of fabric can be immersed in 50 mL of the particle colloidal solutions for 24 hours. Such tests can be scaled up tol square yard of material. After immersion, the metallic particle-coated composites can be washed thoroughly with water to remove adventitiously bound particles and finally dried in a commercial dryer. Particle-coated cotton fabrics can also be continuously agitated in water to test their stability, and the water assayed for presence of metallic particles.

5.10. Methods for Preparing Wool-Based Sers-Active Textiles

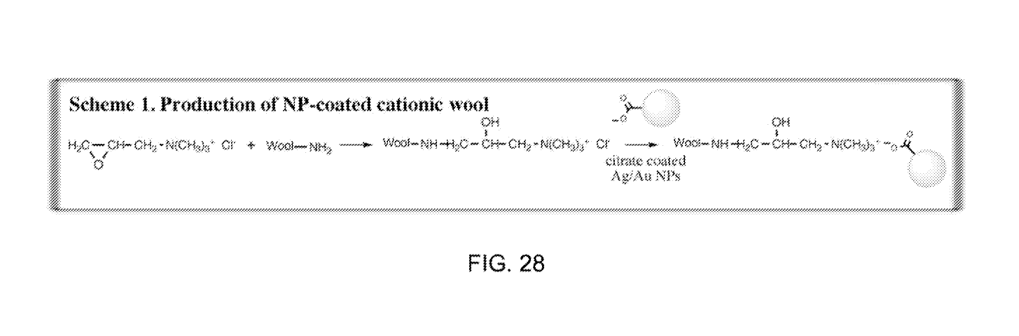

SERS-active wool-based substrates can be prepared as illustrated in Scheme 1 (FIG. 28). As with cotton, this approach can use art-known methods, for example, 2,3-epoxypropyltrimethylammonium chloride and base to produce cationic wool. This reagent reacts with the —NH₂ groups of the lysine residues contained on the surface of wool fibers, and has been reported to enhance the affinity of the modified wool with anionic dyes (Chaudhary, A. N. and B. Smith, Synthesis and properties of cationized wool. AATCC Rev., 2003. 3(1): p. 27-29). As shown in FIG. 23C, LBL-based methodology has been used previously to deposit multilayers of poly(sodium 4-styrene sulfonate) (PSS) and poly(allylamine hydrochloride) (PAH) over woven cationized wool fabrics (using methods disclosed in WO2009/129410A1). This methodology can also be used for the deposition of metallic particles. The conditions for functionalizing wool are the same (or similar to) that described for functionalizing cationized cotton above, and can be readily established by the skilled artisan.

5.11. Preparation of Nylon-Based Sers-Active Textiles

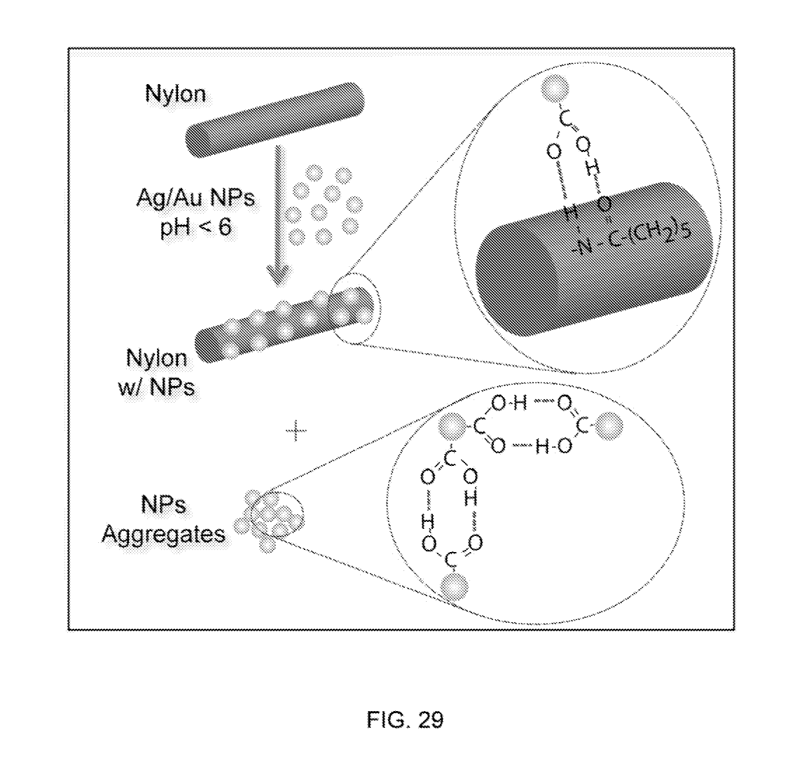

Nylon and wool-based SERS-active textiles can be prepared using the LBL self-assembly process (Dong, H., et al., Assembly of Metal Nanoparticles on Electrospun Nylon 6 Nanofibers by Control of Interfacial Hydrogen-Bonding Interactions. Chem. Mater., 2008. 20(21): p. 6627-6632). The mechanism for particle assembly on nylon is illustrated in FIG. 29. The assembly of citrate stabilized metallic (e.g., Ag and Au) particles is controlled by the hydrogen bonding interactions between the amide groups along the nylon backbone and the carboxylic acid groups on the surface of the particles. The LBL self-assembly process can be used with any nylon substrate known in the art. Nylon samples can be coated with citrate stabilized metallic (e.g., Ag and Au) particles of varying sizes (e.g., ˜20-100 nm nominal diameter) to identify optimal conditions for maximizing the SERS signal of the composite materials. The resulting SERS-active nylon textiles can be characterized as described hereinabove.

The particle-coating methods described herein can be used with fibrous textiles that are relatively ‘inert’ with respect to surface functionalization (e.g., polyethylene, polypropylene, polycarbonate, etc.).

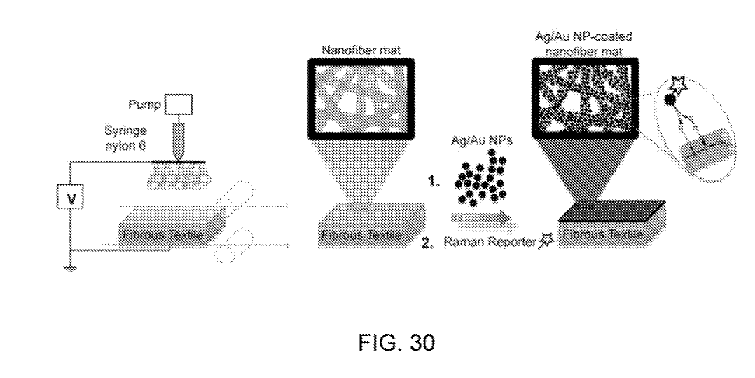

FIG. 30 illustrates schematically one embodiment of the method for producing generic SERS-active textiles using particle-coated nylon 6 nanofibers. FIG. 30 shows an electrospinning set up for the production of SERS active metallic (Ag and Au) particle/nylon nanofiber coated textiles. The electrospinning setup produces fibers, which are pressed or rolled, using methods known in the art, into a fibrous textile composed of a nanofiber mat. LBL-based methodology can be used to deposit metallic particles, the Raman reporter tag is introduced using the methods disclosed herein, and a metallic particle-coated nanofiber mat is produced.

5.12. Methods for Producing Spectroscopically Active Coatings on Base Textile Substrates

In one embodiment, a nylon nanofiber can be incorporated into a generic coating to make it spectroscopically active (e.g., SERS-, SEF-, or SEIRA-active, altered IR reflectance, unique reflectance, etc.) by adhering nanofibers to a base textile substrate. Nylon nanofibers (e.g., Nylon 6 nanofibers) or any fiber in the 10 nm-100 μm size regime that can participate in hydrogen bonding can be electrospun, using methods well known in the art, onto a select number of fibrous substrates, including but not limited to cotton and nylon fabrics and various paper-grade cellulose substrates.

The production of nylon 6 nanofibers via electrospinning is a well documented process (Ryu, Y. J., et al., Transport properties of electrospun nylon 6 nonwoven mats. Eur. Polym. J., 2003. 39(9): p. 1883-188). A non-woven mat consisting of uniform and continuous nanofibers—with an average diameter of ˜100 nm and interconnected pores—can be produced by electrospinning from a master batch containing a solution of 220 mg/mL polymer in formic acid (Dong, H., et al., Assembly of Metal Nanoparticles on Electrospun Nylon 6 Nanofibers by Control of Interfacial Hydrogen-Bonding Interactions. Chem. Mater., 2008. 20(21): p. 6627-6632). Adhesion of the nanofibers to the various fibrous substrates is significant due to the swelling effect that the residual formic acid in the nylon 6 fiber mat should have on the base substrate. Adhesion can be further controlled by presoaking the substrate in formic acid and other solvent systems (Li, L. and M. W. Frey, Modification of air filter media with nylon-6 nanofibers. Polym. Prepr. (Am. Chem. Soc., Div. Polym. Chem.), 2006. 47(1): p. 566-567).

Metallic particles (e.g., Ag and Au particles) in the ˜10-50 nm size regime can be deposited onto the resulting nanofiber-substrate blends. Using the LBL self-assembly process, a nylon (e.g., Nylon 6) nanofiber-substrate blend can be immersed in a pH-controlled metal particle solution such that the hydrogen-bond interactions between the citrate coated metallic particles and the nylon backbone are maximized. The resulting particle-coated composites are preferably thoroughly rinsed to remove adventitiously bound metallic particles. The resulting particle-nanofiber coated fibrous substrates are dried at room temperature and characterized as described hereinabove.

5.13. Analysis Methods

Nanoparticle suspensions can be analyzed for size and monodispersity using UV-vis spectroscopy and dynamic light scattering. The particle-fiber coatings will be characterized by conventional transmission electron microscopy (TEM) to assess particle-surface coverage as well as pore sizes of the composite materials. Samples for TEM imaging can be prepared by art known methods, e.g., embedding the particle-coated fabric yarns in Spun resin and heating to 60° C. for 16 hours to harden the resin. The embedded specimens can then be cross-sectioned using an ultramicrotome equipped with a diamond knife. Cross sections of the embedding block with thickness of ˜100-150 nm can be collected on TEM copper grids and imaged.

Art-known methods of field emission scanning electron microscopy (FESEM) can also be used provide surface information regarding particle surface coverage and fiber morphology, and elemental characterization can be done using an energy-dispersive X-ray spectroscope (EDS) attached to the FESEM. Specimens for FESEM-EDS analysis can be prepared on glass slides, followed by an ultrathin layer of carbon (˜20-30 nm) prior to imaging.

Each composite particle-coated textile substrate can be characterized by UV-Vis spectroscopy in order to determine its corresponding extinction maxima. Although UV-Vis data may not completely determine SERS efficiencies, this tool allows for rapid screening and analysis of the samples, and in conjunction with microscopy, can also serve as a predictive tool for correlating particle size and interparticle distances to expected SERS enhancements.

SERS data for the SERS-active substrates can be obtained using methods known in the art. For example, a micro-Raman spectrometer (e.g., a Renishaw InVia micro-Raman spectrometer) can be used with a selected wavelength of excitation (e.g., 785 nm).

Empirical enhancement factors can be calculated by comparing ratios of the various SERS peaks of the Raman reporters (at substrate saturation) to the respective unenhanced Raman signals obtained from films of reporter molecules of known thickness. The Raman signal of the SERS-active substrates with absorbed reporters can be evaluated after treatment with simulated environmental contaminants, using methods known in the art. This includes, but is not limited to, dirt, oils, and various chemicals (e.g., dry cleaning treatments, detergents, etc.0.

SEIRA data for the SEIRA-active substrates can be obtained using methods known in the art (e.g., a FT-IR spectrometer such as the Nexus 670, Thermo Nicolet).

SEF data for the SEF-active substrates can be obtained using methods known in the art. For example, emission spectra can be obtained using a spectrofluorometer using various excitation sources and accompanying excitation filters (e.g., filters for 514 nm and 605 nm excitation), in combination with appropriate emission filters in the emission observation path (e.g., filters for 530 nm and 630 nm emission). The specific sets of excitation/emission filters are defined by the specific SEF-surface and the specific SEF-active molecules.

5.14. Uses of Coated Materials

Materials coated according to the methods of the invention and/or with the coatings of the invention (“coated” or “treated” materials) can have antimicrobial properties for applications including, but not limited to, surgical garments, wound dressings, bedding, masks, diapers, sanitary products carpeting, upholstery, filtration media, ropes, and sutures. For example, nanofiber mats decorated with metal particles produced in accordance with the methods of the invention can exhibit strong antibacterial activity, and thus can be used, e.g., for producing wound dressing, antibacterial clothing, and non-woven antibacterial filtration materials.

Coated materials can provide antimicrobial properties for implantable medical applications including, but not limited to, treated collagen, pacemakers and other medical devices.

The coating on the treated material can provide antimicrobial properties to prevent biofilm development on the material. It can provide antimicrobial properties for filter media used in filtration of air, water, or other fluids.

The coating on treated materials can provide catalytic properties for use in reactors, catalytic converters, etc.

Fiber mats decorated with metallic or nonmetallic particles produced in accordance with the methods of the invention can be used as flexible and portable catalytic mantles or as seeds for electroless deposition of metal on cellulose substrates.

The coating on treated materials can provide enhanced spectroscopic properties such as Raman spectroscopy, infrared spectroscopy and fluorescence spectroscopy for applications including, but not limited to, positive identification, analyte detection and tagging/tracking identification.

The coating on treated materials can provide enhanced magnetic properties for applications including, but not limited to, positive identification, tagging/tracking identification, microwave directed hyperthermia and high efficiency motor windings.

Coated materials that exhibit self-cleaning (hydrophobic and/or oleophobic) properties can be used in textiles goods including, but not limited to, outerwear such as coats, jackets, shirts and trousers, undergarments, hats and footwear.

Coated materials that exhibit superhydrophobic and/or superoleophobic properties can be used in textiles goods including, but not limited to, outerwear such as coats, jackets, shirts and trousers, undergarments, hats and footwear.

Coated materials that exhibit electrical conductivity can be used in applications including, but not limited to, detection of garment integrity breach, monitoring of medical condition (heart rate, etc.), anti-tampering devices, anti-static devices, positive identification and batteries.

Coated materials that exhibit thermal conductivity can be used in applications including, but not limited to, athletic shirts, socks, jackets, microprocessors, electronics and sensors.

Coated materials that exhibit insulating properties can be used in applications including, but not limited to, athletic and outdoor clothing, socks, jackets, microprocessors, electronics and sensors.

The particles and particle density of coated materials can be adjusted to affect the absorption, reflection and scattering of light of UV, visible, near infrared and infrared wavelengths.

Coated materials can be used to provide enhanced wound healing properties via electrical conductivity, heat conduction, or the attraction of curative blood constituents.

In another aspect, the methods of the invention can also be used for fabric inkjet printing with particles.

5.14.1. Use of Conformal Particle Coatings on Fiber Materials in Spectroscopic Methods for Detecting Targets of Interest

Uses of the conformal coatings, coated fibrous materials and methods set forth herein include, but are not limited to friend-or-foe identification, anti-counterfeiting, detection of trace chemicals and biological molecules, and various needs in tagging, tracking, and identification. SERS-, SEIRA- or SEF-based systems for positive detection can be passive and covert. The spectra depend upon the active reporter molecule(s), the enhancer, and the excitation wavelength. The resulting signal is complex but can be interpreted through a prescribed, art-known algorithm that will then yield a unique identifying code. Overlaying this complexity is the placement of this covert tag, which will introduce yet another level of encoding. The LBL process allows placement of the tag at literally any level in the overall processing of many textiles—whether it be, for example, introduction of ‘coded’ thread/yarn into a textile weaving process, or coding a finished woven textile product.

The following examples are offered by way of illustration and not by way of limitation.

### 6. EXAMPLES

### 6.1. Example 1

### Efficient Assembly of Metal Nanoparticles on Electrospun Nylon 6 Nanofibers by Control of Interfacial Hydrogen Bonding Interactions

6.1.1. Summary

This example demonstrates an efficient, one-step route for uniformly assembling preformed Ag metal nanoparticles (NPs) on the surface of electrospun nylon 6 nanofibers that is driven by interfacial hydrogen bonding interactions. Metal nanoparticles (Ag, Au, Pt) were assembled on electrospun nylon 6 nanofibers by controlling the interfacial hydrogen bonding interactions between the amide groups in the nylon 6 backbone and the carboxylic acid groups capped on the surface of the metal nanoparticles.

Metal nanoparticles were synthesized in aqueous media using sodium citrate as a stabilizer. Nylon 6 nanofiber mats, produced by electrospinning, were immersed into pH-adjusted solutions of metal nanoparticles. Since silver and silver ions have long been known to exhibit strong inhibitory and bactericidal effects as well as a broad spectrum of antimicrobial activities (Choa, K.-H.; Park, J.-E.; Osaka, T.; Park, S.-G. Electrochim Acta 2005, 51, 956), the antibacterial activity of these Ag-nylon 6 fibers was evaluated against Escherichia coli (E. coli). The nylon 6 nanofiber mats decorated with Ag nanoparticles exhibited strong antibacterial activity against Escherichia coli.

One factor determining the assembly phenomena was identified as the hydrogen bonding interactions between the amide groups in the nylon 6 backbone and the carboxylic acid groups capped on the surface of the metal nanoparticles. The assembly was strongly dependent on the pH of the media, which affected the protonation of the carboxylate ions on the metal nanoparticles and hence, influenced the hydrogen bonding interaction between nanofibers and nanoparticles. High surface coverage of the nanofibers by the Ag nanoparticles was found at pH intervals from 3 to 6, whereas only few Ag nanoparticles were found on the surface of the fibers when the pH was greater than 7.

6.1.2. Materials and Methods

6.1.2.1. Chemicals

Silver nitrate (AgNO₃), hydrogen tetrachloroaurate trihydrate (HAuCl₄_{_{—}}3H₂O), chloroplatinic acid hexahydrate (H₂PtCl₆_{_{—}}6H₂O), sodium borohydride (NaBH₄), sodium citrate tribasic dihydrate (Na₃C₆H₅O₇_{_{—}}2H₂O), nylon 6 and formic acid were all purchased from Sigma-Aldrich and used as received. All solutions were prepared using distilled/deionized water with resistance ˜18.2 MΩ cm.

6.1.2.2. Synthesis of Citrate-Stabilized Ag NPs

The aqueous solution of Ag NPs was synthesized by sodium borohydride reduction of AgNO₃ in the presence of sodium citrate as a stabilizing reagent (Lok, C.-N.; Ho, C.-M.; Chen, R.; He, Q.-Y.; Yu, W.-Y.; Sun, H.; Tam, P. K.-H.; Chiu, J.-F.; Che, C.-M. J. Proteome Res. 2006, 5, 916). The stoichiometry of AgNO₃/sodium citrate/NaBH₄ in the solution has a molar ratio of 1:1:5. A 45 mL solution of AgNO₃ and sodium citrate was prepared from 8.5 mg AgNO₃ dissolving in water followed by addition of 14.7 mg Na₃C₆H₇.O₇.2H₂O in water under continuous stirring. To this solution, a 5 mL solution of NaBH₄ (9.5 mg) was rapidly added under vigorously stirring. After one hour of continuous stirring at room temperature, a deep brown solution was formed.

6.1.2.3. Synthesis of Citrate-Stabilized Au NPs

Synthesis of citrate-stabilized Au NPs was carried out using methods of Turkevich et al. (Turkevich, J.; Stevenson, P. C.; Hiller, J. Discuss. Faraday Soc. 1951, 11, 55). A 45 mL aqueous solution of HAuCl₄_{_{—}}3H₂O (19.7 mg) was heated to boiling under vigorous stirring. A 5 mL aqueous solution of sodium citrate (73.5 mg) was introduced to the gold salt solution. This stoichiometry leads to a molar ratio of HAuCl₄_{_{—}}3H₂O to sodium citrate 1:5 in the reaction solution. Continuous boiling for one hour completed the formation of the colloids producing a stable solution with a wine red color.

6.1.2.4. Synthesis of Citrate-Stabilized Pt NPs

Synthesis of citrate-stabilized Pt NPs was carried out using methods of Pron'kin et al. (Pron'kin, S, N.; Tsirlina, G. A.; Petrii, O. A.; Vassiliev, S. Y. Electrochim Acta 2001, 46, 2343A). 45 mL of H2PtCl6 aqueous solution was prepared by dissolving 26.5 mg H₂PtCl₆.6H₂O in water, and then a 5 mL solution of sodium citrate (73.5 mg) was added. The mixture with a 1:5 molar ratio of H₂PtCl₆ to sodium citrate was heated to reflux, and it was kept refluxing for one hour. A solution of Pt NPs with a black color was yielded after reflux.

6.1.2.5. Electrospinning of Nylon 6

Nylon 6 was dissolved in formic acid to form a solution with a concentration of 220 mg/mL. Electrospinning was carried out using a syringe and an 18 gauge needle with a flat tip at an applied voltage of 20 kV. The syringe pump was set to deliver polymer solution at a feeding rate of 0.5 mL/h. The nanofibers were collected on a grounded aluminum sheet that was located 20 cm apart from the needle.

6.1.2.6. Assembly of Metal NPs on Nylon 6 Nanofibers

For pH-controlled assembly of Ag NPs on nylon 6 nanofibers, the pH values of the solutions of Ag NPs were adjusted to 3.0, 4.0, 5.0, 6.0, 7.0, respectively, from the original pH 9.7 using a 1 M HCl solution. Immediately after pH adjustment, nylon 6 nanofiber mats, peeled off from the collector, were immersed into the pH adjusted solutions. After a 3 h immersion, the mats were taken out, thoroughly rinsed in deionized water and air-dried. For the assembly of Au NPs and Pt NPs, the pH of NP solutions was adjusted to 5.0 by adding drops of 1 M HCl solution. Similar procedures as those previously described for Ag NP were used for binding Au NPs and Pt NPs on the surface of nylon 6 nanofibers.

6.1.2.7. Antibacterial Test

The antibacterial properties of the Ag-nylon 6 nanofiber mats were examined against Escherichia coli (E. coli) (K-12, a Gram-negative bacterium), according to a modified AATCC 100 test method. Nylon 6 nanofiber mats without Ag NPs were used as control. Ten milligrams of the control sample and the Ag-nylon 6 nanofiber mats were placed in a sterilized container. A 1.0 mL volume of an aqueous suspension containing E. coli was dropped onto the surfaces of the mats. Four batches of the Ag-nylon 6 nanofiber mats and the control samples were prepared to assess the effect of contact times varying from 2 h, 5 h, 12 h to 24 h on the antibacterial properties of the Ag-nylon 6 nanofiber mats. After exposure, the inoculated controls and the Ag-nylon 6 nanofiber mats were placed into 100 mL distilled water. The mixture was vigorously shaken for 1 min. Then 100 μL of microbial suspension was taken out from the container and diluted to 10¹, 10², and 10³ times in sequence. Finally, 100 μL each of the microbial suspension and the three diluted solution were placed onto four zones of a nutrient agar plate, and incubated at 37° C. for 18 h.

The numbers of viable bacteria on zone 4 of the nutrient agar plates for the control samples and for the Ag-nylon 6 nanofiber mats were counted, and the difference between these two numbers was obtained. The total numbers of bacteria killed by Ag NPs on nylon 6 nanofiber mats was calculated using the difference multiplied by the dilution times, 10⁵. The power index to 10 of the calculated total number represents the logarithm reduction of bacteria. The numbers of bacteria on zone 3, 2 and 1 were also counted, and the logarithm reductions of bacteria in these three zones were calculated for procedure validation purposes.

6.1.2.8. Characterization

Field emission scanning electron microscopy (FESEM) was carried out with a LEO 1550 at a voltage of 2 kV, using an in-lens detector. The specimens were sputtered with an ultra thin layer of Au/Pd before imaging. Transmission electron microscopy (TEM) were performed on a TECNAI T-12 with 120 kV accelerating voltage. Samples for TEM imaging were prepared as follows. Nylon 6 nanofibers were electrospun directly onto TEM grids coated with lacey support films. The TEM grids were immersed into pH-adjusted solutions of metal nanoparticles for 3 h. The grids were rinsed with copious deionized water and air-dried. UV-vis spectra were collected using a PerkinElmer Lambda 35 spectrometer. The liquid samples were placed in quartz cuvettes and the fiber samples were supported on glass slides.

6.1.3. Results and Discussion

6.1.3.1. pH-Controlled Assembly of Ag NPs on Nylon 6 Nanofibers

The assembly process initiated with the synthesis of Ag NPs in the presence of sodium citrate and the fabrication of nylon 6 nanofibers via electrospinning. The citrate ions, weakly bound on the NP surfaces, imparted negative charges to the metal NPs and prevented aggregation of the NPs in the solution (Henglein, A. J. Phys. Chem. B 1999, 103, 9533-9539). The as synthesized Ag colloidal solution exhibited a deep brown color and a pH value of 9.7. The production of nylon 6 nanofibers via electrospinning is a well documented process (Ryu, Y. J.; Kim, H. Y.; Lee, K. H.; Park, H. C.; Lee, D. R. Europ. Polym. J. 2003, 39, 1883). A nonwoven mat consisting of uniform and continuous nanofibers with an average diameter of 108 nm and interconnected pores was produced by electrospinning a 220 mg/mL formic acid polymer solution.

Nylon 6 nanofiber mats were immersed into pH adjusted solutions of Ag NPs (pH values of 3.0, 4.0, 5.0, 6.0, 7.0 and 9.7 were used) immediately after acidification. Thirty minutes after the pH of the solutions was adjusted aggregates of Ag NPs formed in the solution at pH 3.0 whereas the solutions at higher pH remained clear. Aggregates of NPs formed at the bottom of the solutions with pH ranging from 4.0 to 6.0 after the solutions stood overnight. The color of the fiber mats evolved from white into brown after they were immersed during 3 h into the solutions with acidic pH values. The dried nanofiber mats immersed in solutions with pH values ranging from 3.0 to 6.0 exhibited a dark brown color, the mat at pH 7.0 had a light brown color, while the mat prepared at pH 9.7 remained white color.

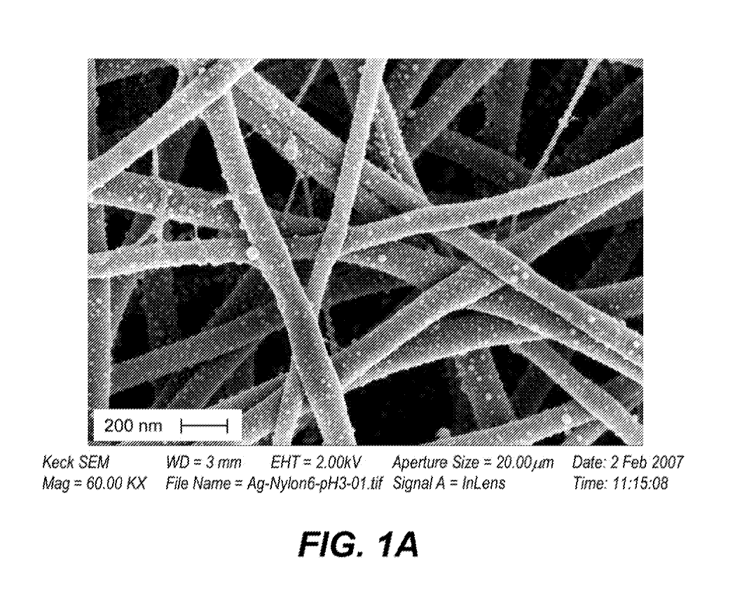

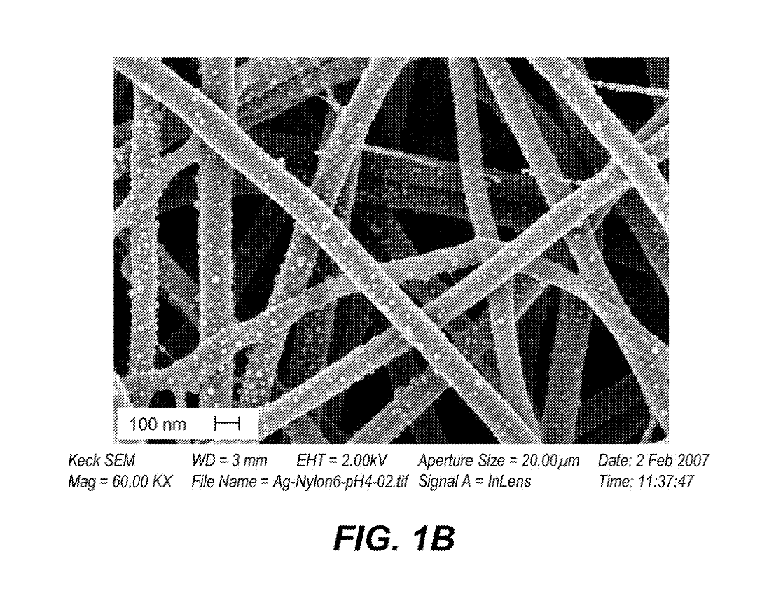

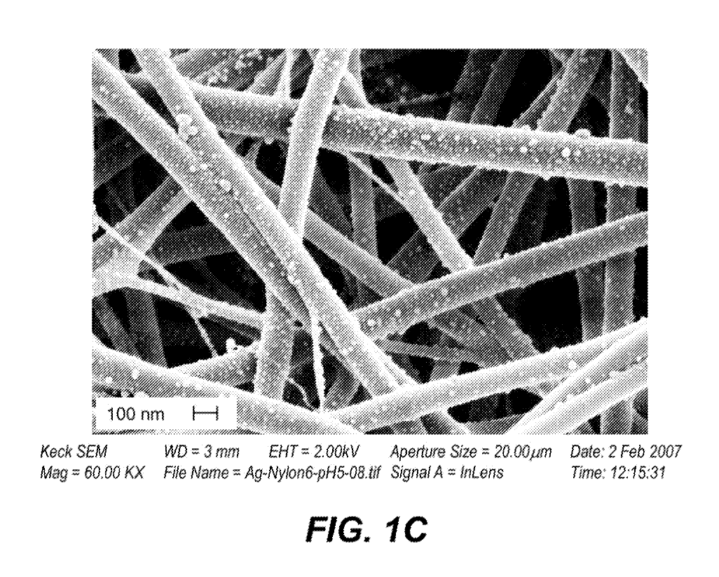

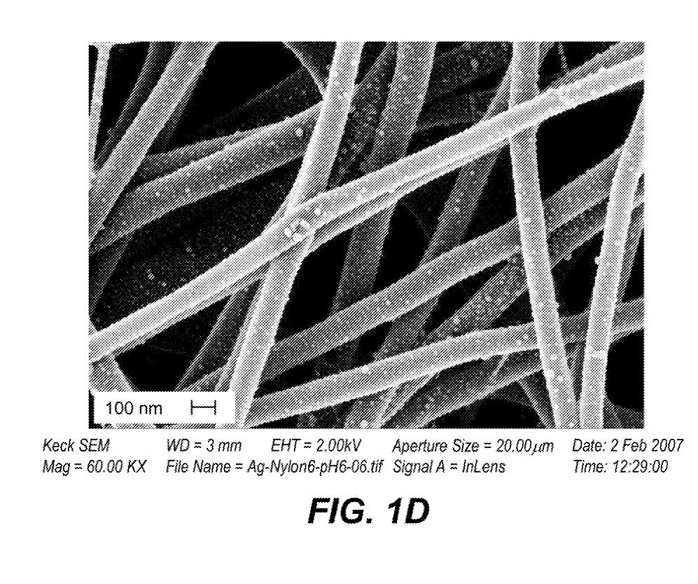

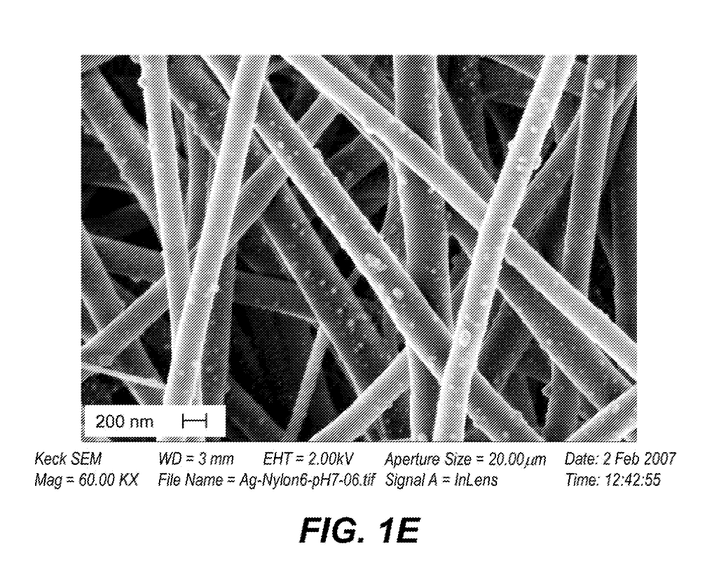

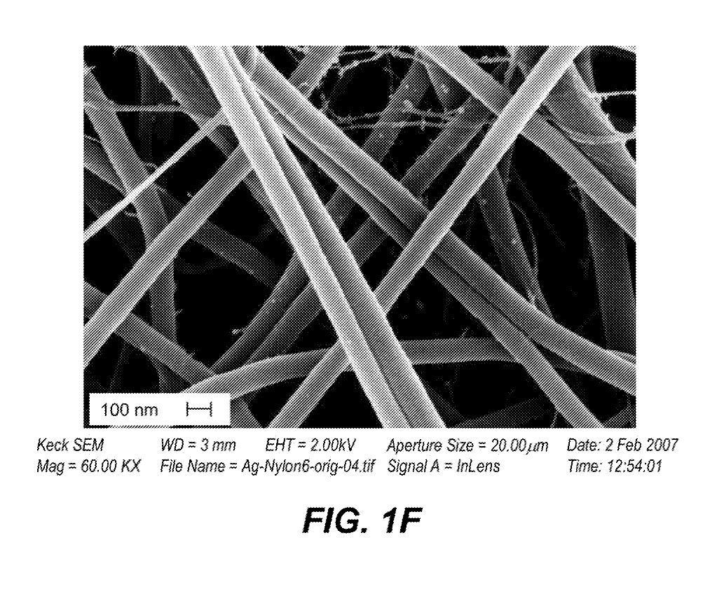

FIG. 1 shows FESEM images of Ag-nylon 6 nanofiber mats as a function of the pH values of the Ag NP solutions (FIG. 1A, pH 3.0, FIG. 1B, pH 4.0, FIG. 1C, pH 5.0, FIG. 1D, pH 6.0, FIG. 1E, pH 7.0, and FIG. 1F, pH 9.7). At pH values ranging from 3.0 to 6.0, individual nanoparticles were observed to distribute uniformly and in high coverage density on the surface of the nylon 6 nanofibers (FIGS. 1A-1D), whereas only a few nanoparticles were found on the nanofibers immersed in the solution with pH 7.0 (FIG. 1E). Very few particles were observed on the surface of the nanofibers immersed in the as-synthesized solution (pH 9.7) (FIG. 1F).

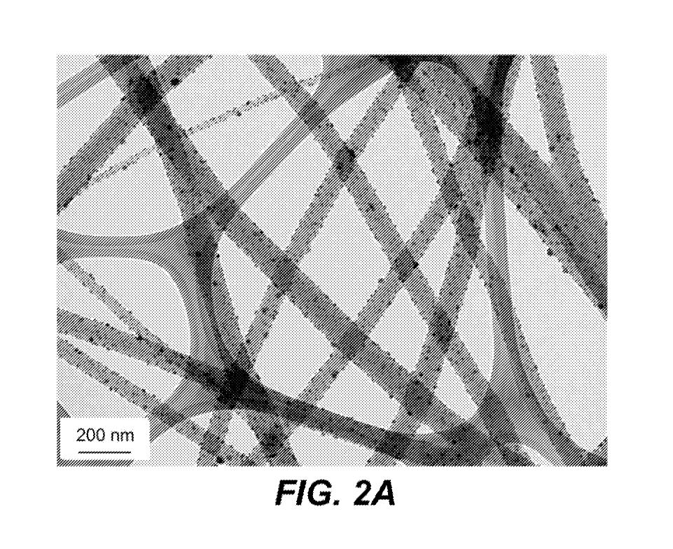

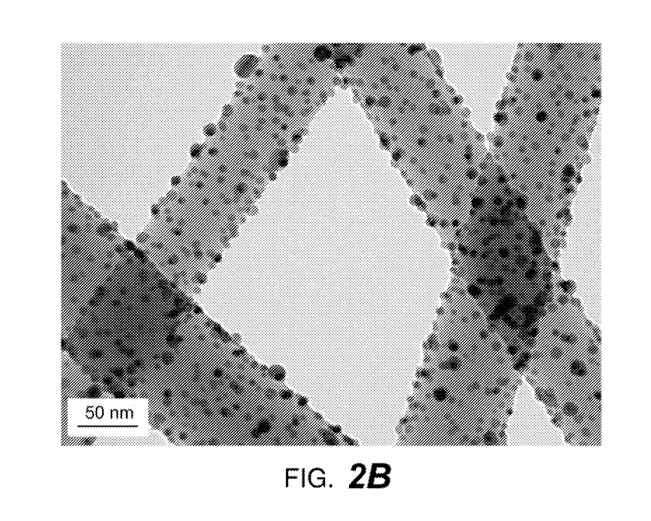

To assess the assembling structure of the Ag NPs on the nanofibers, nylon 6 nanofibers were directly electrospun onto TEM grids coated with lacey support films. The nanofibers were decorated with Ag NPs by immersing the TEM grids into pH-adjusted Ag nanoparticle solutions. FIG. 2A-2B shows TEM images of a nylon 6 sample immersed in a solution of Ag nanoparticles at pH 5.0. FIG. 2A shows TEM images at low magnification and FIG. 2B shows TEM images at high magnification. A large number of individual nanoparticles with spherical shape were observed to distribute homogeneously on the surface of the nylon 6 nanofibers. The size of Ag NPs on the fiber surface had an average of 8 nm

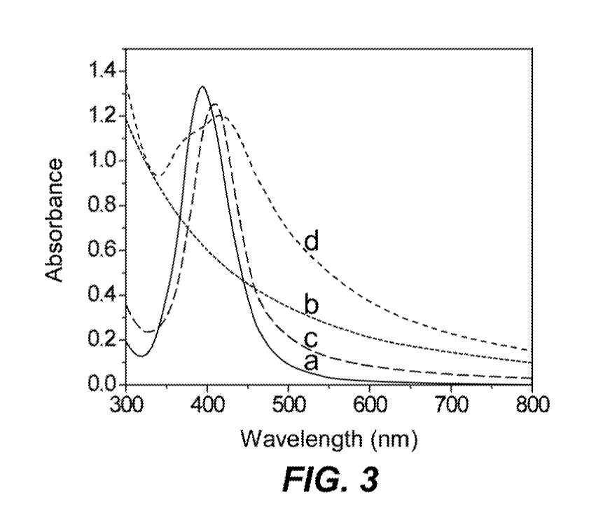

UV-vis spectroscopy was employed for further characterization of Ag NPs assembled on nylon 6 nanofibers. FIG. 3 shows UV-vis spectra for (A) diluted solution of as-synthesized Ag NPs at a ratio of 1:1 with water, (B) nylon 6 nanofiber mat, (C) wet Ag-nylon 6 nanofiber mat, and (D) dried Ag-nylon 6 nanofiber mat. The spectrum of the diluted solution of Ag nanoparticles in FIG. 3(A-D) shows an absorption band at 394 nm which is attributed to the surface plasmon resonance band (SPR) of Ag NPs (Lok, C.-N.; Ho, C.-M.; Chen, R.; He, Q.-Y.; Yu, W.-Y.; Sun, H.; Tam, P. K.-H.; Chiu, J.-F.; Che, C.-M. J. Proteome Res. 2006, 5, 916).

The SPR band of the wet Ag-nylon 6 fiber mat was red shifted to 409 nm. This red shift of the SPR band can be explained by the close proximity of NPs on the nanofibers compared with a larger interparticle distance while the NPs are in solution. The SPR of dried Ag-nylon 6 nanofiber mat was also broadened and further red shifted to 416 nm due to further closed interparticle distance after drying.

6.1.3.2. Assembly Mechanism

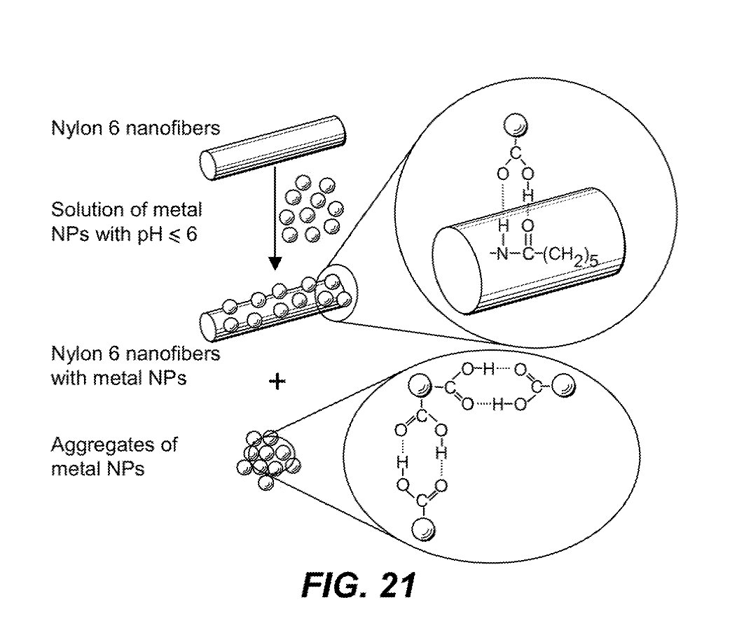

The assembly mechanism for citrate-covered NPs on the nylon 6 nanofibers could be explained on the basis of hydrogen bonding interactions between the amide groups along the nylon 6 backbone and the carboxylic acid groups capped on the surface of the Ag NPs, as presented in FIG. 21. Nylon 6 has been known to have inter- and intra-hydrogen bonding through its amide groups leading to the high crystallinity of nylon 6 (Reddy, P. S.; Kobayashi, T.; Abe, M.; Fujii, N. Europ. Polym. J. 2002, 38, 521). Nylon 6 has also been reported to interact with other polymers containing carboxylic acid groups forming miscible blends via hydrogen bonding interactions (Sainath, A. V. S.; Inoue, T.; Yonetake, K.; Koyama, K. Polymer 2001, 42, 9859). Either amide and carboxylic acid functional groups can act as proton donor and acceptor hence dimeric associations involving two hydrogen bonds can form between amid and carboxylic acid groups (Wash, P. L.; Maverick, E.; Chiefari, J.; Lightner, D. A. J. Am. Chem. Soc. 1997, 119, 3802). The pKa values of citric acid are known to be 3.13, 4.76, 6.40 (Lide, D. R., Handbook of Chemistry and Physics, 87th edition; CRC: 2007).

The as-synthesized Ag NP aqueous solution, using citrate as a stabilizer, has a pH value of 9.7. At a pH above the pKa values, carboxylate groups are attached on the surface of the Ag NPs. These carboxylate ions may form one hydrogen bond with the amide groups in the nylon 6 backbone between the carbonyl in the carboxylate and the H—N in the amide.

This interaction, however, might not be strong enough to drive Ag NPs from the solution to the surface of the nylon 6 fibers when compared with the hydrogen bonding interactions between water and nylon 6 (Iwamoto, R.; Murase, H. J. Polym. Sci. Part B-Polym. Phys. 2003, 41, 1722). As the pH of Ag NP solutions is lowered to 6.0, which is below one of the pKa values of citric acid (6.40), one of the three COONa groups from the surface-bound citrate on the surface of the NPs is acidified becoming COOH. This COOH group can be bridged to the amide group on the surface of the nylon 6 fibers through two intermolecular hydrogen bonds as shown in FIG. 21. Further increasing the number of COOH groups on the Ag NPs by lowering down the pH of the solutions below 6 did not appear to increase the quantity of Ag NPs bound with nylon 6 nanofibers. At pH 3.0, the COONa groups on Ag NPs are completely acidified. The strong hydrogen bonding between two COOH groups attached to Ag NPs brings the NPs into close proximity in all three-dimensions resulting in the formation of aggregates.

FIG. 21 shows the postulated mechanism of pH-induced assembly of metal nanoparticles on the surface of nylon 6 nanofibers.

6.1.3.3. Antibacterial Test

Ag NPs with high specific surface area and large fraction of surface atoms, are expected to exhibit high antimicrobial activity compared to that of bulk Ag meta 1(Choa, K.-H.; Park, J.-E.; Osaka, T.; Park, S.-G. Electrochim. Acta 2005, 51, 956-960; Lok, C.-N.; Ho, C.-M.; Chen, R.; He, Q.-Y.; Yu, W.-Y.; Sun, H.; Tam, P. K.-H.; Chiu, J.-F.; Che, C.-M. J. Biol. Inorg. Chem. 2007, 12, 527-534). The antibacterial activities of Ag NPs have been found to be size dependent, with smaller particles having higher activities on the basis of equivalent silver mass content (Lok, C.-N.; Ho, C.-M.; Chen, R.; He, Q.-Y.; Yu, W.-Y.; Sun, H.; Tam, P. K.-H.; Chiu, J.-F.; Che, C.-M. J. Biol. Inorg. Chem. 2007, 12, 527-534). The effects of Ag nanoparticles on microorganisms and the precise antimicrobial mechanism have not been completely revealed yet. One proposed mechanism is that the antibacterial activity of Ag NPs originates from chemisorbed Ag+, which is readily formed on Ag NPs owing to their extreme sensitivity to oxygen (Lok, C.-N.; Ho, C.-M.; Chen, R.; He, Q.-Y.; Yu, W.-Y.; Sun, H.; Tam, P. K.-H.; Chiu, J.-F.; Che, C.-M. J. Biol. Inorg. Chem. 2007, 12, 527-534).

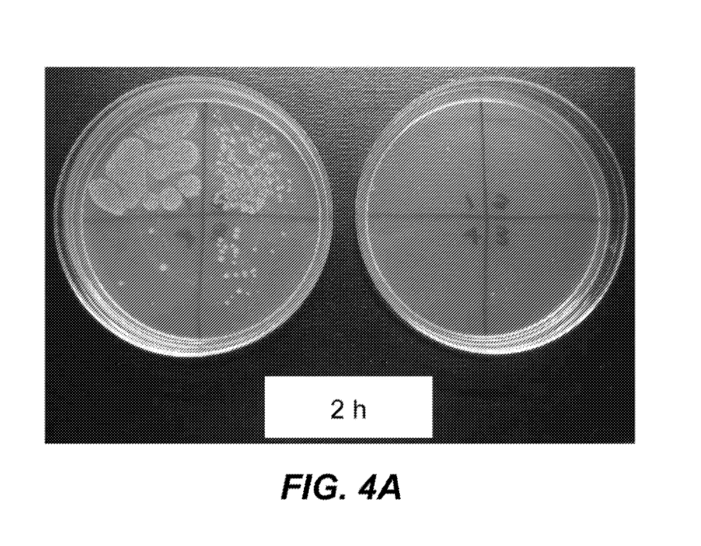

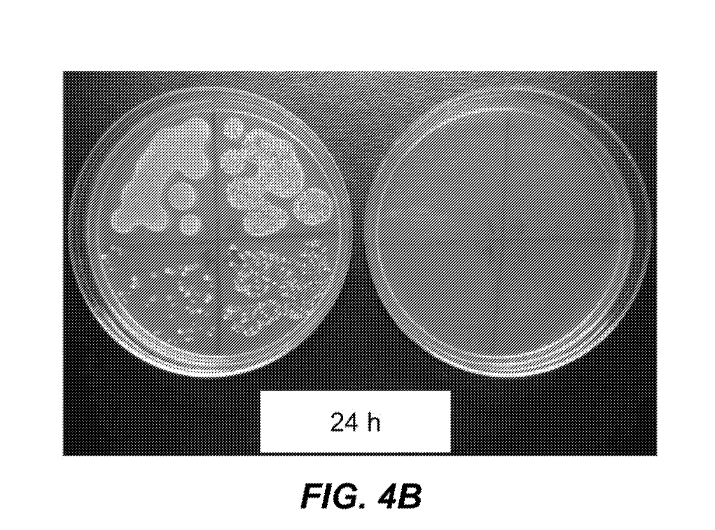

The antibacterial properties of nylon 6 nanofibers with or without Ag NPs were examined against E. coli according to a modified AATCC 100 test method. The contact time of the nanofiber mats with bacteria varied from 2 h, 5 h, 12 h, to 24 h. The antibacterial effect of the Ag-nylon 6 fiber mat is obvious, as shown in FIG. 4A-B. No colony of viable bacteria was found in the agar plate with the solution extracted from the Ag-nylon 6 nanofiber mat even at a contact time of 2 h, whereas proliferated colonies were observed in all the agar plates at all contact times from the uncoated nylon 6 nanofiber mat. The reduction of E. coli at a contact time of 2 h (FIG. 4A) was 5-logarithm. When the contact time increased to 5 h, 12 h and 24 h (FIG. 4B), the reductions could further reach 6-7 logarithm. The very strong and rapid antibacterial activity of the Ag-nylon 6 nanofiber mats, comparing with that of Ag NPs incorporated in the electrospun polymer fibers (Son, W. K.; Youk, J. H.; Lee, T. S.; Park, W. H. Macromol. Rapid Commun. 2004, 25, 1632-1637; Xu, X. Y.; Yang, Q. B.; Wang Y. Z.; Yu, H. J.; Chen, X. S.; Jing, X. B. Europ. Polym. J. 2006, 42, 2081-2087), could be attributed to the high surface packing density of the Ag NPs assembled exclusively on the surface of nylon 6 nanofibers.

Applications of these porous mats thus include wound dressing and antibacterial filtration.

FIG. 4 shows the results of antibacterial tests of nylon 6 nanofiber mats without (left) and with (right) Ag NPs against E. coli after incubation. (A) 2 h contact time. (B) 24 h contact time. The extraction of bacterial solution after the contact time was diluted to 10¹, 10², and 10³ times. Then the extraction and three diluents were incubated on four zones of a nutrient agar plate at 37° C. for 18 h.

6.1.3.4. Assembly of Au NPs or Pt NPs on Nylon 6 Nanofibers

The assembly method presented in this example, utilizing interfacial hydrogen bonding interactions, can also be extended to anchoring many other metal NPs capped with carboxylic acid groups. Au NPs and Pt NPs, synthesized using citrate as both a reducing agent and protective group, were applied as examples to demonstrate the versatility of the reported approach. After synthesis, a solution of Au NPs with a wine red color and a solution of Pt NPs with a black color, respectively, were yielded. The pH values of the NP solutions were adjusted to 5.0 before immersion of the nylon 6 nanofiber mats. After dried, the nanofiber mats exhibited a purple color and a grey color for those immersed in Au and Pt NPs solutions, respectively.

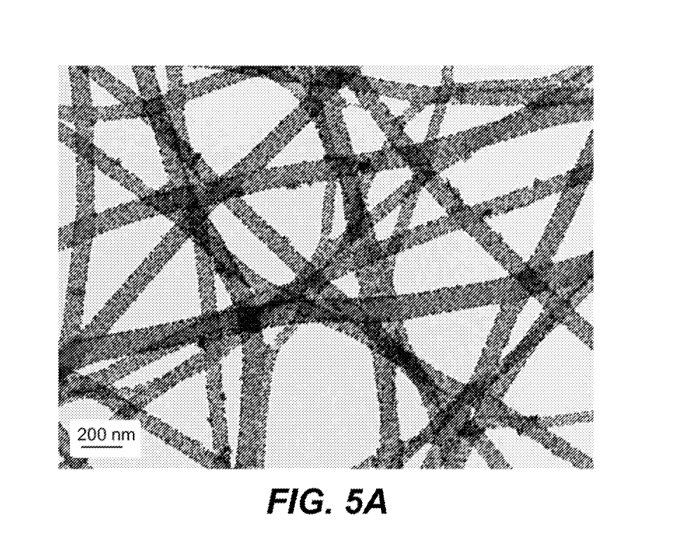

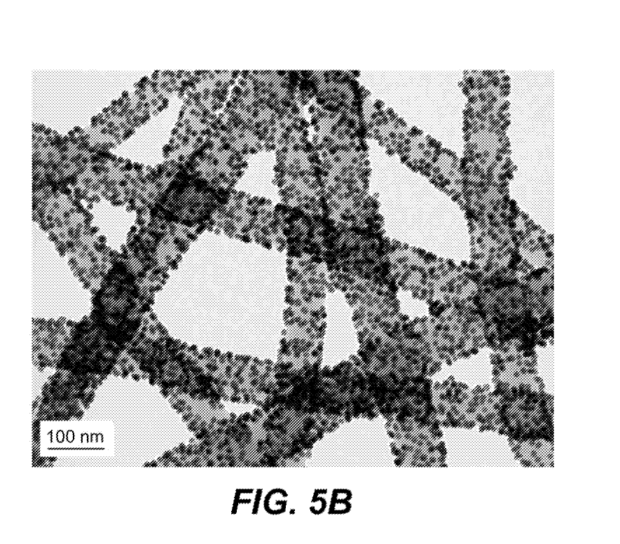

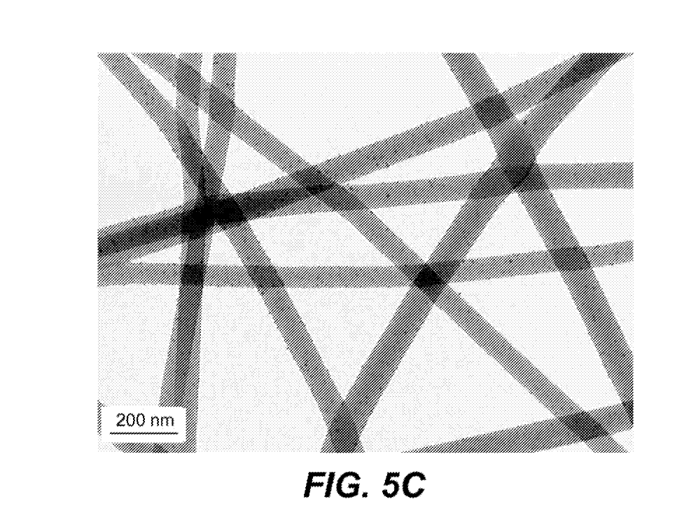

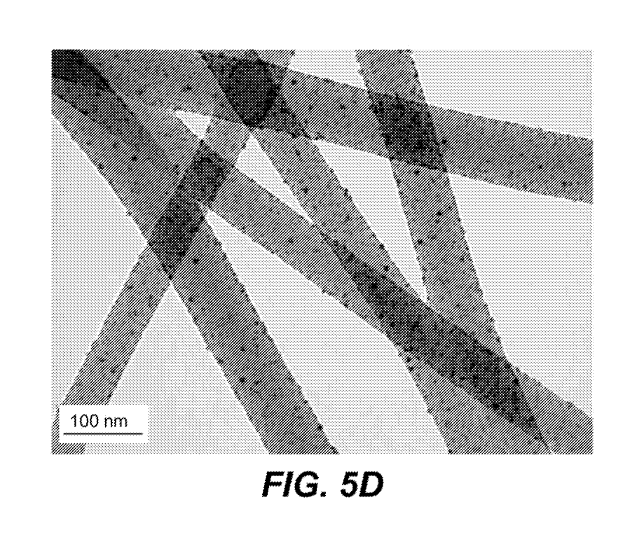

FIGS. 5A-D shows TEM images. FIGS. 5A and 5B show assembly of Au NPs on nylon 6 nanofibers at pH 5. Spherical NPs with an average diameter of 12 nm were observed to uniformly distribute on the surface of nanofibers.

FIGS. 5C and 5D show assembly of Pt NPs on nylon 6 nanofibers at pH 5. A large quantity of irregular-shaped NPs with an average size of 2-3 nm was found to be dispersed on the surface of nanofibers.

FIG. 6A shows the UV-vis spectra for (a) half-diluted solution of Au NPs and for (b) the Au-nylon 6 nanofiber mat. FIG. 6B shows the UV-vis spectra for (a) the half-diluted solution of Pt NPs and for (b) the Pt-nylon 6 nanofiber mat. The UV-vis absorption spectrum in FIG. 6A indicates that the solution of Au NPs exhibits a sharp SPR band at 519 nm, which is characteristic for Au NPs (Rotello, V. M. Nanoparticles: Building Blocks for Nanotechnology; Kluwer Academic Publishers: New York 2004). The SPR band of Au NPs on the dried nylon 6 nanofiber mat was broadened and red shifted to 531 nm. This red shift of SPR band could be explained by the close proximity of the NPs on the nanofibers after dried compared to the larger interparticle distance while in solution. The UV-vis absorption spectra (FIG. 6B) indicate that both the solution of Pt NPs and Pt NPs on the nylon 6 nanofiber mat have no absorption band in the visible range, which is consistent with previous report on Pt NPs (Pron'kin, S. N.; Tsirlina, G. A.; Petrii, O. A.; Vassiliev, S. Y. Electrochim Acta 2001, 46, 2343).

6.1.4. Conclusion

The assembly of metal nanoparticles on electrospun nylon 6 nanofibers by control of interfacial hydrogen bonding interactions has been demonstrated. A high surface packing density of the nanoparticles was achieved on the surface of the nanofibers when the NPs precursor solutions were adjusted to pH values between 3 and 6. When the pH of the NP solutions was higher than 7.0, limited coverage of the surface of the nanoparticles was noted. The nylon 6 nanofiber mat decorated with Ag NPs exhibited very strong antibacterial activities against E. coli. The assembly of Au NPs and Pt NPs on nylon 6 nanofibers demonstrated the versatility of this method for the deposition of other metal nanoparticles onto nylon 6 nanofibers. The mechanism for the pH-induced assembly of metal nanoparticles on the surface of nylon 6 nanofibers appears to be controlled by the presence of dimeric associations involving two hydrogen bonds that form between the amid and carboxylic acid groups present on the nanofiber and the nanoparticles.

### 6.2. Example 2

### Surface Bonding of Metal and Metal Oxide Nanoparticles on Cellulose Substrates

6.2.1. Summary

This example demonstrates surface bonding of metal nanoparticles on cellulose substrates using two approaches: direct assembly of metal nanoparticles on cationic cellulose substrates and in-situ synthesis of metal nanoparticles on cationic and anionic cellulose substrates.

6.2.2. Background

In situ synthesis of metal nanoparticles on porous cellulose fibers has been previously demonstrated by He et al. (2003, Chem. Mater. 15, 4401-4406). Metal nanoparticles were formed on porous cellulose fibers by impregnation and reduction.

Hyde et al. (2007, Effect of surface cationization on the conformal deposition of polyelectrolytes over cotton fibers. Cellulose (2007) 14:615-623, DOI 10.1007/s10570-007-9126-z) showed assembly of a solution of charged polymers onto fibrous material. These polymers represented continuous domains and assembled onto the fibrous materials as films. Hyde et al. showed the effect of surface cationization on the conformal deposition of alternating nanolayers of poly(sodium styrene sulfonate) (PSS) and poly(allylamine hydrochloride) (PAH) over cotton fibers. Three different levels of cotton cationization were evaluated. Variations in the cationization degree were achieved by manipulating the ratio of 3-chloro-2-hydroxy propyl trimethyl ammonium to NaOH. Experimental results obtained via Carbon-Hydrogen-Nitrogen-Sulfur (CHNS) elemental analysis and X-ray Photoelectron Spectroscopy (XPS) indicated that the deposition process was not significantly influenced by the degree of cotton cationization. The build up of further polyelectrolyte layers was found to be less sensitive to variations in the cationic character of the substrates once a critical number of alternating layers was deposited.

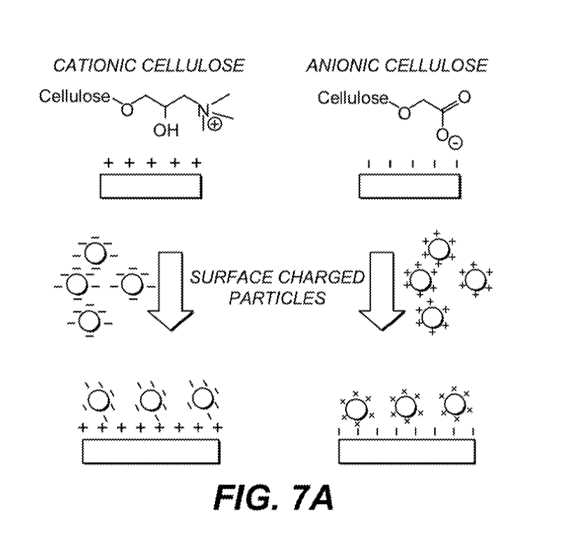

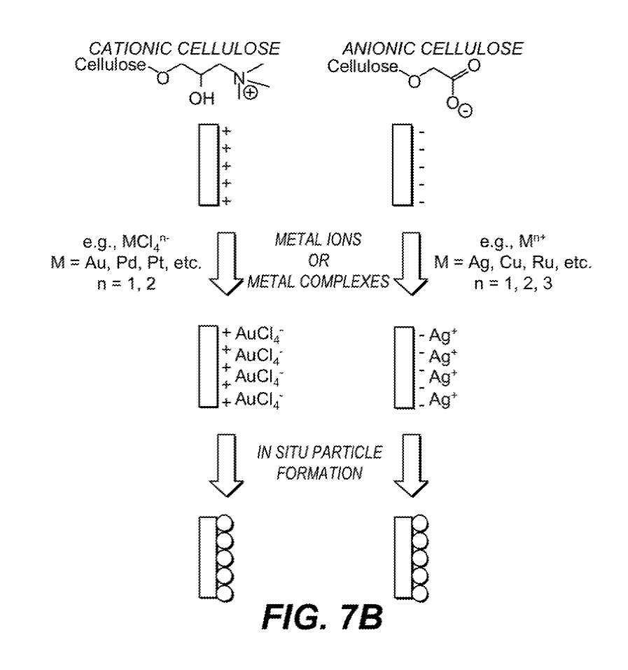

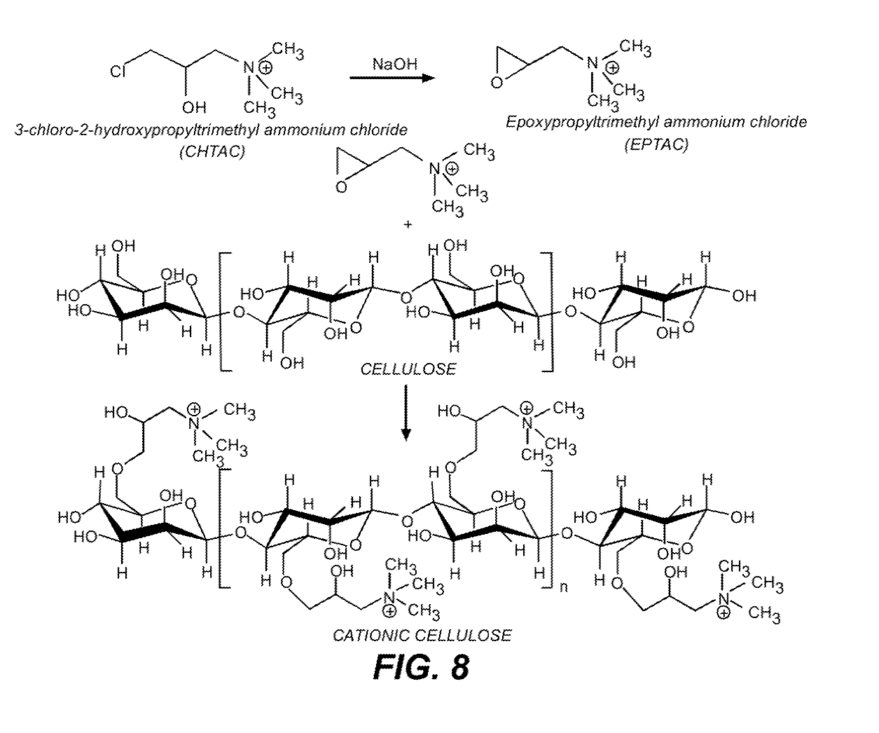

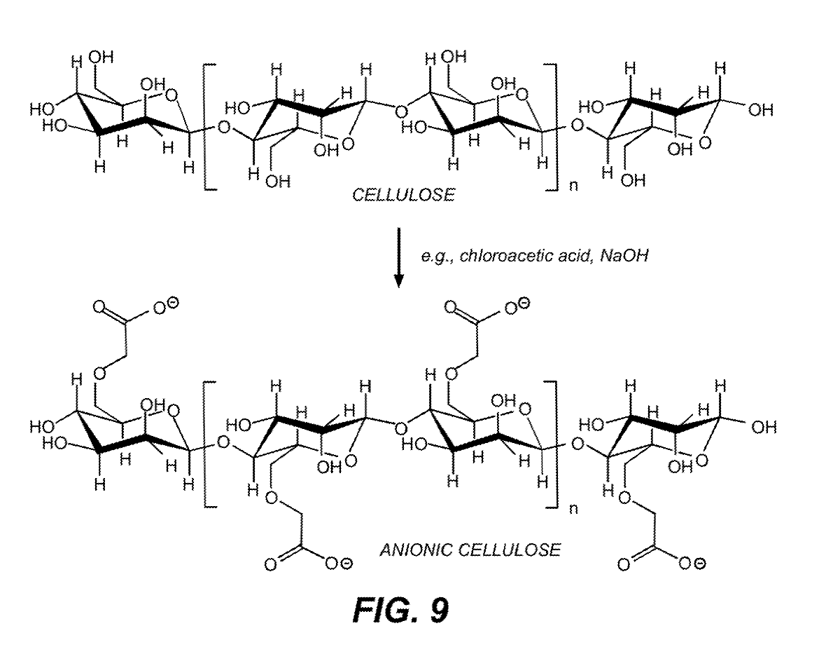

In the present example, metal nanoparticles were surface-bonded on cellulose substrates by four methods; (1) direct assembly using negatively charged nanoparticles in a colloidal solution and cationic cellulose (FIG. 7A; left), (2) in situ synthesis using negatively charged metal complexes and cationic cellulose (FIGS. 7B; left), and (3) in situ synthesis using positively charged metal ions and anionic cellulose (FIG. 7B; right). The synthetic methods for the production of cationic and anionic cellulose are pictured in FIG. 8 and FIG. 9, respectively. The direct assembly method using positively charged nanoparticles in a colloidal solution and anionic cellulose (shown in FIG. 7A, right) is provided here by way of example. The ordinarily skilled practitioner will understand that this method is encompassed in the present invention.

The cellulose was chemically pretreated with a small organic molecule to give a formal charge on the surface of the fibers. The metal ion or metal complex was then electrostatically bonded to the surface of the cellulose. This was followed by in situ reduction to give nanoparticles that bonded to the fiber surface through electrostatic bonds. The method of the present example contrasts with, and is a significant advance over, prior art methods of, e.g., He et al. (2003, Chem. Mater. 15, 4401-4406), in which a native porous material such as cellulose is simply soaked in an Ag metal ion solution and the metal is reduced to nanoparticles in the pores.

6.2.3. Material and Methods

6.2.3.1. Cotton-Based Cellulose Substrate Preparation

Cationic cellulose was prepared using the methods of Hauser et al. (Color. Technol. 2001, 117, 282-288) and Bilgen (Master Thesis, North Carolina State University, 2005). The synthesis scheme is shown in FIG. 8.

Anionic cellulose was prepared using the methods of Bilgen (Master Thesis, North Carolina State University, 2005). The synthesis scheme is shown in FIG. 9.

6.2.3.2. Preparation of Metal Nanoparticles in Colloidal Solution

Colloidal solutions of metal nanoparticles were prepared at a concentration of approximately 1 mM using well-known methods. Au nanoparticles were synthesized by employing the methods described by Turkevich et. al. (Turkevich, J.; Stevenson, P. C.; Hiller, J. Discuss. Faraday Soc. 1951, 11, 55-75.). Pt nanoparticles were synthesized using the reported protocol of Huang et. al. (Huang, M.; Shao, Y.; Sun, X.; Chen, H.; Liu, B.; Dong, S. Langmuir, 2005, 21, 323-329). Finally, Ag nanoparticles were synthesized using methods described by Lok et. al. (Lok, C.-N.; Ho, C.-M.; Chen, R.; He, Q.-Y.; Yu, W.-Y.; Sun, H.; Tam, P. K.-H.; Chiu, J.-F.; Che, C.-M. J. Proteome Res., 2006, 5, 916). All of the above methods use citrate as the nanoparticle stabilizing agent and give the particles negatively charged surface groups.

6.2.3.3. Characterization

Transmission electron microscopy (TEM) imaging of cross sections of cotton fibers was achieved using a Hitachi H-7000 (100 kV) or a JEOL 1200EX (120 kV). Samples for TEM imaging were prepared by embedding the cotton yarns coated with nanoparticles in a Spurr resin and hardening the resin at 60° C. for 16 h. The embedded specimens were cross-sectioned using an ultramicrotome equipped with a diamond knife. Cross sections of the embedding block with thicknesses of ˜100-150 nm were collected on TEM copper grids and dried before imaging. Field-emission scanning electron microscopy (FESEM) was performed on a LEO 1550 microscope, using an in-lens detector. The specimens were coated with a thin layer of carbon ˜20-30 nm) prior to FESEM imaging. Elemental characterization was performed using an energy-dispersive X-ray spectroscope attached to the LEO microscope.

6.2.3.4. Direct Assembly of Metal Nanoparticles on Cationic Cellulose Substrates

Pieces of cationic cotton fabric and several cationic cotton yarns were immersed into a beaker containing 50 mL of either a solution of Au nanoparticles or a solution of Pt nanoparticles. After 24 h of soaking, the cotton specimens were removed from the container and rinsed thoroughly with water to remove loosely bound metal nanoparticles. The fabrics and yarns were dried in air before further analysis.

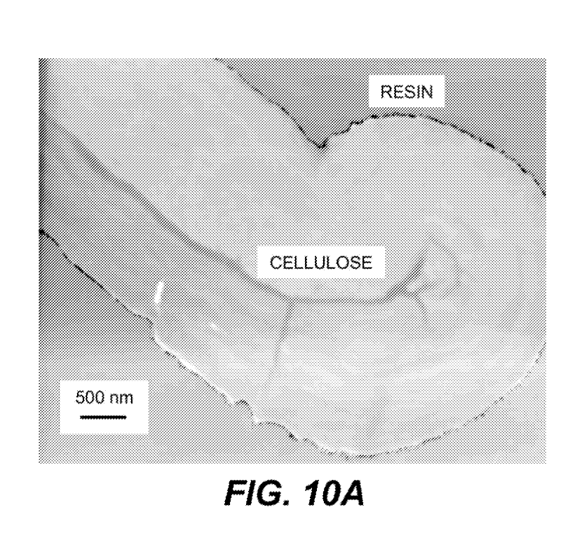

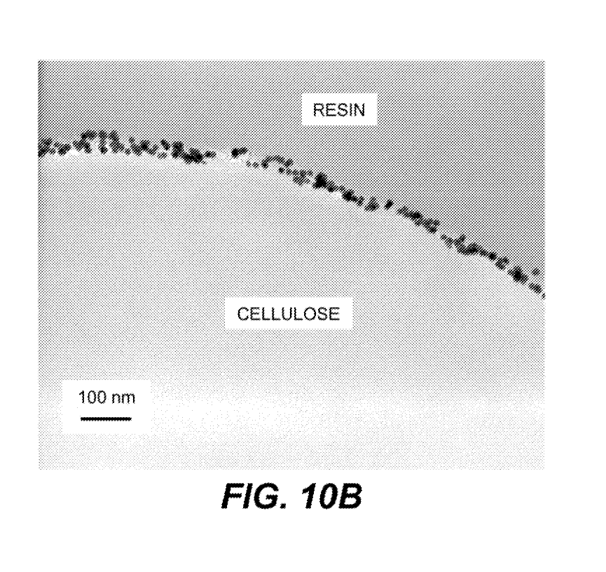

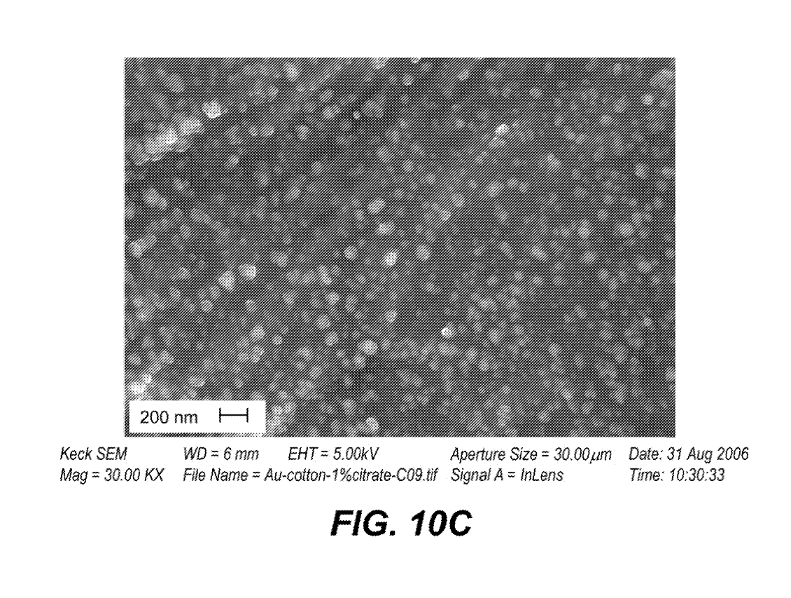

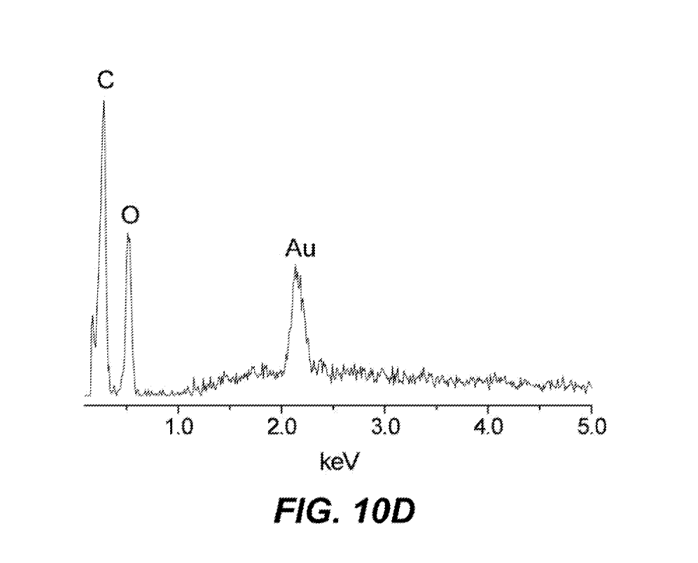

Direct assembly using negatively charged Au nanoparticles in a colloidal solution and cationic cotton (cellulose) is shown in FIGS. 10A-D.

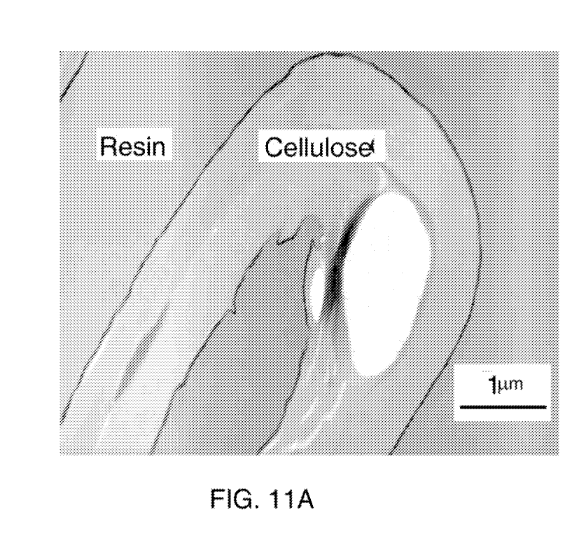

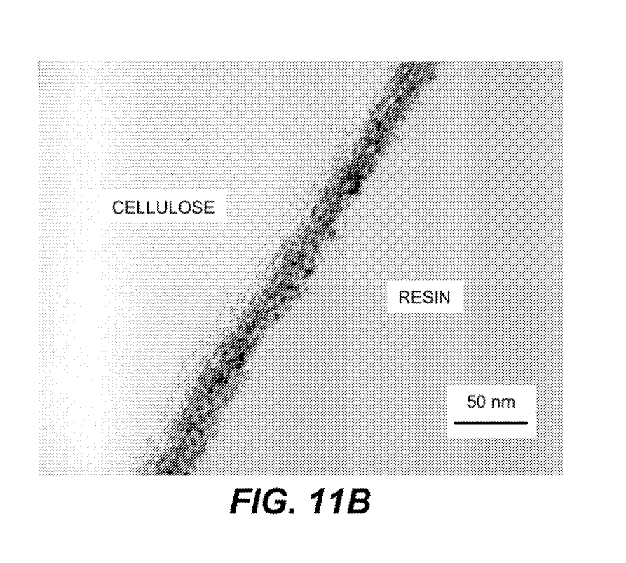

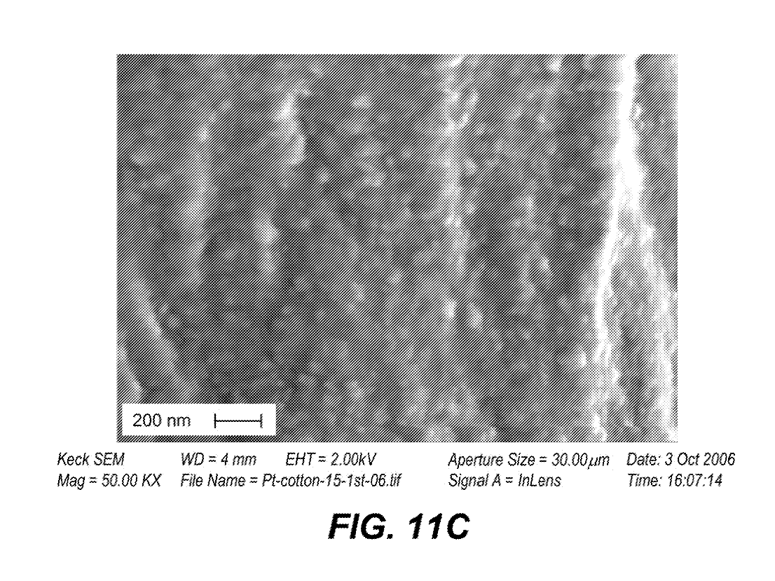

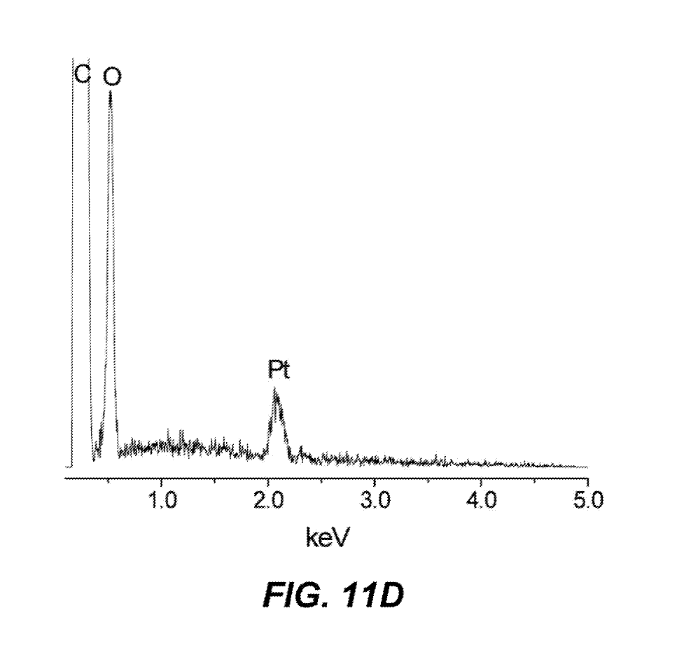

Direct assembly using Pt negatively charged nanoparticles in a colloidal solution and cationic cotton (cellulose) is shown in FIGS. 11A-D.

6.2.3.5. In-Situ Synthesis of Metal and Metal Oxide Nanoparticles on Cationic and Anionic Cellulose Substrates

Negative metal complex ions were adsorbed onto cationic cellulose substrates by immersing the cotton specimens in a 5 mM aqueous solution of NaAuCl₄ or Na₂PdCl₄. After removal of the samples from the metal salt solution, they were rinsed with water three times in order to remove the excess ions. The fabrics or yarns were then immersed in a 50 mM NaBH₄ solution in order to reduce the metal ions to zero-valence metal. After reduction, the samples were rinsed copiously with water. The obtained specimens were dried in air prior to characterization.

Cationic cotton specimens treated with Na₂PdCl₄ to furnish Pd nanoparticle coated cotton were further processed by electroless plating of Cu nanoparticles. This example indicates the catalytic properties of the Pd deposited onto cotton. Electroless copper plating was carried out using CuSO₄, ethylene diamine tetraacetic acid (EDTA), and sodium hypophosphite using the modified procedure of Ochanda et. al. (Ochanda, F; Jones Jr., W. E., Langmuir, 2005, 21, 10791-10796).

Cationic metal ions were adsorbed onto anionic cellulose substrates by immersing the cotton specimens in a 5 mM aqueous solution of AgNO₃, Pd(NO₃) or RuCl₃ and processed as described above for Au and Pd.

Cationic metal ions of Zn were also adsorbed onto anionic cellulose substrates by immersing the cotton specimens in a 10 mM methanolic solution of Zn(OAc)₂ at elevated temperatures (e.g., 60 degrees Celsius). This was followed by the dropwise addition of 30 mM NaOH and further heated at 60 degrees Celsius to produce zinc oxide particles. After a specified time, the cotton specimens were removed from the metal solution and washed with copious amounts of methanol to remove excess particles and dried for analysis.

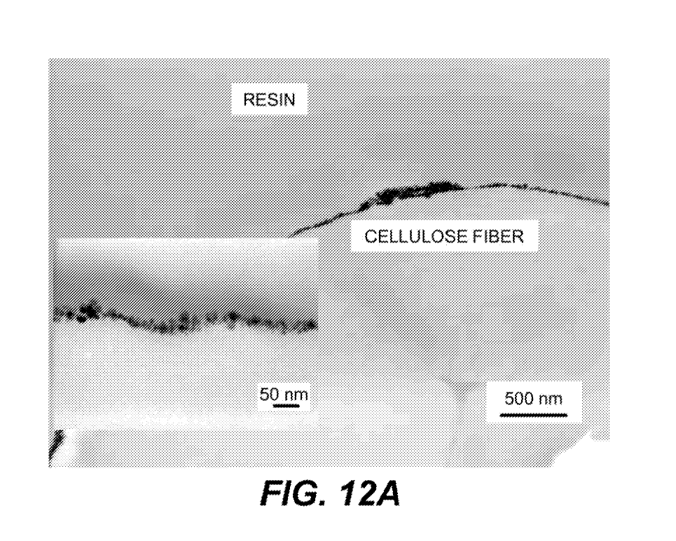

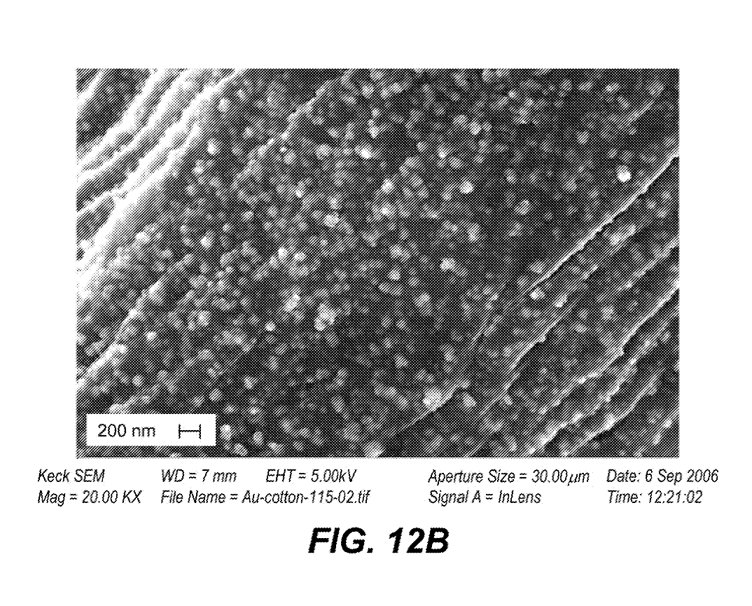

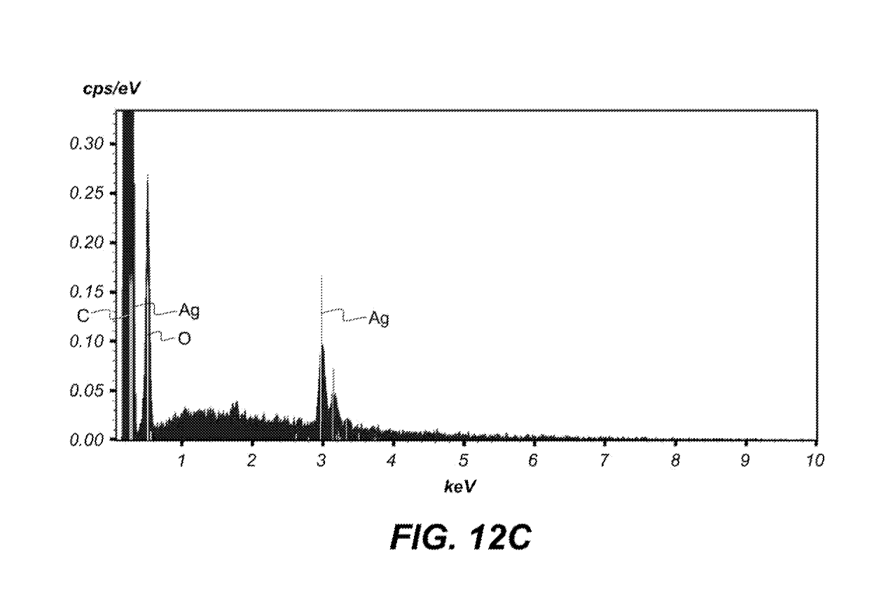

In situ synthesis of Ag nanoparticles on anionic cotton (cellulose) is shown in FIGS. 12A-C.

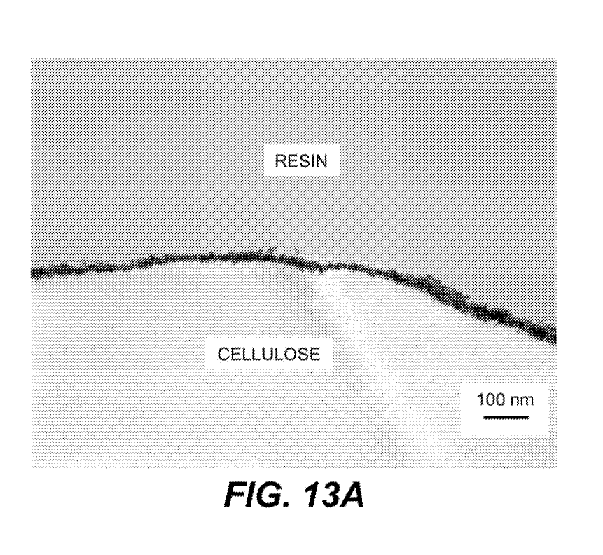

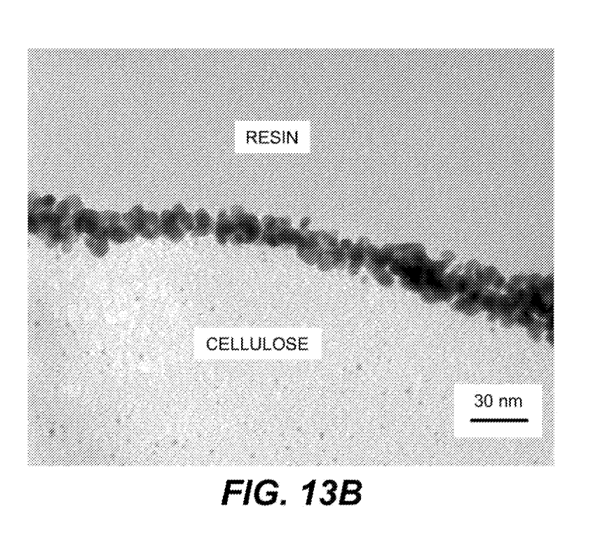

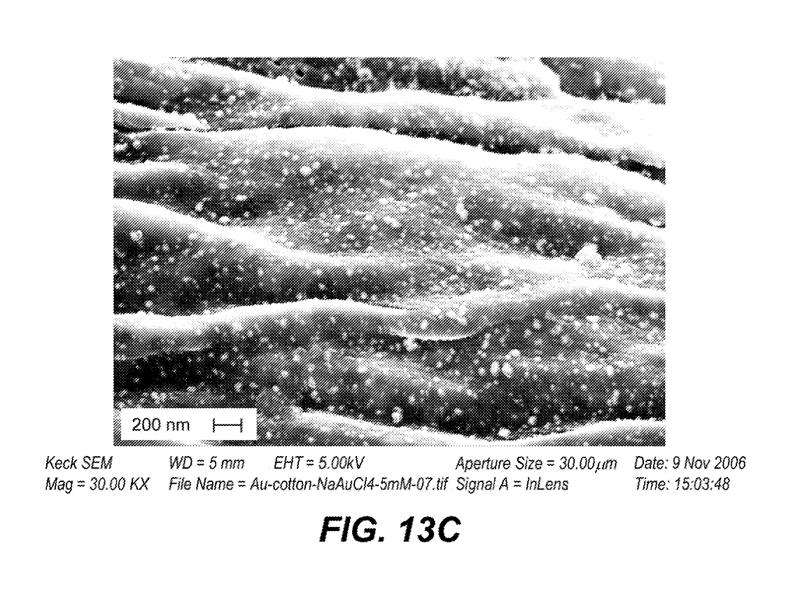

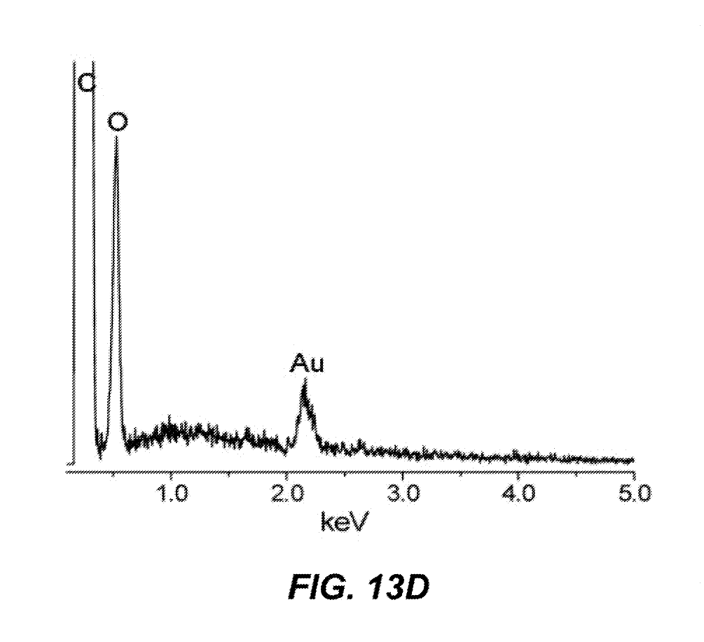

In situ synthesis of Au nanoparticles on cationic cotton (cellulose) is shown in FIGS. 13A-D.

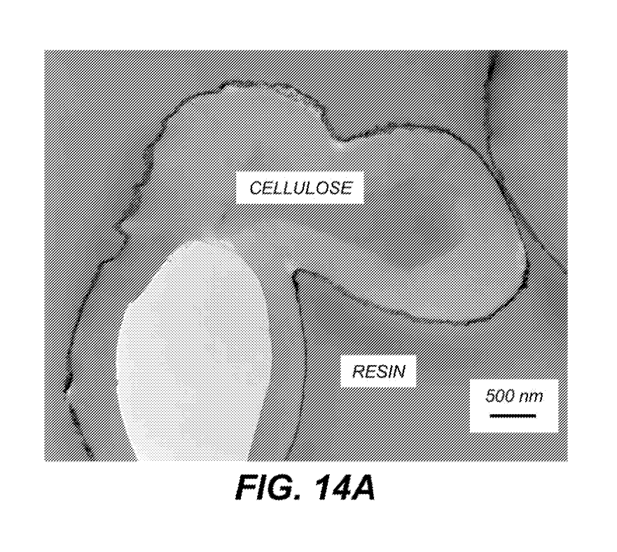

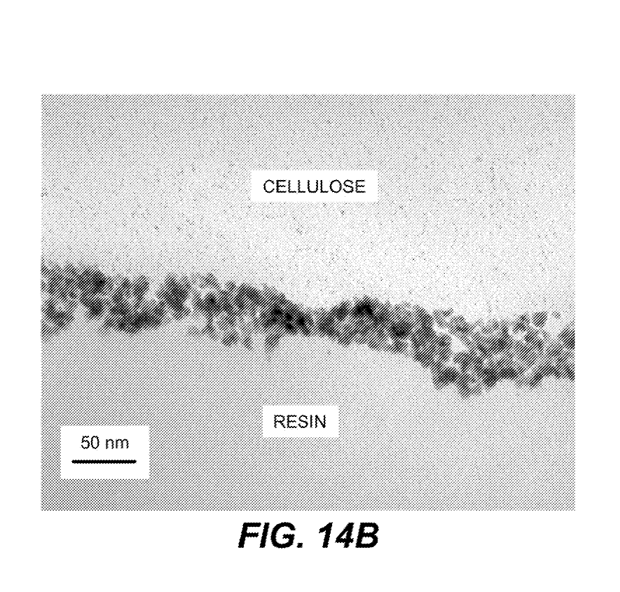

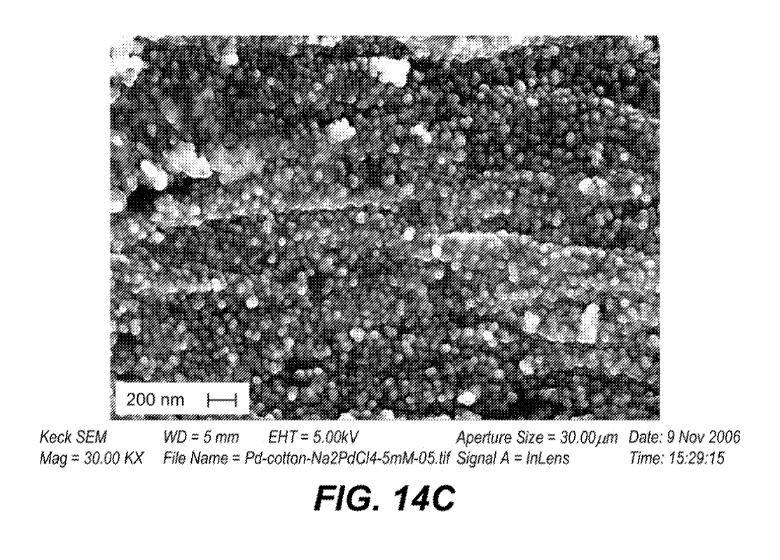

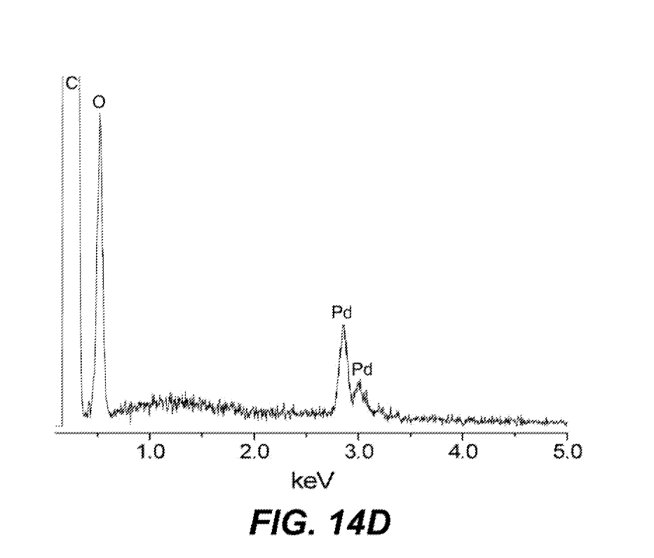

In situ synthesis of Pd nanoparticles on cationic cotton (cellulose) is shown in FIGS. 14A-D. The synthetic scheme was the same as in FIG. 13A-D above except that the metallic precursor solution was 5 mM Na₂PdCl₄.

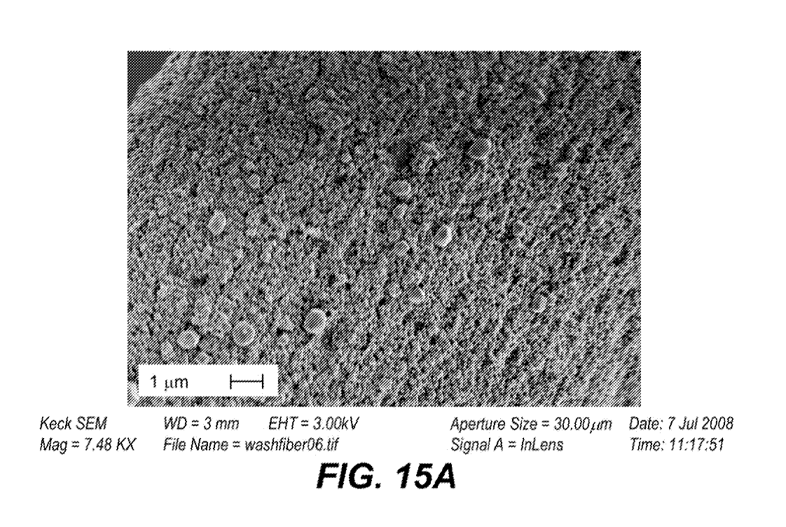

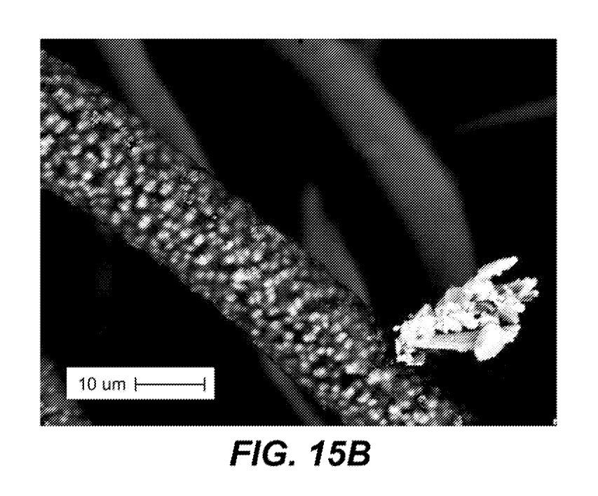

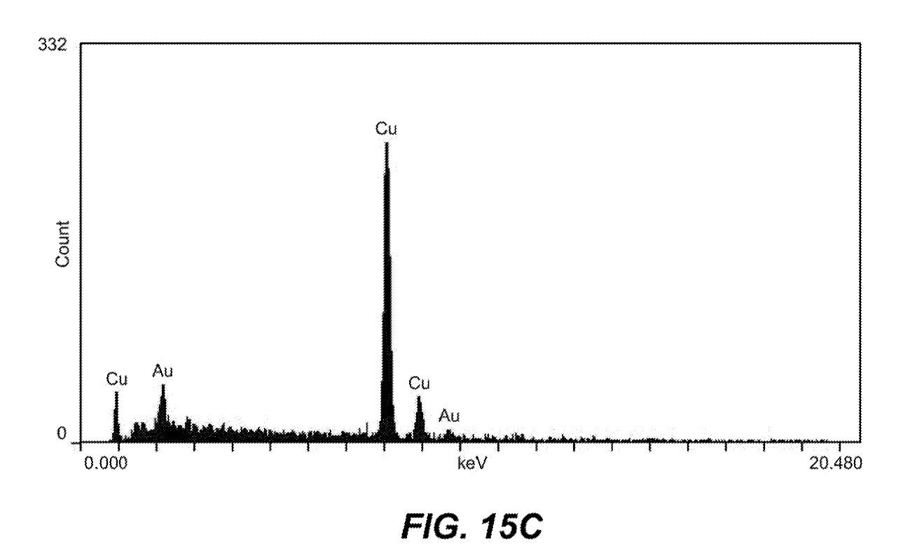

In situ synthesis on anionic cellulose substrates was also achieved. Photomicrographs of cellulose substrates resulting from in situ synthesis on anionic cellulose substrates are shown in FIGS. 15A-C and 16A-B.

In-situ synthesis of Cu nanoparticles on cationic cotton (cellulose) is shown in FIGS. 15A-C.

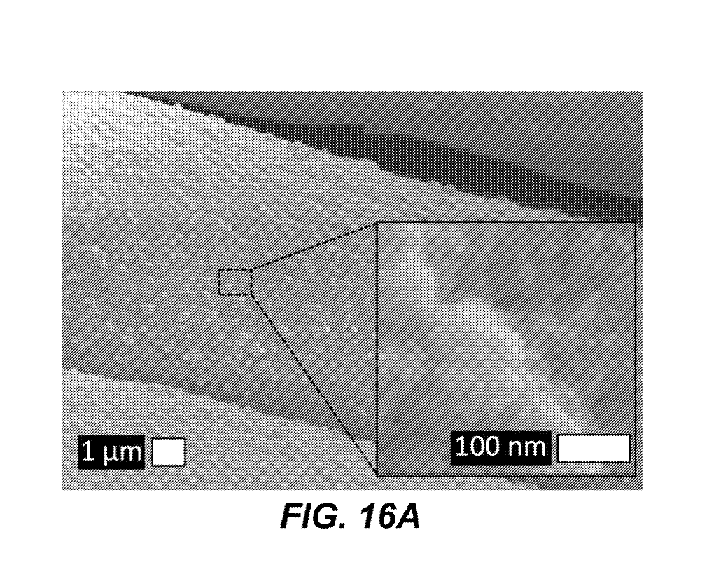

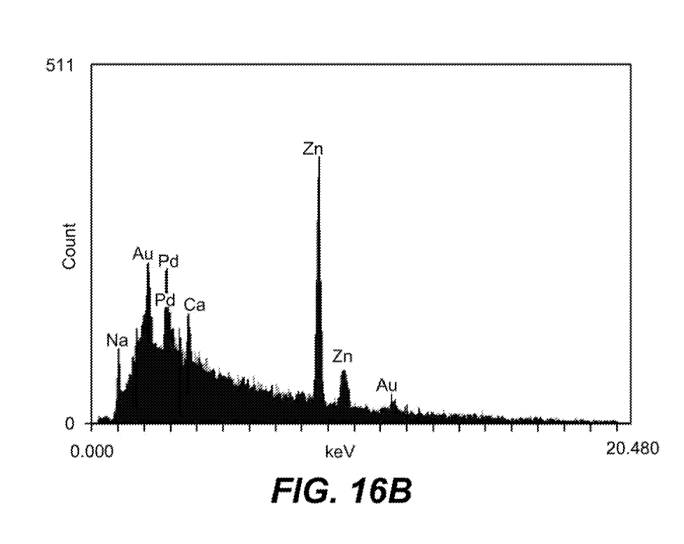

In situ synthesis of ZnO (zinc oxide) nanoparticles on anionic cotton (cellulose) is shown in FIGS. 16A-B.

6.2.3.6. Antibacterial Tests

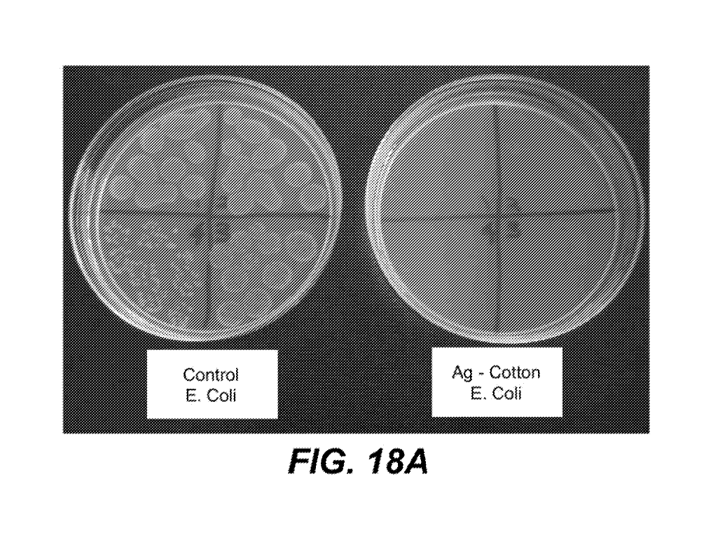

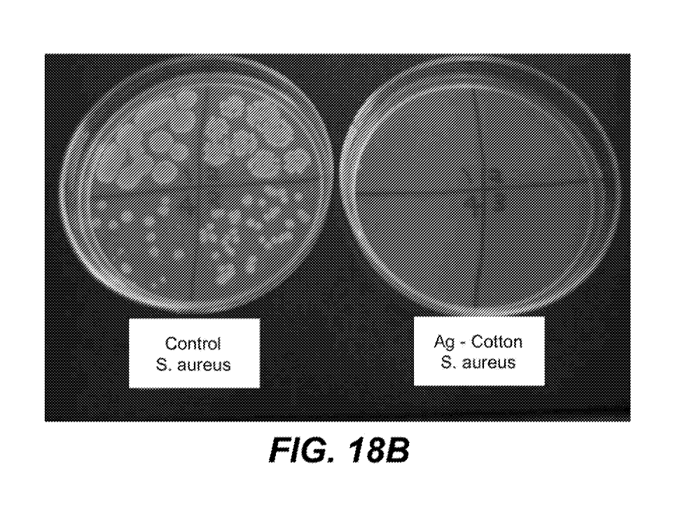

Modified AATCC 100 Test. The American Association of Textile Chemists and Colorists test method 100 (AATCC 100) provides a quantitative assessment of antibacterial finishes on textile materials. This method was modified according to ASTM method E2149-01 for determining antibacterial activity of immobilized agents under dynamic contact conditions (FIGS. 18A-B). Ag and Cu-treated cotton described in Sections 6.2.3.4 and 6.2.3.5 were weighed out and immersed in E. coli or S. aureus inoculum that was grown to log phase and diluted to a standardized concentration (e.g., colony forming units per milliliter; CFU/mL, as determined by absorbance and plate count assay). Samples were then agitated with the bacterial cultures on a benchtop shaker and aliquots were taken at 0 hrs (i.e., “0” contact time) and then again at a specified contact time points (1-24 h). Each aliquot was serially diluted, plated and incubated for ˜18 hrs to perform standard plate counts. Each assay was done in triplicate with an “inoculum only” control, and negative controls were performed (e.g., cotton or silk materials having no NP coating). From the plate counts, the percent reduction of the organisms resulting from contact with the NP-coated cotton was calculated to be 99.9% after 24 hours, which corresponds to at least a 6 log reduction in growth.

Zone of Inhibition Test. The ability of antibacterial compounds/materials to inhibit bacterial growth can be estimated with a so-called “zone of inhibition” test. Antibacterial materials are placed on an agar plate, pre-seeded with bacteria, which is then incubated to promote bacterial growth. Antibacterial agents diffuse out of the material, inhibiting growth in the “diffusion zone”. The relative antibacterial activity and diffusivity of the agent can be determined by comparing the size of these zones of inhibition. The presence of a zone of inhibition for Cu-coated cotton samples described in Section 6.2.3.5 were measured using the standard AATCC 147 test method. The assay was performed by placing an 8 mm disk of each fiber composite onto an agar-media plate seeded with approximately 10⁷ CFUs of E. coli or S. aureus. After ˜18 h of incubation, the diameters of the inhibitions zones were measured.

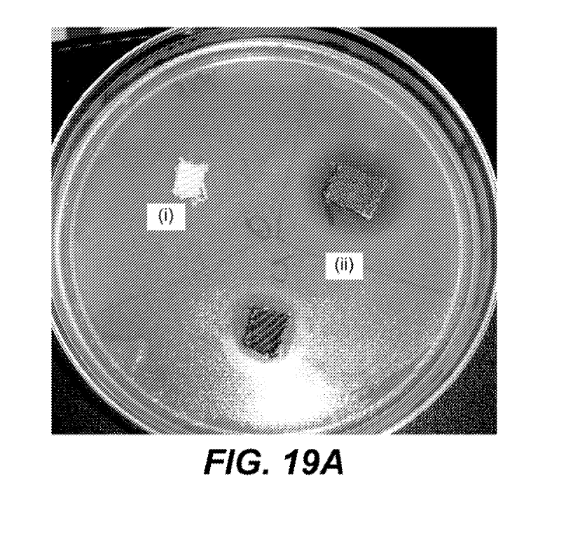

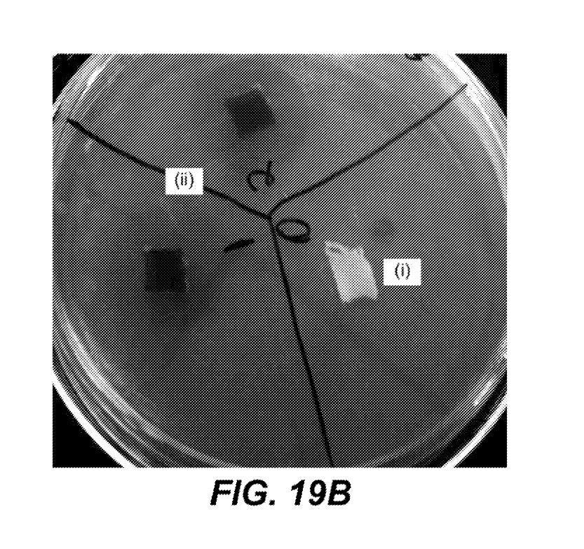

FIGS. 19A-B display photographs of inhibition zones for Cu-cotton against S. aureus (FIG. 19A) and for Cu-cotton against E. coli (19B). Control plates were used for non-treated cotton substrates and showed no zone of inhibition.

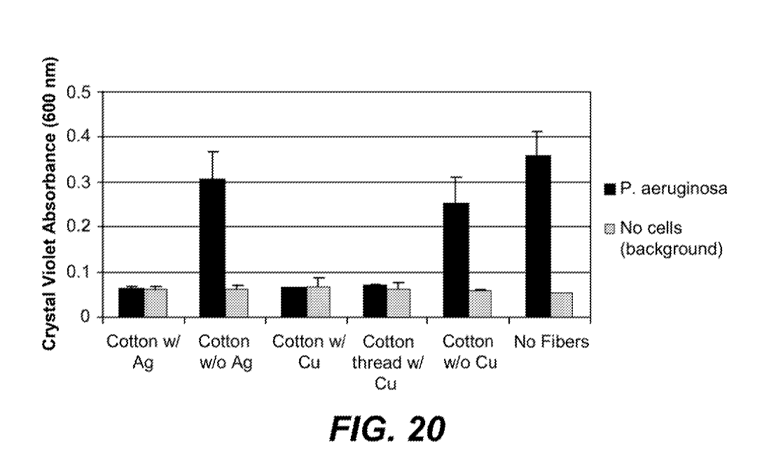

Biofilm Inhibition Tests. Ag and Cu-coated cotton samples described in Section 6.2.3.4 and Section 6.2.3.5 were also tested for P. aeruginosa biofilm inhibition. A standardized microplate-based assay was used as reported by Junker and co-workers (Junker, L. M.; Clardy, J., Antimicrob. Agents Chemother., 2007, 51, 3582-3590). A culture of P. aeruginosa was grown overnight to log phase in LB media. In a 96-well microtiter plate, a series of weighed fibers with and without NP-treatment was added to biofilm growth medium (10% tryptic soy broth; TSB), which was then spiked with the bacterial culture to a standard concentration. The microtiter plate was covered and incubated at 37° C. for 24 hours. After this time, medium and substrate was discarded and the wells were washed with phosphate buffer (PBS) to remove planktonic cells. The remaining biofilm that was formed during incubation was stained with a 0.1% (w/v) solution of crystal violet by incubating at room temperature for 30 minutes. The CV solution was then removed, the well was washed and the portion of CV embedded into biofilm was extracted with ethanol. Biofilm quantification was done spectrophotometrically by measuring the absorbance of the extracts at 600 nm. As illustrated in FIG. 20, no biofilm was produced in the wells containing either Ag or Cu-coated cotton, however, non-treated cotton and ‘cell only’ controls showed the growth biofilms after the 24 hour inhibition.

6.2.4. Discussion

The deposition of metal nanoparticles on cellulose substrates has been achieved via electrostatic interactions between modified cellulose surfaces and oppositely charged metal nanoparticles or metal ions. The methods demonstrated in this example achieved very high surface coverage of metal nanoparticles on cotton fabrics. The color appearance of metal-cotton fabrics was uniform in samples resulting from direct assembly and from in situ synthesis methods (data not shown).

The deposition methods described in this example are also versatile. Various nonmetallic, bimetallic nanoparticles or other charged particles can be deposited onto modified cellulose substrates. In addition to cellulose, glass, carbon, metal or metal oxides and polymers are suitable substrates for the deposition of metal particles as demonstrated in this example.

Such coated substrates have applications for optical materials, magnetic materials, biological sensors and catalysts. They also have use as antibacterial materials, such as in wound dressings, antibacterial clothing and non-woven antibacterial filtration material. The methods for metal nanoparticle deposition demonstrated in this example have numerous applications, e.g., in fabric inkjet printing with nanoparticles, as flexible and portable catalytic mantles, and as seeds for electroless deposition of metal on cellulose substrates.

### 6.3. Example 3

### Surface Bonding of Organic Particles on Cellulose Substrates

6.3.1. Summary

This example demonstrates surface bonding of polystyrenesulfonic acid (PSS) particles on cellulose substrates using direct assembly of PSS particles on cationic cellulose substrates.

6.3.2. Material and Methods

Cationic cellulose was prepared using the methods described in Section 6.2.3.

Spherical PSS colloidal particle suspensions at a concentration of 2.5% wt. were purchased from Polysciences, Inc. in diameters of 0.2, 0.5, and 1.0 micrometers and diluted with deionized water to 0.016 mg PSS spheres per mL of suspension. Mushroom cap shaped particles, approximately 1.2 micrometers in diameter, at a concentration 4.2% wt. were diluted with deionized water to 0.009 mg PSS particles per mL of suspension.

The process used to deposit PSS particles onto cationic cellulose was achieved by immersing the specimens into aqueous colloidal solutions of negatively charged PSS particles.

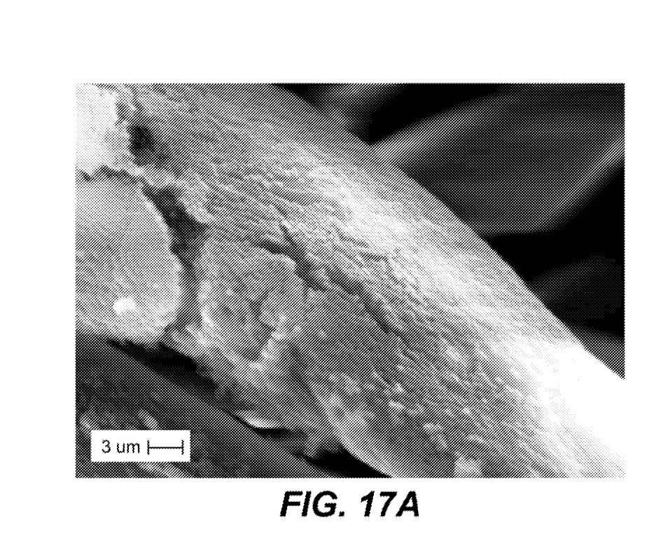

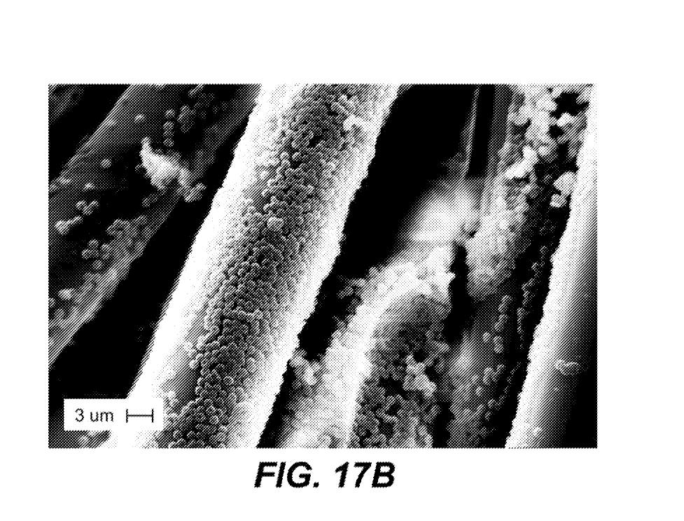

Direct assembly using negatively charged PSS particles in a colloidal solution and cationic cotton (cellulose) is shown in FIGS. 17A-B. Shown are SEM images of the surface of a cationic cotton fiber coated with (A) polystyrene sulfonate spheres size 1 micron in diameter, (B) polystyrene sulfonate mushroom cap particles size 1.2 microns in diameter.

### 6.4. Example 4

### Silver Particle-Coated Cotton Fibers and Nylon 6 Nanofiber Mats Analyzed by SERS

The overall enhancement factors of the SERS-active fibers will be defined by the average ‘roughness feature,’ which is the combined contributions from the metal NP composition (e.g., Au or Ag), the average interparticle distance, and the average size of the individual NPs (FIG. 22A). It is well known that huge SERS signal enhancements can be achieved for bound sensor molecules when the SERS-active substrate exhibits an absorption band (or plasmon band) that corresponds to the wavelength of the excitation source. In this example, particle size, composition and interparticle distance are exploited in this way to give highly enhanced SERS, such that the average excitation band of the SERS-active fibers is in resonance with the wavelength of the laser source. Although precise control over the interparticle distance is not possible using the LBL-based methodology described herein, this distance should be relatively constant for a given NP-fiber composite. Because there is a finite number of NP binding sites on the fibers, fibers coated with the various NP sizes should exhibit different relative interparticle distances. Molecules adsorbed to the particle coated surface can be detected using SERS. Furthermore, the general mode of detection illustrated in FIG. 22A also applies to SEIRA and SEF.

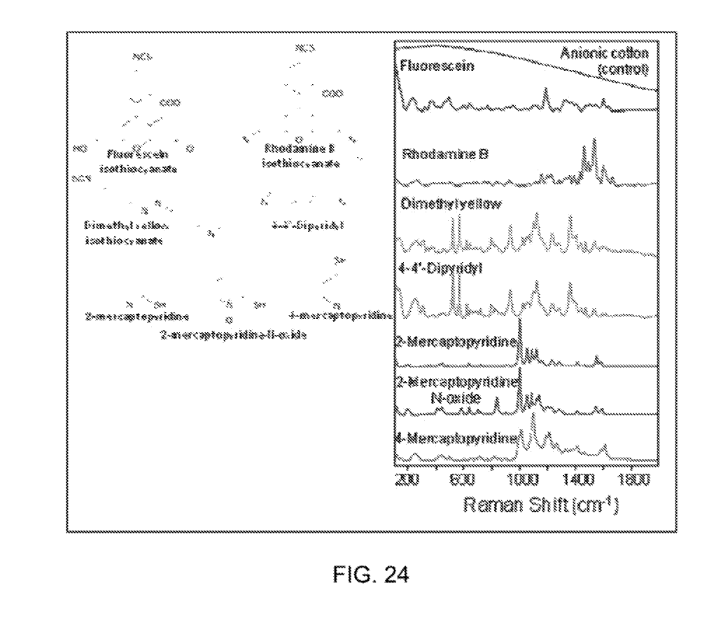

In this example, silver particle-coated cotton fibers and nylon 6 nanofiber mats were treated with a variety of commercially available organic molecules and analyzed by SERS (FIGS. 24, 25 and 26A-D). Three significant results were obtained:

(1) Different Raman reporter molecules absorbed onto the SERS-active textiles were detected by their unique spectra (FIG. 24),

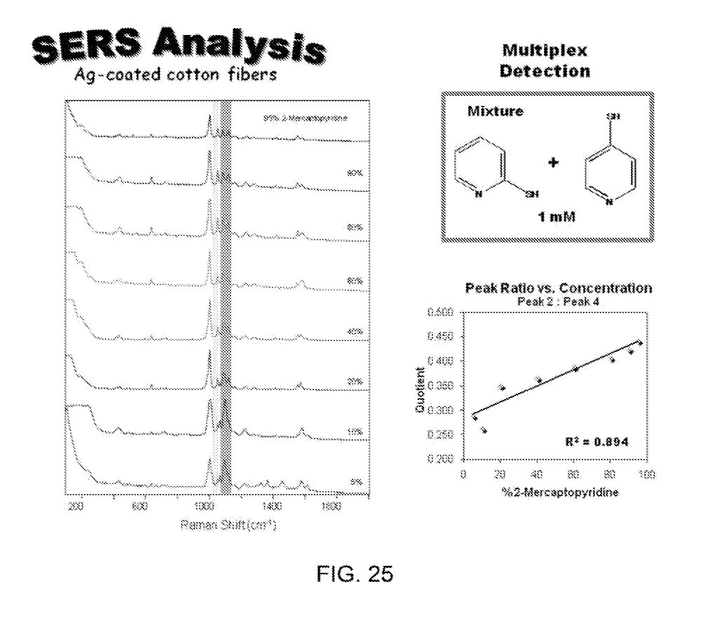

(2) Multiple Raman reporters absorbed onto a single SERS-active textile substrate (FIG. 25) were simultaneously detected, and

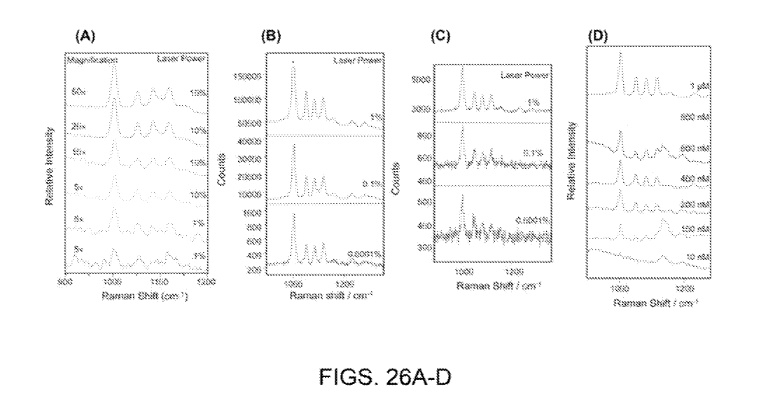

(3) A Raman reporter was detected at low concentrations using minimal laser power (FIGS. 26A-D).

These results highlight or demonstrate that metal particle-textile composites can be chemically functionalized without affecting the particle-fiber electrostatic interactions. Specifically, soaking Ag and Au particle-coated cotton and nylon substrates in relatively concentrated solutions of thiols (at least 10-3 M) does not remove the particles from the surface of the textile. Raman spectra were acquired using a Renishaw InVia Raman microscope equipped with a 785 nm excitation source and 5×-50× objective lenses.

FIG. 24 shows that there is a great deal of latitude in the molecular structure of the reporter that yields a measurable and distinct Raman spectrum. Raman reporters with subtle structural differences can be differentiated based on their Raman spectra (e.g., the derivatives of mercaptopyridine shown in FIG. 24).

SERS-active textile substrates can also be used in the simultaneous detection of multiple Raman reporters absorbed onto the fibers. Ag SERS-active cotton fibers were incubated with solutions containing various mixtures of 2- and 4-mercaptopyridine and analyzed by SERS (FIG. 25). The spectra shown in FIG. 25 can be clearly differentiated by comparing the integrated area for the four prominent peaks in each spectrum (indicated by the shaded boxes). For example, by comparing the ratio of the signals between 1032-1060 cm⁻¹ and 1075-1140 cm⁻¹, a correlation between sample composition and spectral output is evident (e.g., plot shown in FIG. 25). The spectral processing and comparisons illustrated use simple ratios of integrated peak area. Slightly more ‘sophisticated’ algorithms can result in a greater degree of correlation in the spectra as a function of sample composition, and can also be used for the detection of many co-absorbed Raman reporters.

The limits of the SERS-active textile substrates were tested as a function of Raman-active reporter concentration, excitation power, and the magnification power of the Raman microscope. Ag particle-coated cotton and nylon 6 nanofiber substrates were incubated with 1 mM to 10 nM solutions of 2-mercaptopyridine. The spectra shown in FIGS. 26A-D are representative of the results obtained. This system is clearly sensitive as indicated by the bottom-most spectra in FIGS. 26A-D. For example, the bottom spectrum in FIG. 26C was obtained using 0.0001% laser power from a nylon 6 nanofiber sample that was incubated with 1 μM 2-mercaptopyridine. This laser power corresponds to 1 nanowatt incident at the sample. Moreover, the spectra shown in FIG. 26C were collected using a 5× objective that was focused on fiber at a distance of approximately 5 cm. Based on these results, SERS-active textile substrates can be translated to a standoff detection platform for targets at distances exceeding 10 meters and possibly 100 meters.

In summary, this example demonstrates the deposition of silver and gold nanoparticles on the surface of cationic cotton and nylon fibers using electrostatic interactions. Silver and gold nanoparticles having a net negative charged were synthesized using conventional methodologies and subsequently absorbed onto the surface of the fibers. These substrates have proven to be very robust, prepared through simple processing, and give very high and uniform metal nanoparticle surface coverage of the fiber surfaces. These substrates have been treated with various commercial organic chemicals (Raman-active reporters), and the resulting fibers exhibit enhanced Raman signal of the absorbed chemicals using near-infrared laser excitation (e.g., 785 nm). This represents a new platform for surface-enhanced Raman scattering (SERS) analysis of target material. The magnitude of the enhancement—or Raman signal in general—is unique to the SERS-active fibers, as little to no Raman signal is observed for the organic chemicals absorbed onto aqueous suspensions of gold and silver nanoparticles, or absorbed onto the fiber alone, in conjunction with the nanoparticle-coated fibers, Raman spectroscopy can be used to detect multiple targets on a single fiber. Currently, Raman spectra of the chemicals absorbed onto the SERS-active fibers can be obtained at a distance of at least 50 millimeters using very low laser power (e.g., ˜10 microwatts). Potential uses of this technology include, but are not limited to friend-foe identification, anti-counterfeiting, detection of trace chemicals and biological molecules, and various needs in tagging, tracking, and identification.

### 6.5. Example 5

### SERS-Based Interrogation of Nanoparticle-Coated Textile Fibers

This example demonstrates Surface Enhanced Raman Scattering (SERS)-based interrogation of particle-coated textile fibers using a commercial Raman microscope (Renishaw InVia Raman Microscope, 785 nm near-IR excitation).

Raman spectroscopy results in the inelastic scattering of molecules. This scattering has high information content and is ideal for analyzing aqueous samples. The primary disadvantage of traditional Raman spectroscopy is its low sensitivity. Surface Enhanced Raman Scattering (SERS) is based on the high polarizability of noble-metal surfaces, which leads to >10⁶-fold increase in Raman signal (Fleishmann, M.; Hendra, P. J.; McQuillan, A. J., J. Chem. Soc. Chem. Commun. 1973, 80). Limits of detection at the attomolar level are possible. Furthermore, molecular species not near the metal surface are “invisible” in SERS.

The overall enhancement factors of the SERS-active fibers will be defined by the average ‘roughness feature,’ which is the combined contributions from the metal NP composition (e.g., Au or Ag), the average interparticle distance, and the average size of the individual NPs (refer to FIG. 22A). It is well known that huge SERS signal enhancements can be achieved for bound sensor molecules when the SERS-active substrate exhibits an absorption band (or plasmon band) that corresponds to the wavelength of the excitation source. In this example, particle size, composition and interparticle distance are exploited in this way to give highly enhanced SERS, such that the average excitation band of the SERS-active fibers is in resonance with the wavelength of the laser source. Although precise control over the interparticle distance is not possible using the LBL-based methodology described herein, this distance should be relatively constant for a given NP-fiber composite. Because there is a finite number of NP binding sites on the fibers, fibers coated with the various NP sizes should exhibit different relative interparticle distances. Molecules adsorbed to the particle coated surface can be detected using SERS. Furthermore, the general mode of detection illustrated in FIG. 22A can also be applied to SEIRA and SEF.

This example demonstrates that when Ag-coated nylon and cotton fibers tagged with a model Raman reporter tag (2-MP) are interrogated using SERS, the tag is detected at trace levels with low power.

Functionalized particles that can be used include SiO₂-coated Au particles (e.g., 70 nm particles), Au nanorods (e.g., 50 nm particles), Ag-coated nanoporous SiO₂ (e.g., 50 nm particles); and Au particle array (e.g., 35 nm). Such SERS-active substrates are known in the art (Hui Wang, Carly S. Levin, and Naomi J. Halas; J. Am. Chem. Soc. (2005), 127, 14992).

SERS-active anionic and cationic cotton and nylon were made by the methods disclosed in anionic cotton fibers using electrostatic interactions or in situ metal ion reduction as described in WO2009/129410A1 and shown in FIG. 31. Top left shows a scanning electron microscopic image of SERS-active cotton coated with metallic particles. Top right shows diagrams of synthesis of particle-coated cationic and anionic cotton. Bottom left shows a scanning electron microscopic image of SERS-active nylon coated with metallic particles. Bottom right shows a diagram of the synthesis of particle-coated Nylon 6 nanofibers.

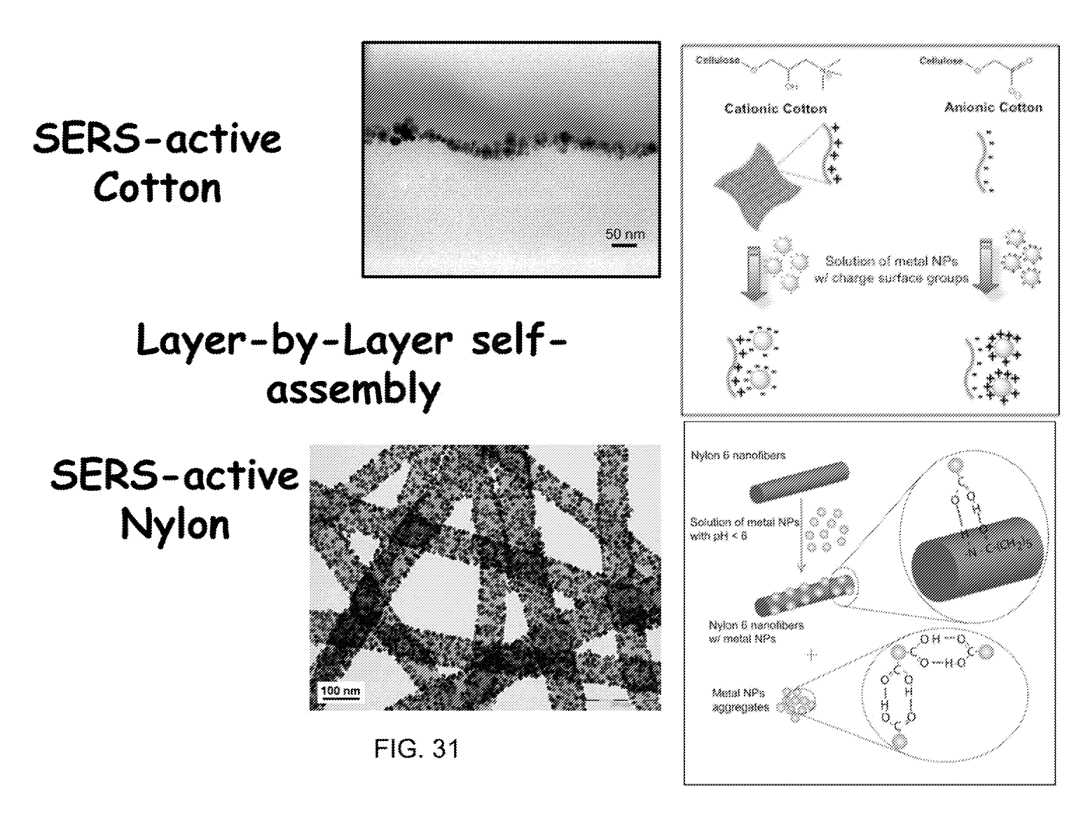

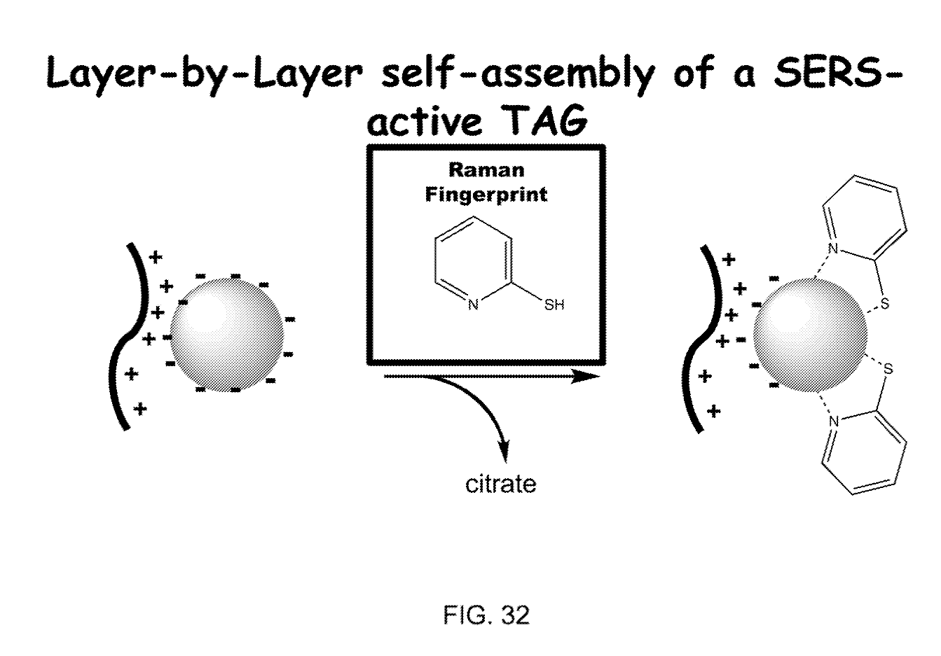

An example of LBL self-assembly of a SERS-active tag is shown in FIG. 32. In this embodiment, a citrate stabilized metal particle-coated substrate was treated with 2-mercaptopyridine (2-MP), a Raman reporter.

FIG. 24 (left) shows commercially available compounds used as Raman reporters for the SERS studies using Ag particle-coated cotton fibers. The SERS spectra shown are representative of the data obtained for the various Raman reporters using silver SERS-active cotton substrates.

FIG. 24 (right) shows a SERS based analysis of Ag-coated anionic cotton fibers tagged with various Raman reporter tags shown on the left of the figure: Fluorescein isothiocyanate, Rhodamine β isothiocyanate, dimethyl yellow isothiocyanate, 4-4′-dipyridyl, 2-mercaptopyridine, 2-mercaptopyridine N-oxide, and 4-mercaptopyridine (4-MP). Raman spectra are shown on the right. The control spectrum for untagged anionic cotton is shown at the top right of the figure.

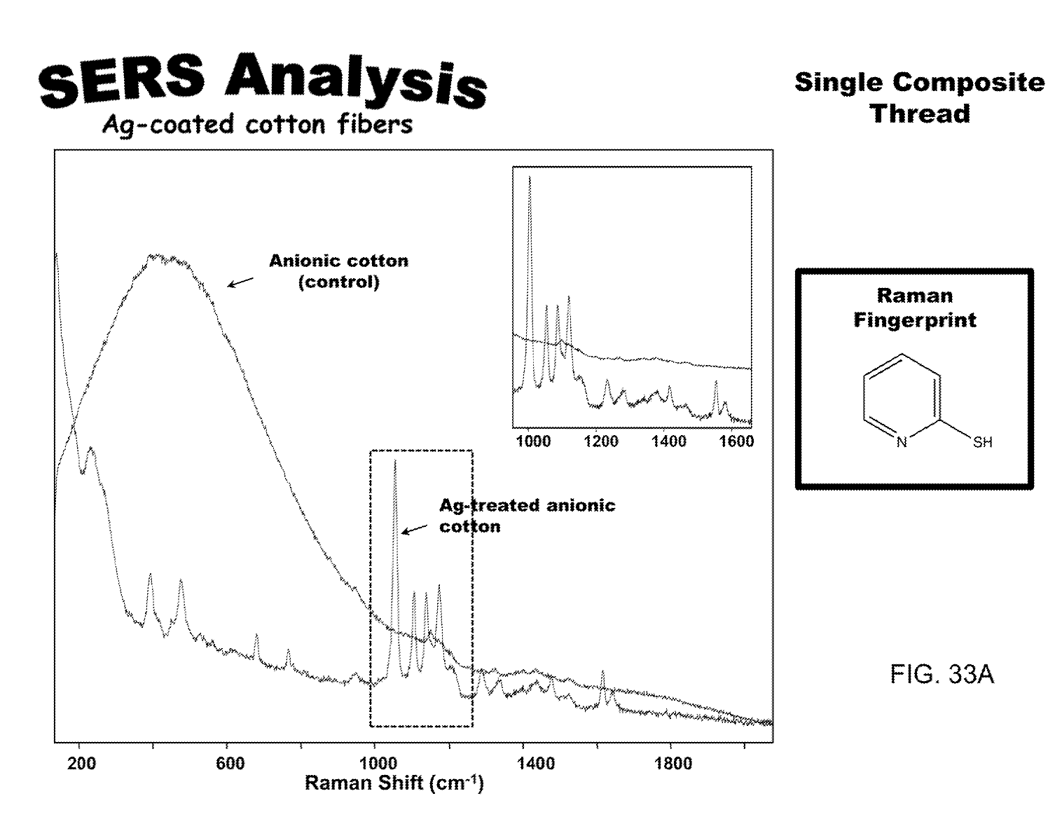

FIG. 33A shows a SERS based analysis of Ag-coated anionic cotton fiber tagged with 2-MP. Control, anionic cotton. The inset at the right shows a detail of the spectrum for the tagged Ag-treated anionic cotton fiber from 1000-1600 cm⁻¹.

FIG. 33B shows a SERS based analysis of Ag-coated anionic cotton fiber tagged with a single tag, 2-MP at a concentration of 1 μM. The spectra shown on the left result from various combinations of microscope objectives and laser power of the Raman microscope over a 10 sec integration time. At the lowest combination of objective power (5×) and laser power (0.1%) tested (lower-most spectrum), the fingerprint of the Raman reporter tag was successfully detected. This represents extremely low laser power, approximately 10 μW, over a 10 sec integration time.

FIG. 25 shows a SERS based analysis of Ag-coated anionic cotton fibers tagged with multiplex tags of 2-MP and 4-MP in concentrations that varied from 5% 2-MP/95% 4-MP (bottom-most spectrum) to 95% 2-MP/5% 4-MP (top-most spectrum). The plot at the lower right shows that the ratio of region 2: region 4 (signature peaks for both 2-MP and 4-PM) varies directly with the concentration of 2-MP and 4-MP present.

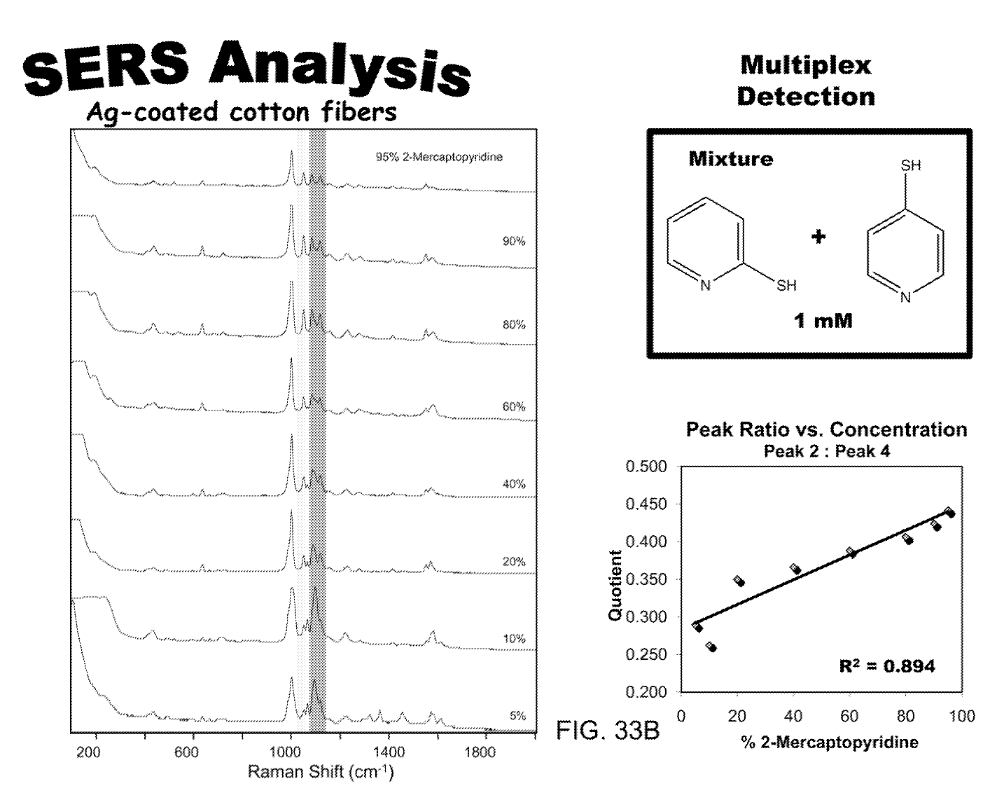

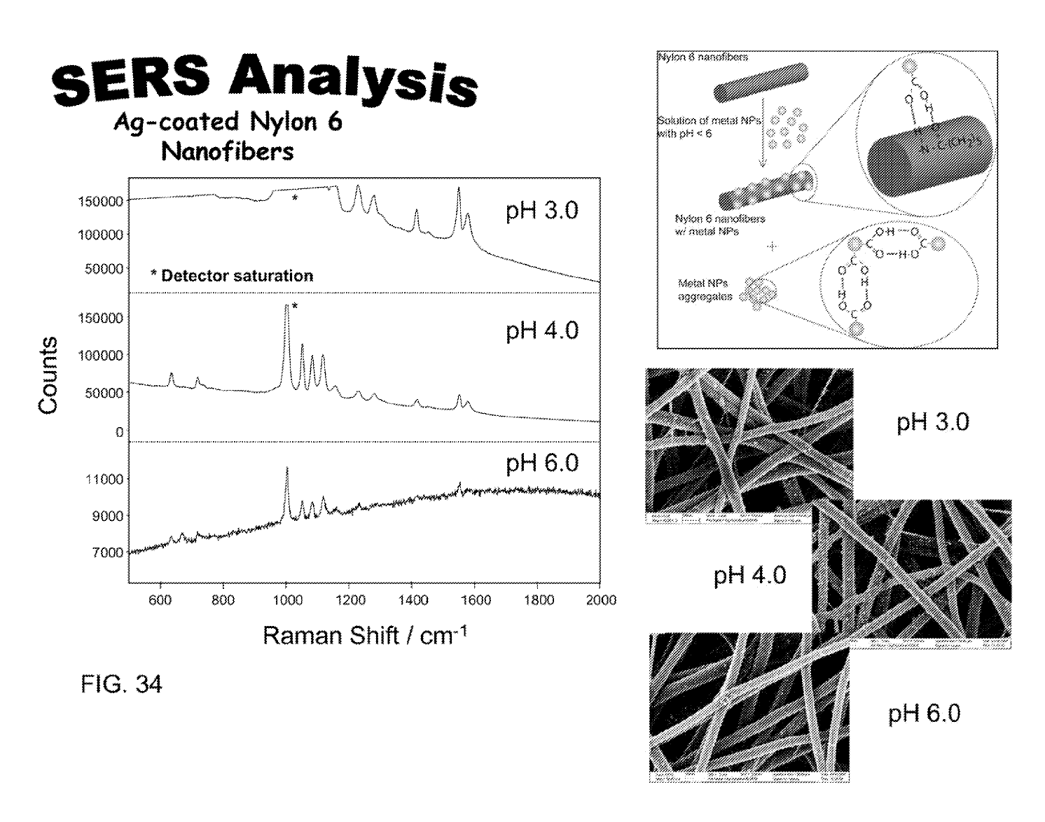

FIG. 34 shows spectra obtained on a Renishaw In Via micro-spectrometer. Laser power=1% of ˜8 mW ˜80 μW, 10-sec extended scan (500-2000 cm⁻¹). The top trace shows the results from pH 3.0 Ag-Nylon-6. This sample gave good quality spectra down to 0.1% laser power and also using the 5× objective at 1% laser power. There is a large background signal associated with this sample that is not present in the pH 4.0 samples. This sample does not perform as well as the pH 4.0 samples. The middle trace shows the results from pH 4.0 Ag-Nylon-6. The pH 4.0 sample performed the best compared to the pH 3.0 and 6.0 samples. Using the 50× objective, 2-MP signal was detected using 0.0001% of the total laser power. This corresponds to 8 nW. At this power the laser light is not visible. This is well below OSHA safety regulations. Also, 2-MP signal was detected using the 50× objective and 0.0001% laser power in a 1-sec static scan. In a static scan, the detector collects data from each wavelength simultaneously. Compared to an extended scan, a static scan is faster but gives lower resolution spectra. Using the 5× objective, 2-MP signal was detected using 0.05% laser power (i.e., 4 μW). The 5× objective is approximately 3 cm from the sample. The lower trace shows the results from pH 6.0 Ag-Nylon-6. This sample gave marginal signal and does not compare well with the pH 3.0 and 4.0 samples. Inspection with an optical microscope showed a lot of crystalline material was present within the sample.

These results show that Ag-coated nylon and cotton fibers can be used as SERS substrates. The model Raman reporter (2-MP) was detected at trace levels, with low power, and at a distance of ˜35 mm from the sample.

### 6.6. Example 6

### Modification of the Near Infrared (NIR) Signal of Textile Fabrics Via Colloidal Self-Assembly of Polystyrene (PS) Nanoparticles

This example demonstrates modification of the near infrared (NIR) signal of textile fabric via colloidal self-assembly of polystyrene (PS) nanoparticles. Colloidal self-assembly of photonic structures (structures that interact with light) can be used to alter interaction of light with a desired substrate (P. Vukusic and J. R. Sambles. Photonic structures in biology. Nature 2003, 424, 852-855.) In this example, a textile fabric was modified using colloidal self-assembly (i.e., layer-by-layer or LBL) of polystyrene (PS) nanoparticles to have less NIR reflectance, and hence, be less detectable by a night vision device (NVD). Such modification can be used to improve military camouflage against detection by a NVD.

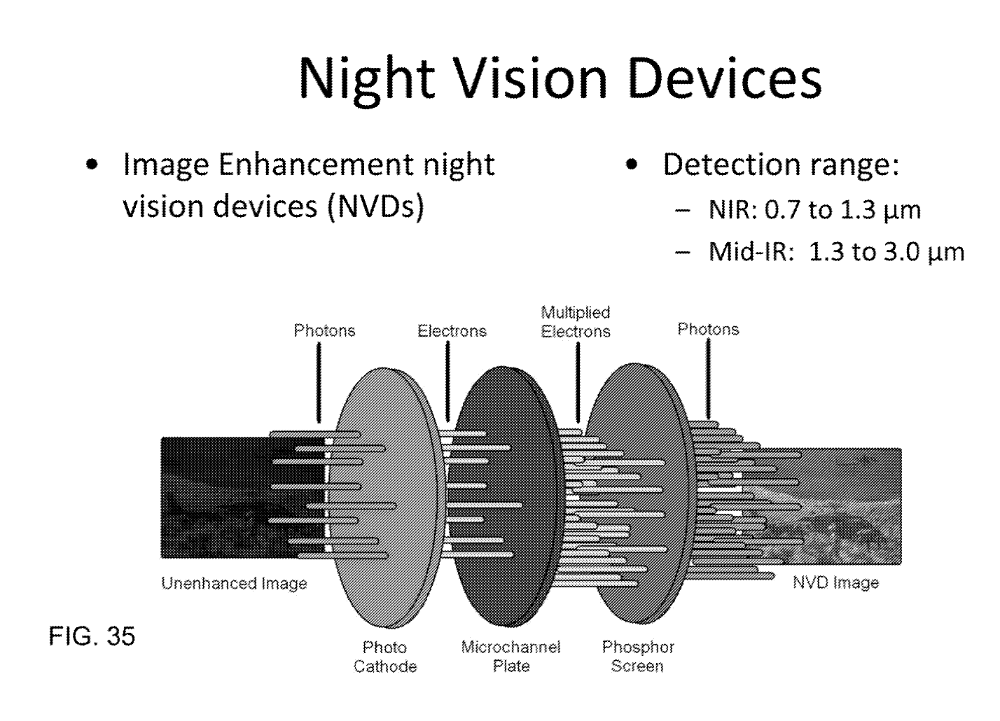

FIG. 35 shows the basic configuration of a night vision device (NVD), which comprises a photo cathode, a microchannel plate, and a phosphor screen, and shows the general principles of image enhancement using the NVD, wherein photons of the unenhanced image are multiplied to produce the NVD image.

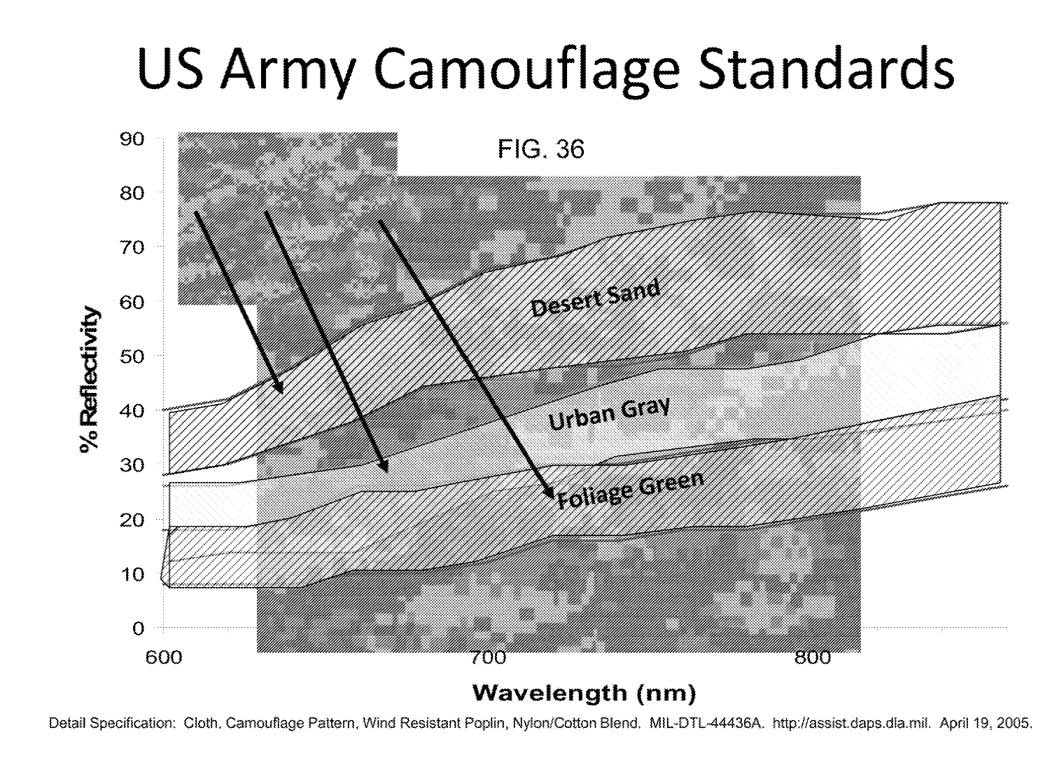

FIG. 36 shows US Army camouflage standards for Foliage Green, Urban Gray and Desert Sand camouflage cloth tested in this example. The camouflage cloth was camouflage patterned, wind-resistant poplin, nylon/cotton blend (MIL-DTL-44436A; http://assist.daPS.dla.mil, Apr. 19, 2005). Percent reflectivity is plotted against wavelength (nm).

Measurement of various forms of reflection and refraction are well known in the art.

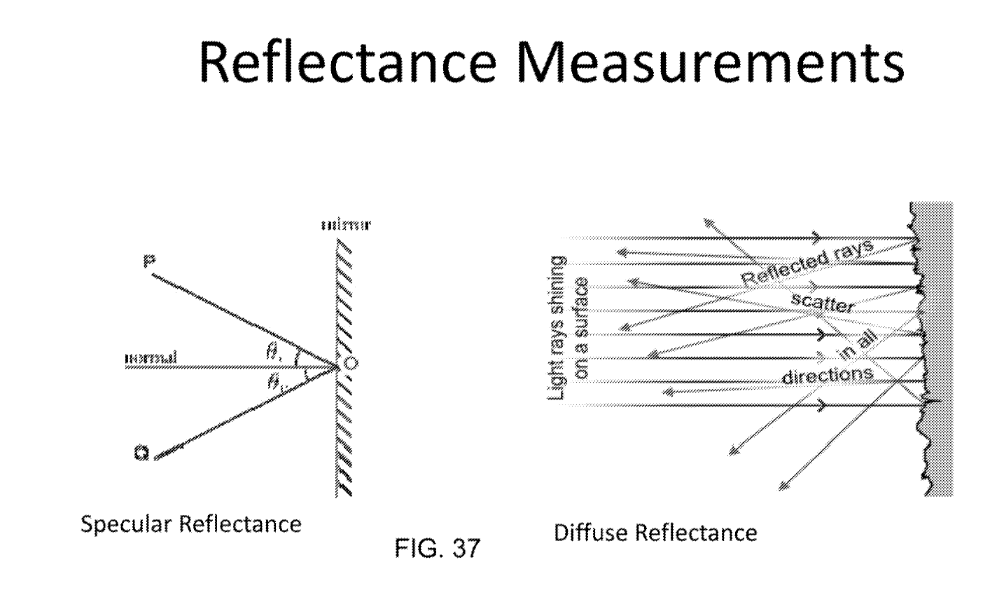

FIG. 37 shows the basic principles of measuring specular reflectance (left) and diffuse reflectance reflectance (right), which were used to measure reflectance in this example.

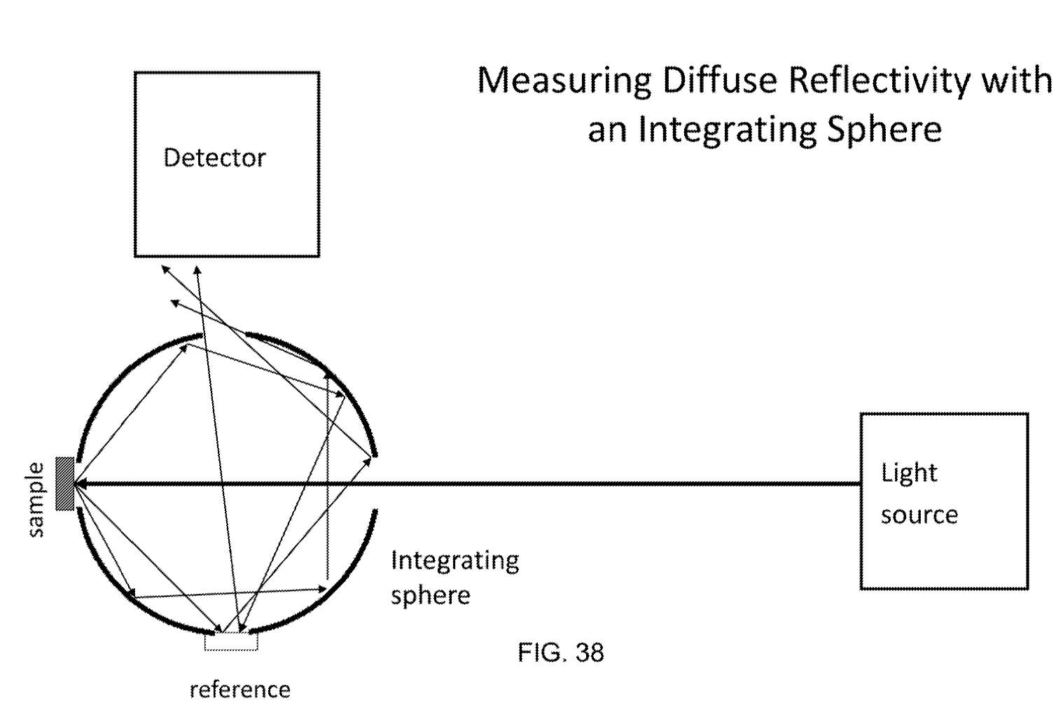

FIG. 38 shows how diffuse reflectivity can be measured using an integrating sphere and a detector, a method well known in the art.

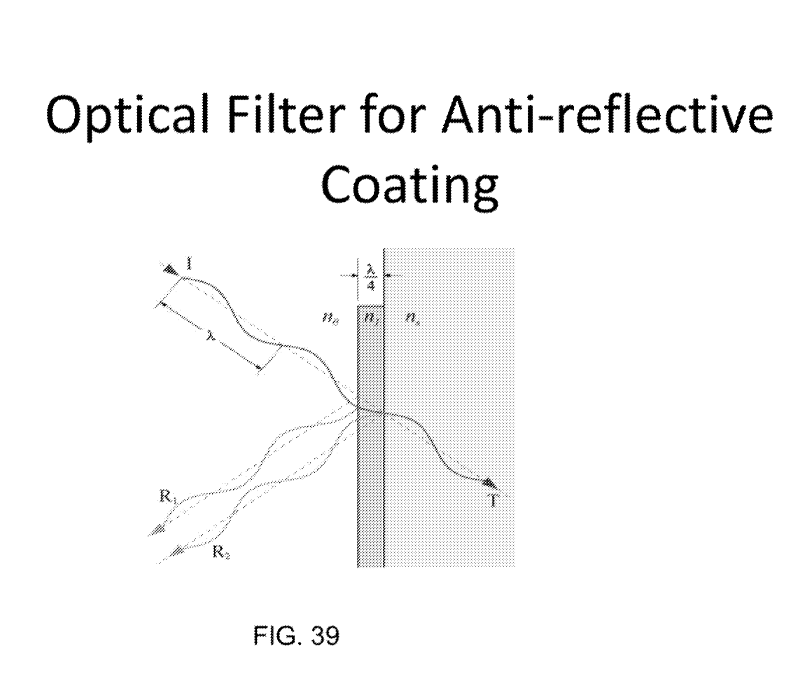

FIG. 39 is a schematic diagram that shows the paths of reflected and transmitted light after incident light encounters a substrate (in this case, an optical filter).

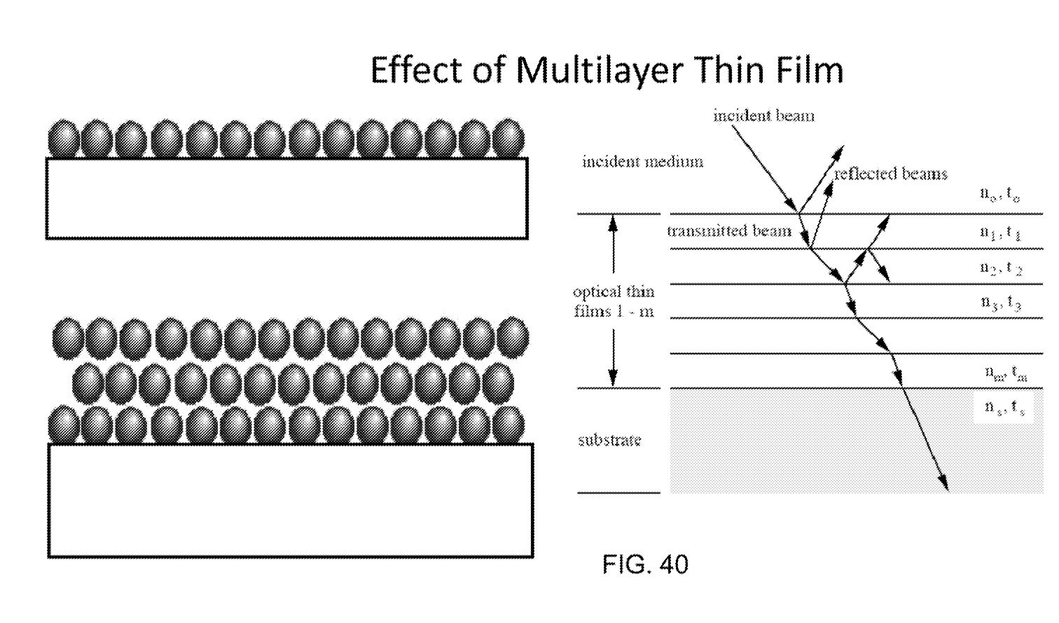

Principles governing the properties of anti-reflective coatings (e.g., on optical filters) are well known in the art. FIG. 40 shows the effect of a single layer (top) and multilayer (bottom) thin film on the paths of reflected and transmitted light after incident light encounters a substrate with an anti-reflective single or multiple layer coating.

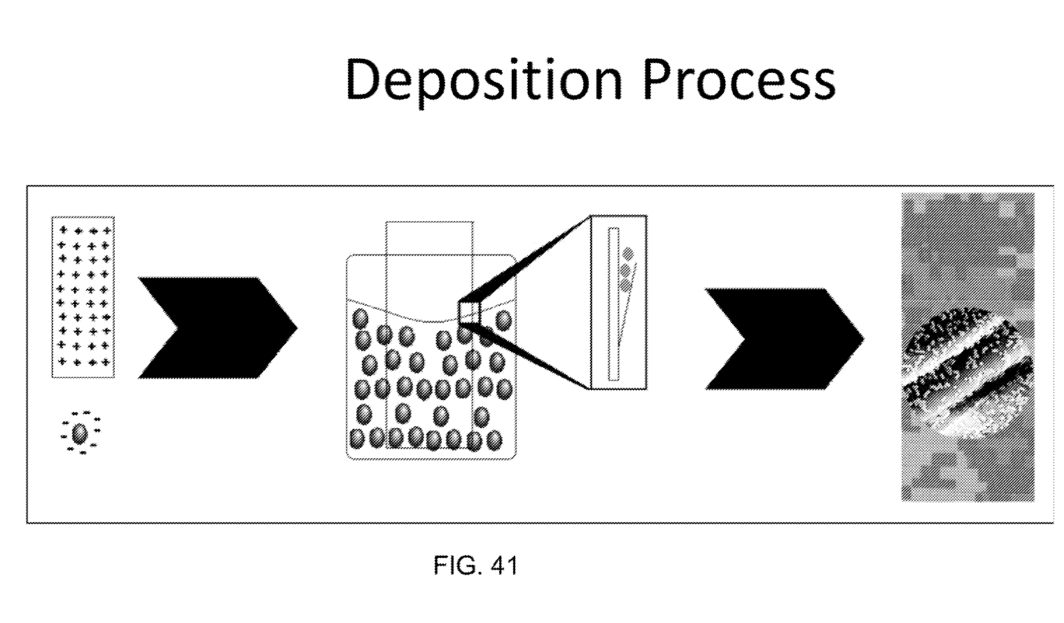

FIG. 41 shows the deposition process of anti-reflective multiple layer coating of polystyrene (PS) nanoparticles on textile fibers using the methods disclosed herein. The left illustration depicts the starting components of the deposition process; that is, cationic camouflaged fabric and anionic polystyrene/polystyrene sulfonate particles. The middle illustration shows the deposition process—where the cationic fabric is immersed in a vessel containing an aqueous solution of the particles. The right illustration shows an optical image of the PS-coated camouflage fabric and a scanning electron image of the same PS-coated camouflage fabric.

Reflectivity of coated samples was measured with a Shimadzu UV-3101PC UV/Vis/Near-IR Spectrophotometer with an integrating sphere. Particle coating was evaluated using a Leica 440 Scanning Electron Microscope.

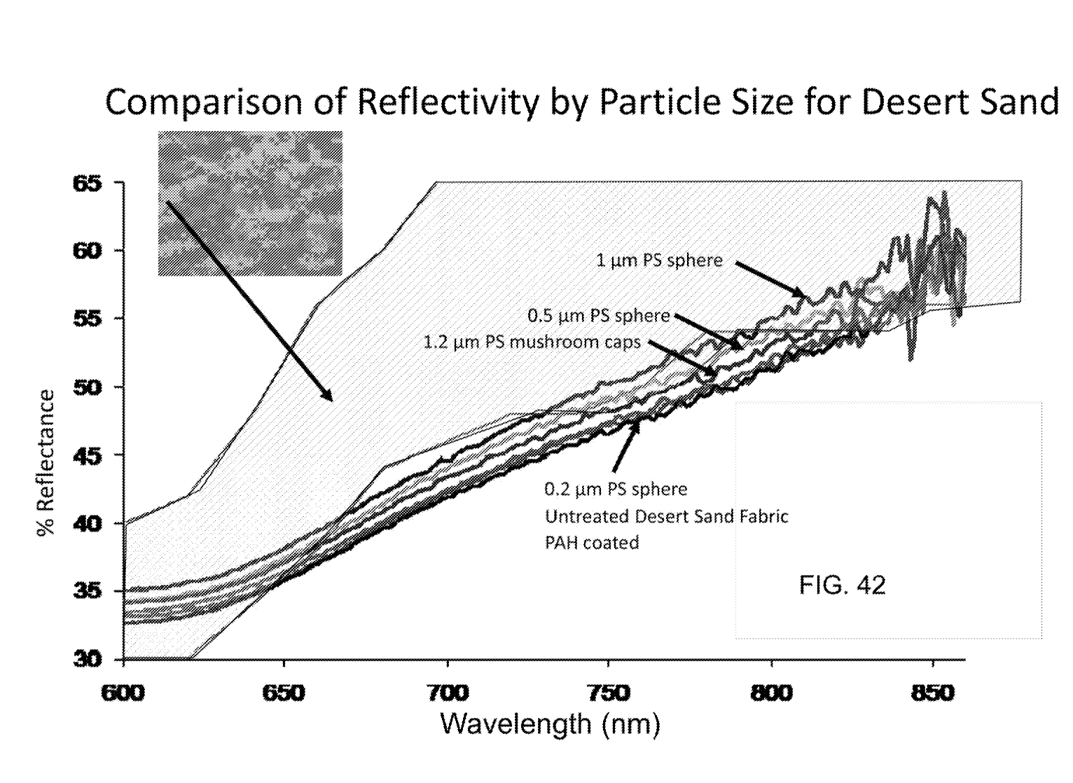

FIG. 42 shows a comparison of reflectivity by particle size for Desert Sand coated nylon/cotton blend camouflage fabric (US Army Natick Soldier Center). % reflectance is plotted as a function of wavelength (nm) from 600-850 nm. Comparisons were made among Desert Sand fabric coated with 0.2 μm polystyrene (PS) spheres, 0.5 μm PS spheres, 1.0 μm PS spheres, 1.2 μm PS “mushroom caps,” and with PAH-coated and untreated Desert Sand fabric, and are with arrows in FIG. 42.

Mushroom caps is a generic term used to described commercially available PS particles that have a convex-shaped side and a concave-shaped side (i.e., they resemble the shape of a mushroom cap.

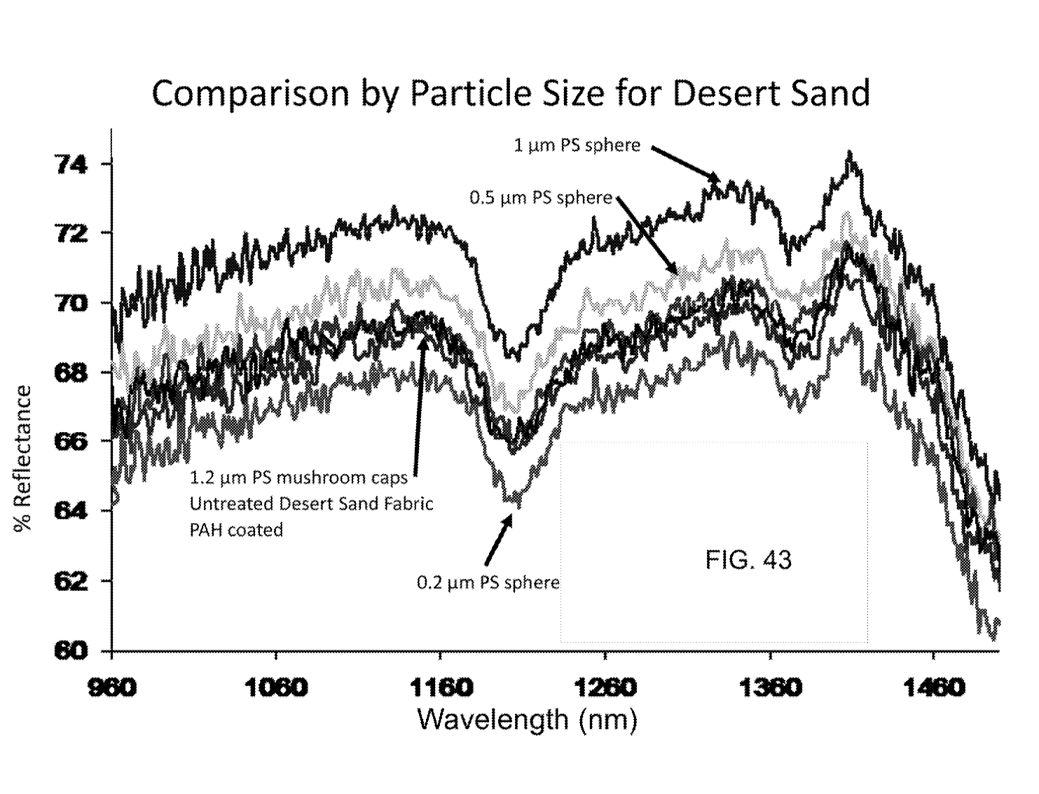

FIG. 43 shows a comparison of reflectivity by particle size for Desert Sand coated nylon/cotton blend camouflage fabric. % reflectance is plotted as a function of wavelength (nm) from 960-1500 nm. Comparisons were made among Desert Sand fabric coated with 0.2 μm PS spheres, 0.5 μm PS spheres, 1.0 μm PS spheres, 1.2 μm PS “mushroom caps,” and with PAH-coated and untreated Desert Sand fabric. % reflectance varied directly with size of the particles, which is indicated with arrows in FIG. 43.

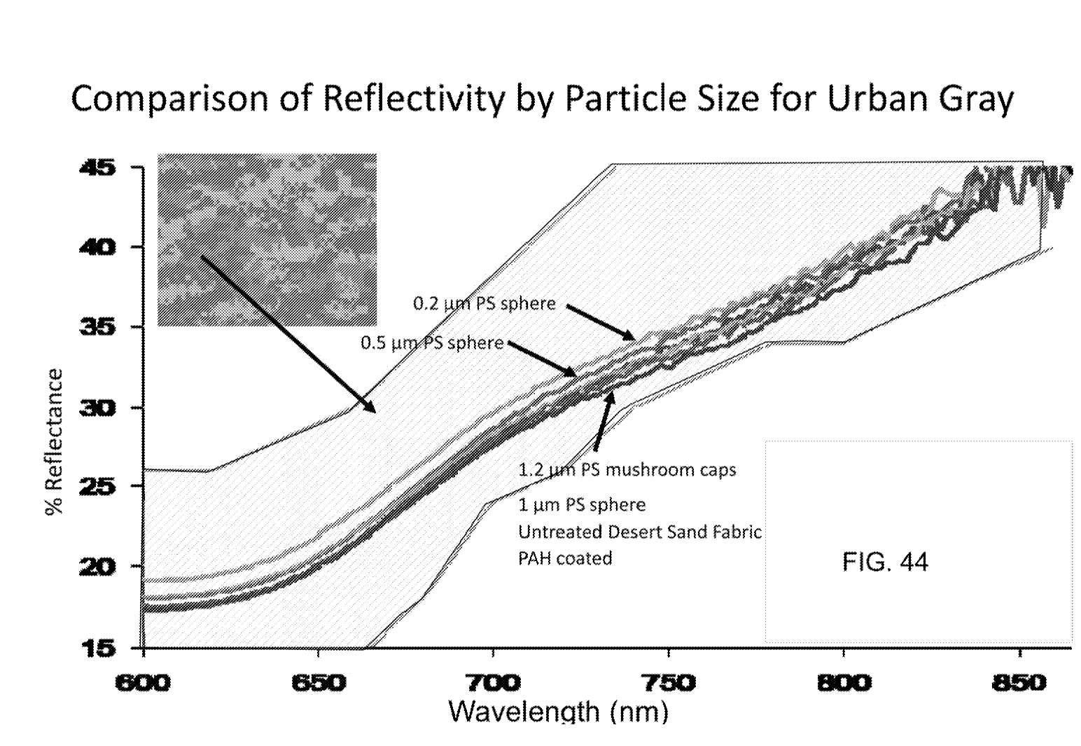

FIG. 44 shows a comparison of reflectivity by particle size for Urban Gray coated nylon/cotton blend camouflage fabric (US Army Natick Soldier Center). % reflectance is plotted as a function of wavelength (nm) from 600-850 nm. Comparisons were made among Urban Gray fabric coated with 0.2 μm PS spheres, 0.5 μm PS spheres, 1.0 μm PS spheres, 1.2 μm PS “mushroom caps,” and with PAH-coated and untreated Urban Gray fabric.

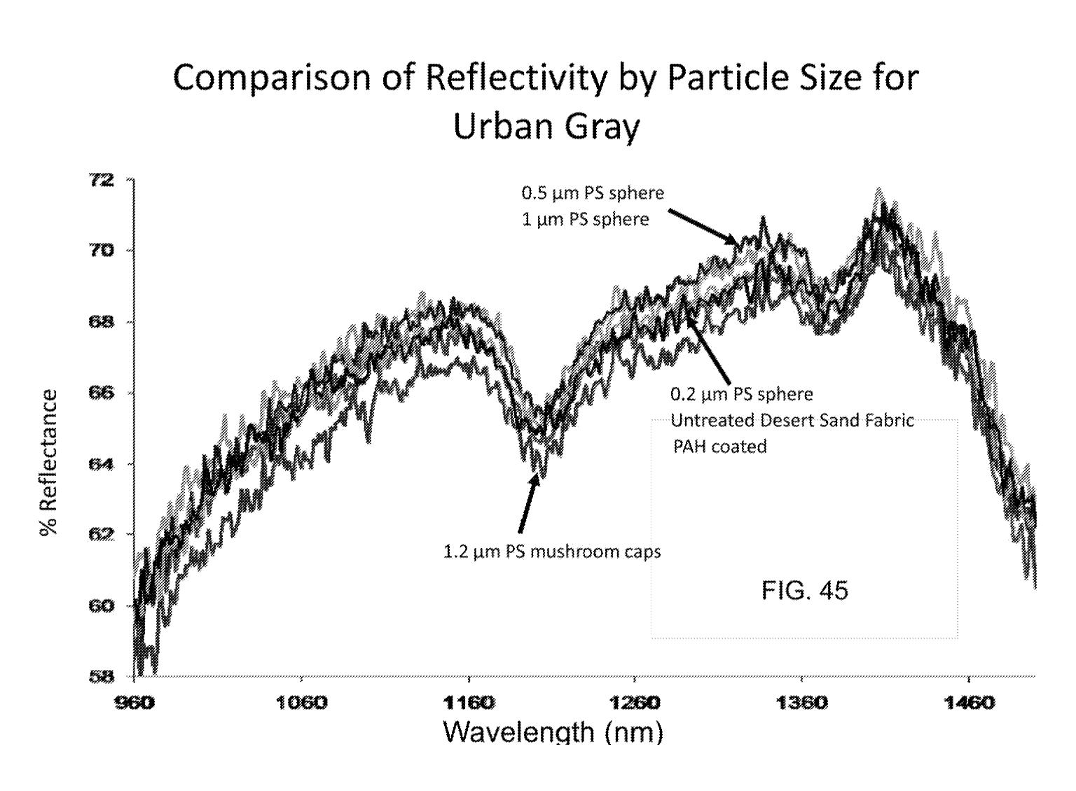

FIG. 45 shows a comparison of reflectivity by particle size for Urban Gray coated nylon/cotton blend camouflage fabric. % reflectance is plotted as a function of wavelength (nm) from 960-1460 nm. Comparisons were made among Urban Gray fabric coated with 0.2 μm PS spheres, 0.5 μm PS spheres, 1.0 μm PS spheres, 1.2 μm PS “mushroom caps,” and with PAH-coated and untreated Urban Gray fabric.

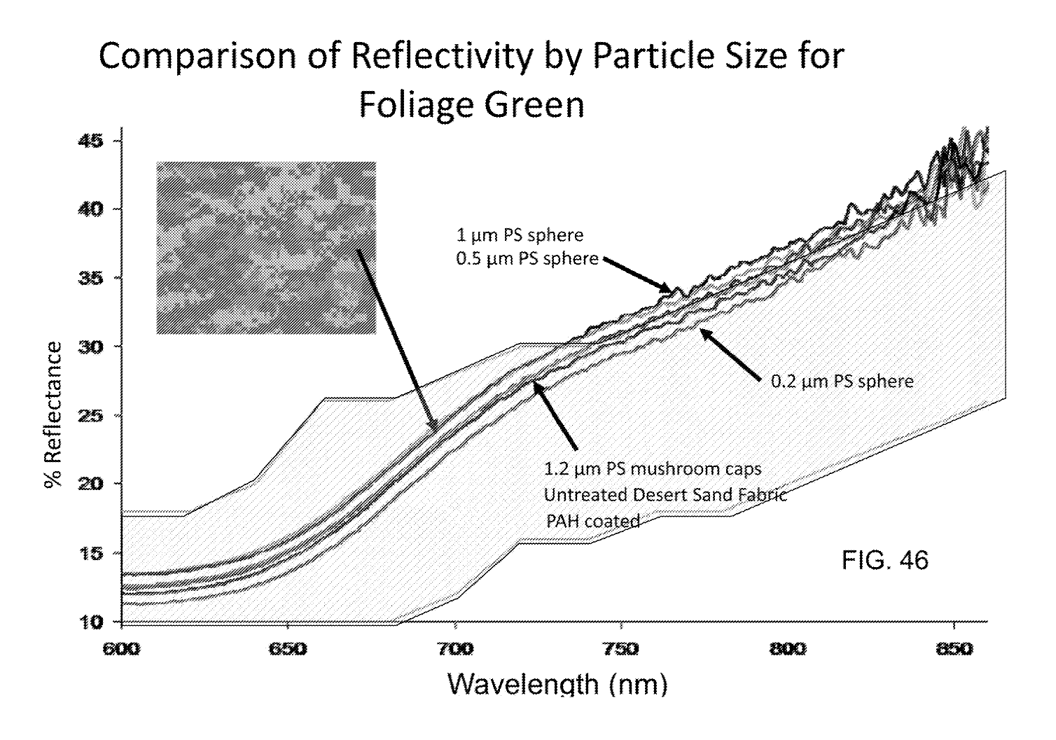

FIG. 46 shows a comparison of reflectivity by particle size for Foliage Green coated nylon/cotton blend camouflage fabric (US Army Natick Soldier Center). % reflectance is plotted as a function of wavelength (nm) from 600-850 nm. Comparisons were made among Foliage Green fabric coated with 0.2 μm PS spheres, 0.5 μm PS spheres, 1.0 μm PS spheres, 1.2 μm PS “mushroom caps,” and with PAH-coated and untreated Foliage Green fabric.

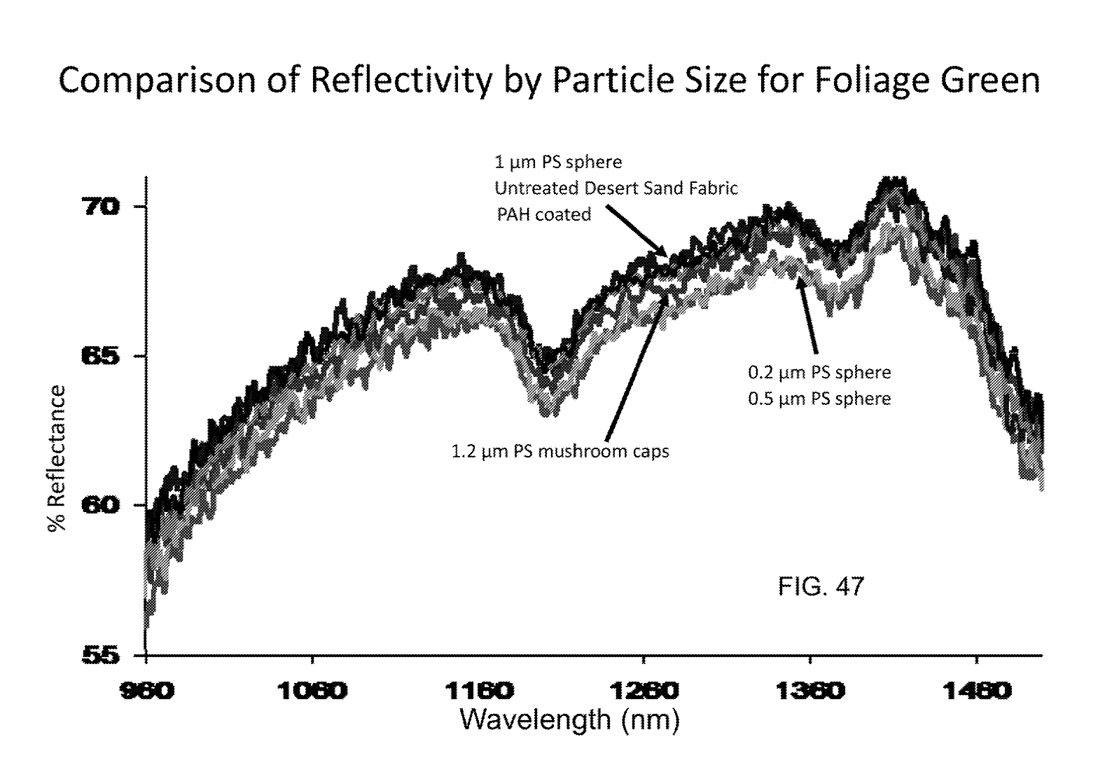

FIG. 47 shows a comparison of reflectivity by particle size for Foliage Green coated nylon/cotton blend camouflage fabric. % reflectance is plotted as a function of wavelength (nm) from 960-1500 nm Comparisons were made among Foliage Green fabric coated with 0.2 μm PS spheres, 0.5 μm PS spheres, 1.0 μm PS spheres, 1.2 μm PS “mushroom caps,” and with PAH-coated and untreated Foliage Green fabric.

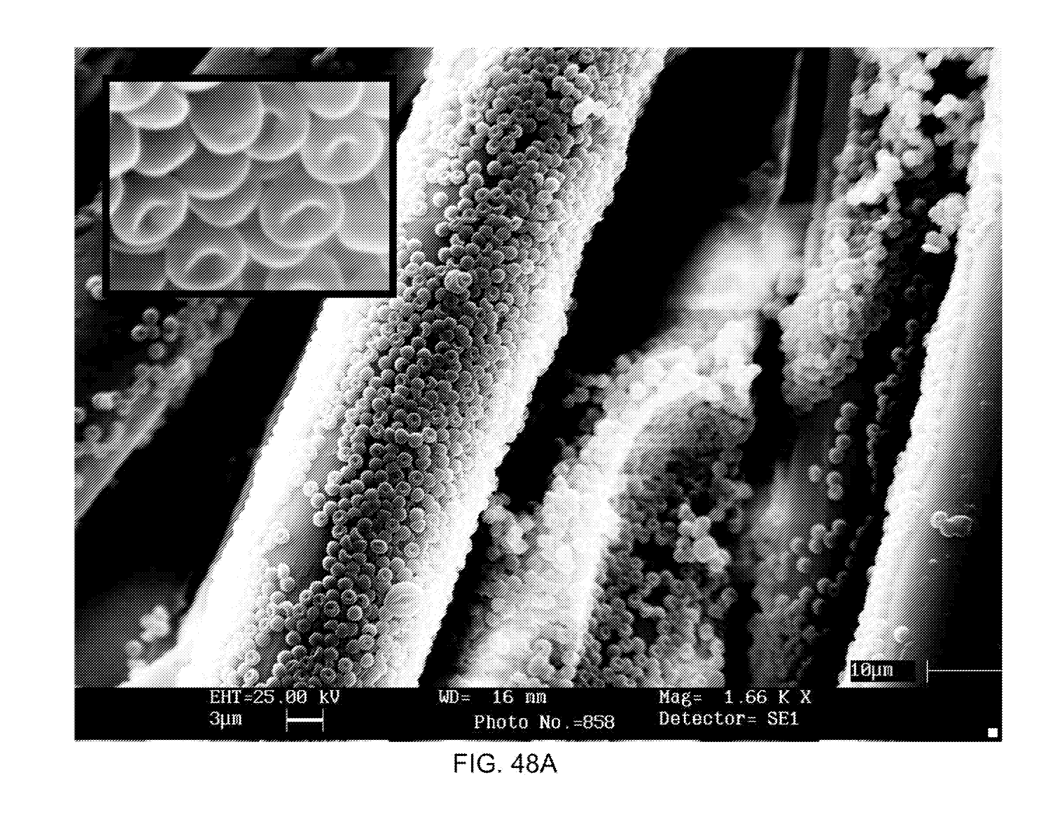

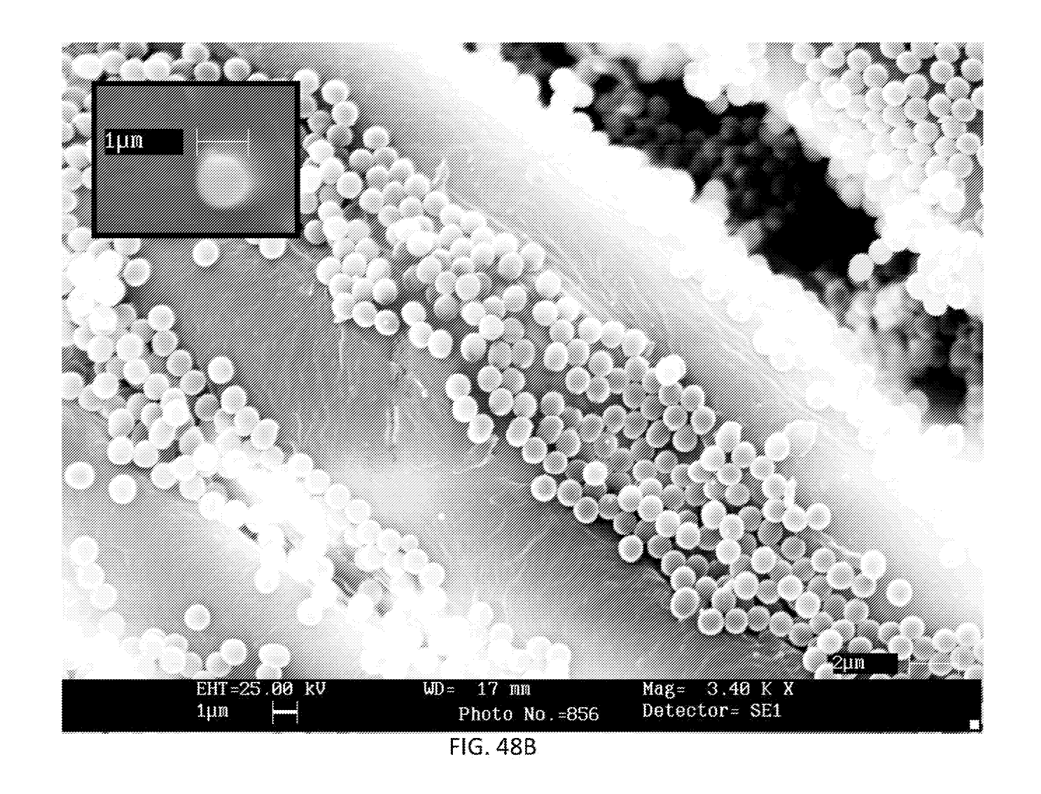

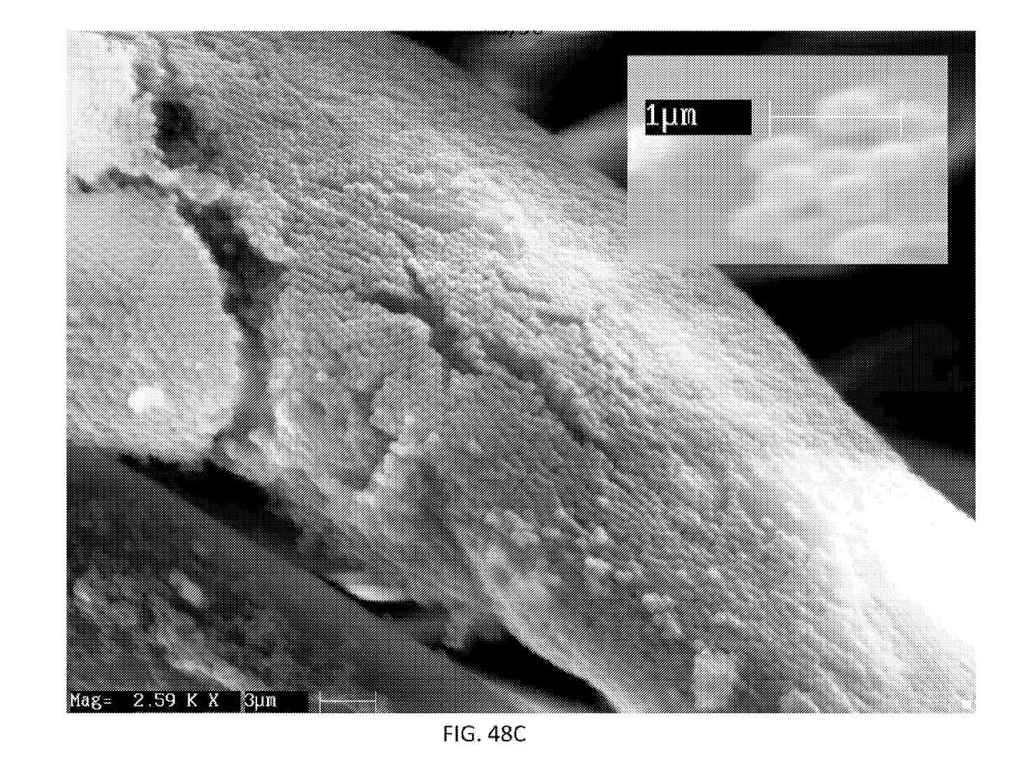

FIGS. 48A-D shows the scanning electron micrographs of the various polystyrene (PS) nanoparticle coatings on nylon/cotton blend camouflage fabric.

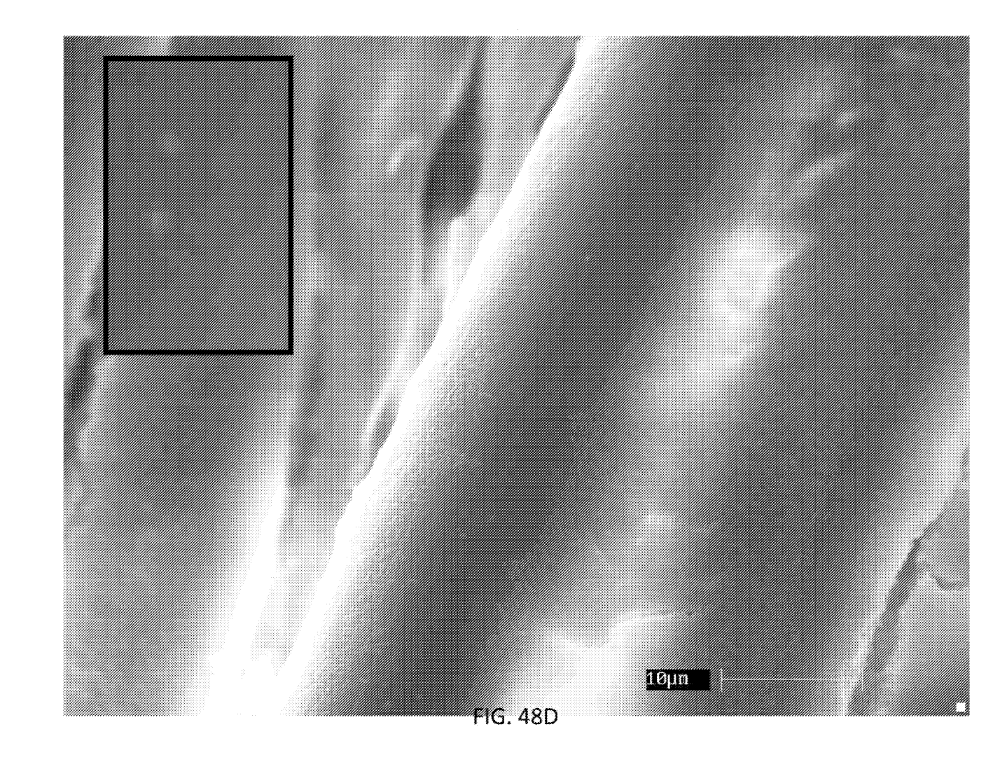

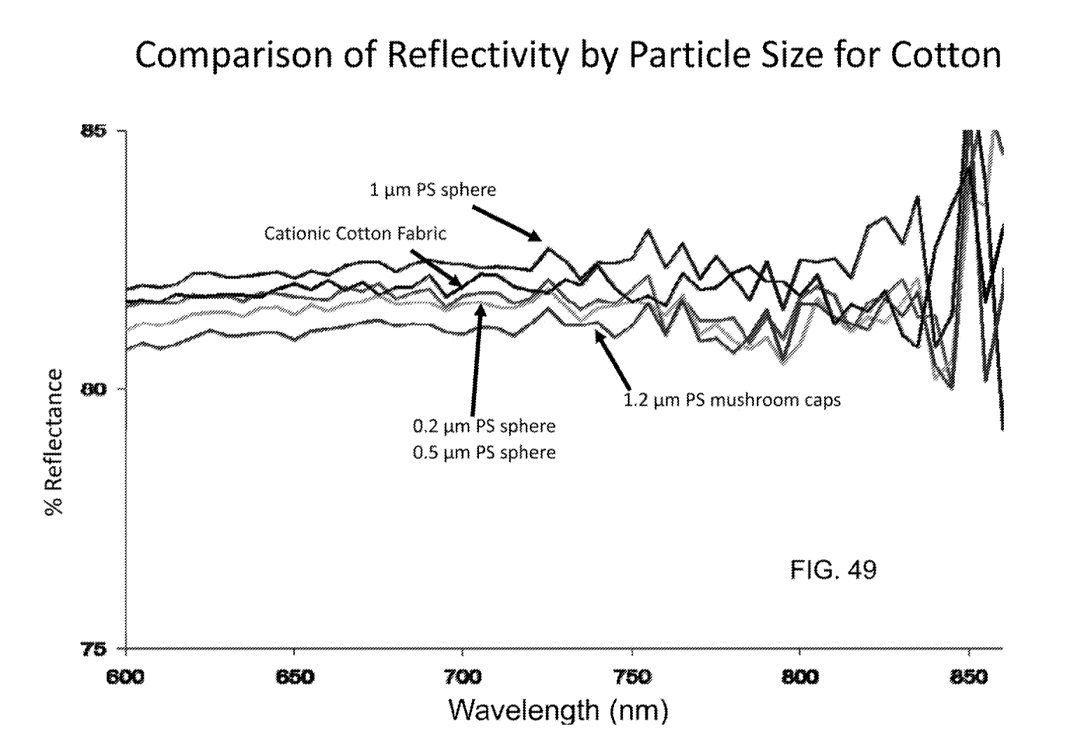

FIG. 49 shows a comparison of reflectivity by particle size for cationic cotton fabric. % reflectance is plotted as a function of wavelength (nm) from 600-850 nm. Comparisons were made among cotton fabric coated with 0.2 μm PS spheres, 0.5 μm PS spheres, 1.0 μm PS spheres, 1.2 μm PS “mushroom caps,” and with untreated cationic cotton fabric.

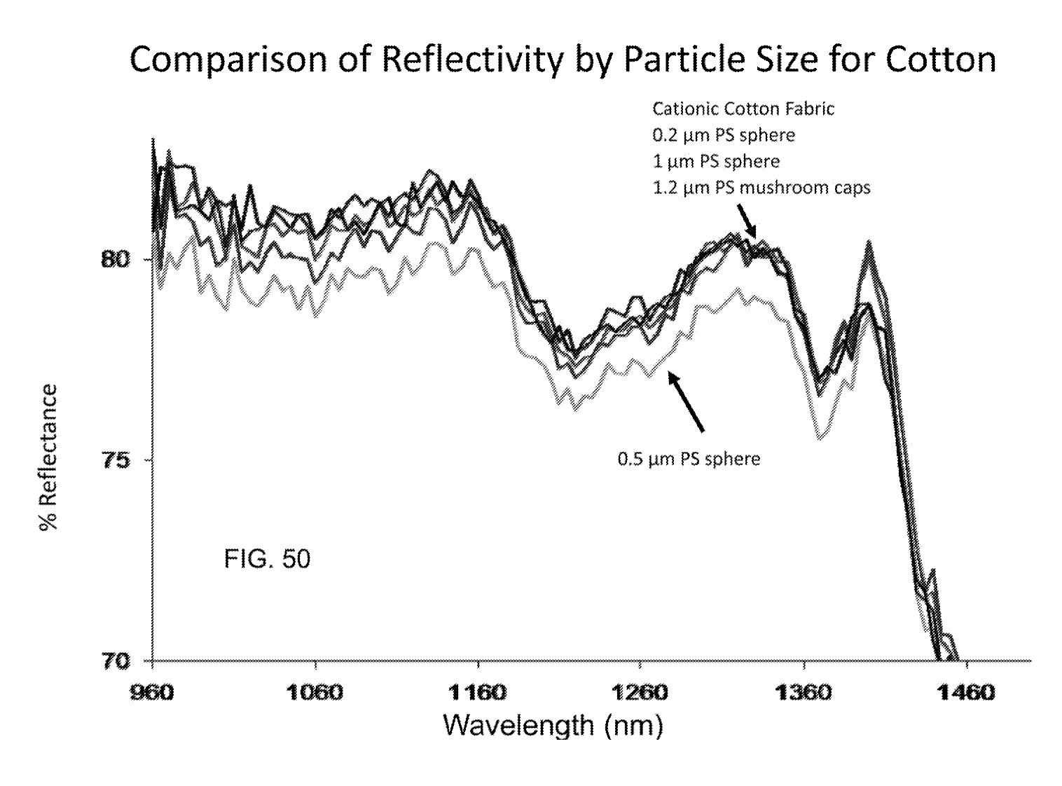

FIG. 50 shows a comparison of reflectivity by particle size for cationic cotton fabric. % reflectance is plotted as a function of wavelength (nm) from 960-1500 nm. Comparisons were made among cotton fabric coated with 0.2 μm PS spheres, 0.5 μm PS spheres, 1.0 μm PS spheres, 1.2 μm PS “mushroom caps,” and with untreated cationic cotton fabric.

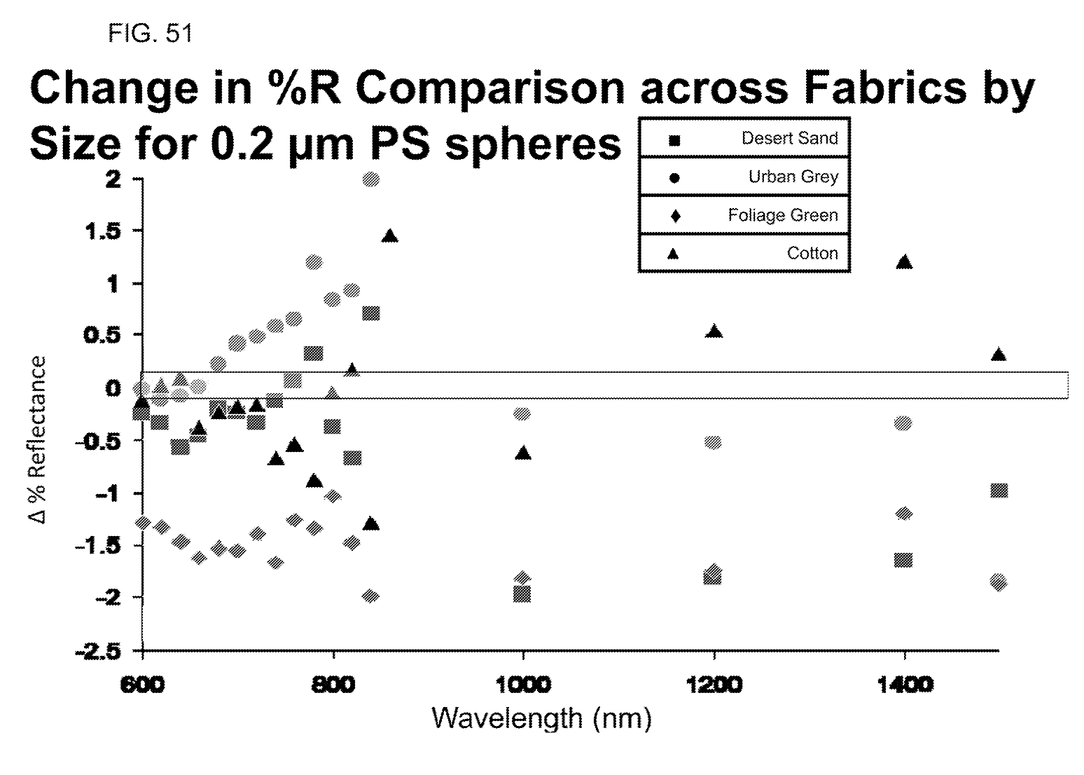

FIG. 51 compares the change in % reflectance across fabrics (Desert Sand, Urban Gray and Foliage Green camouflage fabric and cationic cotton fabric) coated with 0.2 μm PS spheres. Change in % reflectance is plotted as a function of wavelength (nm) from 600-1500 nm.

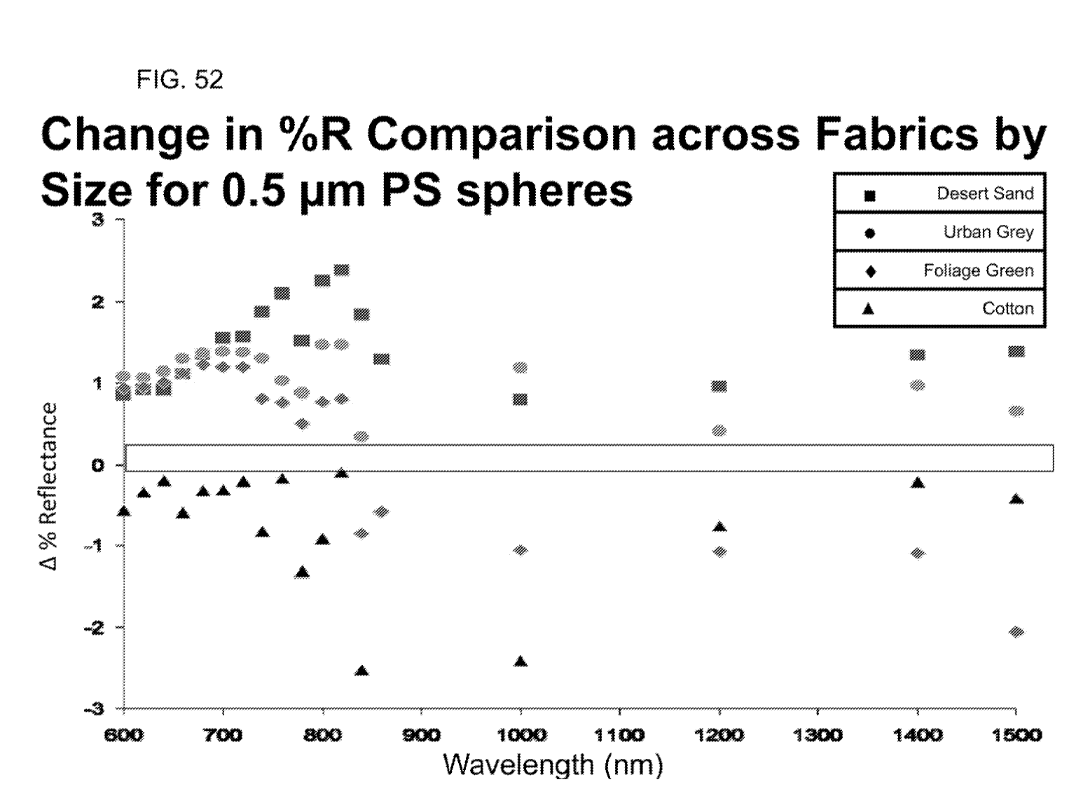

FIG. 52 compares the change in % reflectance across fabrics (Desert Sand, Urban Gray and Foliage Green camouflage fabric and cationic cotton fabric) coated with 0.5 μm PS spheres. Change in % reflectance is plotted as a function of wavelength (nm) from 600-1500 nm.

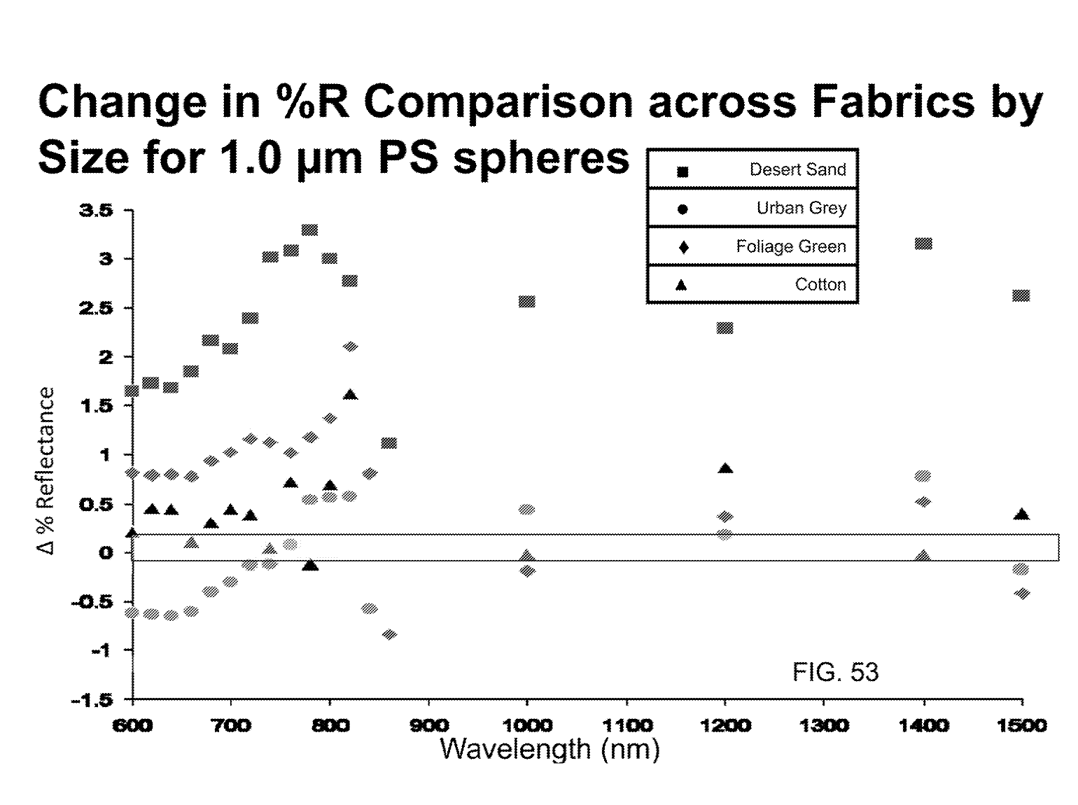

FIG. 53 compares the change in % reflectance across fabrics (Desert Sand, Urban Gray and Foliage Green camouflage fabric and cationic cotton fabric) coated with 1.0 μm PS spheres. Change in % reflectance is plotted as a function of wavelength (nm) from 600-1500 nm.

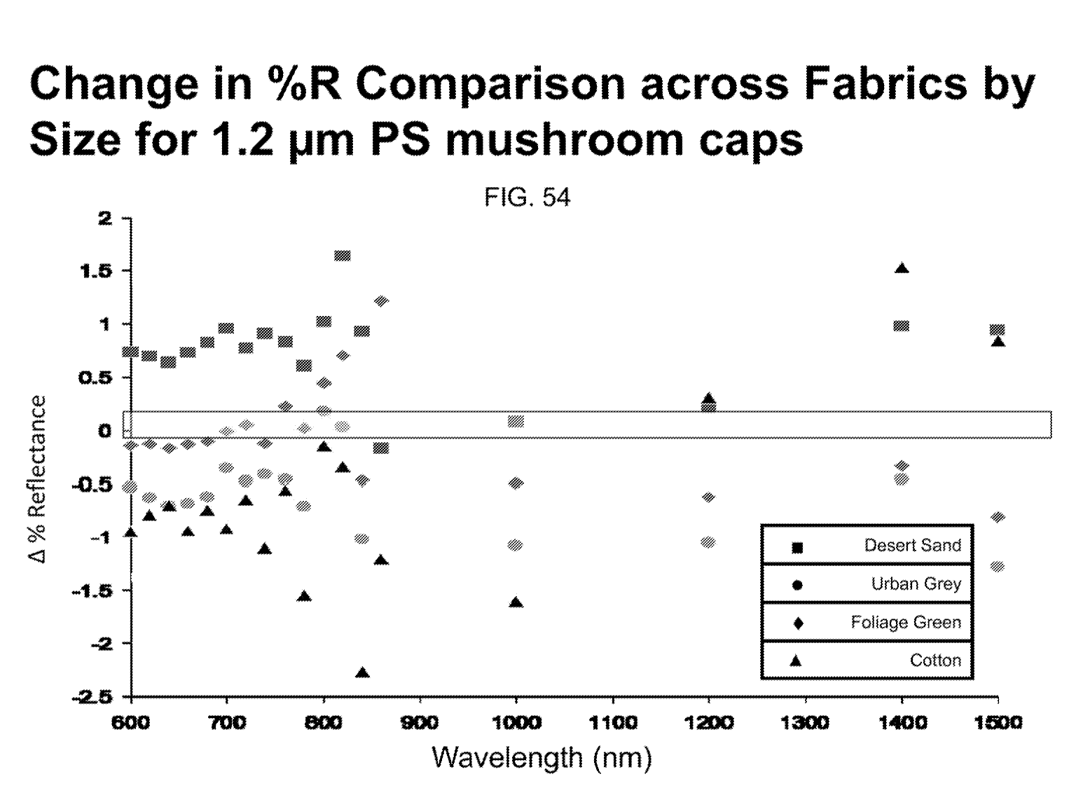

FIG. 54 compares the change in % reflectance across fabrics (Desert Sand, Urban Gray and Foliage Green camouflage fabric and cationic cotton fabric) coated with 1.2 μm PS mushroom caps. Change in % reflectance is plotted as a function of wavelength (nm) from 600-1500 nm.

### CONCLUSIONS

This example demonstrates that textile fabric can be modified using colloidal self-assembly of polystyrene (PS) nanoparticles to have less NIR reflectance, and hence, be less detectable by a night vision device (NVD). Such modification can be used to improve military camouflage against detection by a NVD. There is an effect of particle size on reflectivity, with the smallest particles tested (0.2 μm PS spheres) having the lowest reflectance. The largest particles and “mushroom cap” shaped particles have the highest reflectance.

This example further illustrates the feasibility of using colloidal particles to manipulate the near-infrared signature of a textile. Unlike previous work and published theories, the particles used to coat the fabric were similar in size to the wavelength of incident light. A combination of electrostatic and convective self-assembly methods were used to successfully deposit submicron and micron sized polystyrene spherical and non-spherical particles onto nylon and cotton fabrics. The particles were capable of conforming to the bends and twists of the textile fibers and coating the surface and subsurface fibers. The smaller particles, 200 and 500 nm spheres, achieved the best long range single layer coverage of the fabrics and film substrates tested. The larger particles, 1000 nm spheres and 1200 nm mushroom caps, formed single layer coverage, but the particles were prone to form agglomerates.

Analysis of the Vis-NIR reflectance spectra was used to calculate the average change in the % reflectance of the fabrics as a result of the particle coatings. The average change in % reflectance for desert sand nylon-cotton ranged from 0 to 6 units, with the 500 nm sphere coated having the highest change. The urban gray had a range in change in % reflectance of 0.5 to 3.5, with the 1000 nm sphere coated having the highest change. The foliage green nylon-cotton change in % reflectance ranged from −1 to 3.5, with the 200 nm coated fabric having a reduction in reflectance and the 1000 nm having the highest change in reflectance.

The cationic cotton had a range of change in % reflectance of −3 to 6, with the mushroom caps having the greatest reduction in reflectance of all the substrates and the 500 nm spheres most change in reflectance on the cotton.

For most cases there was an increase in reflectance based on the average reflectance spectra. However, by using the areas bounded by the upper and lower 95% confidence intervals of the average spectra and the standard deviation, overlaps of the particle coated region and the uncoated region indicate that the particle coated samples statistically can have lower reflectance than the uncoated. Based on this analysis, there were several particle coatings, which in some portion of the region tested, had reflectance lower than the upper 95% confidence interval (CI) of the corresponding uncoated substrate. For some the reflectance fell below the lower 95% CI for the uncoated substrate. For the desert sand nylon-cotton, the 200 nm spheres, 500 nm spheres, and 1200 nm mushroom caps had portions of their 95% CI areas overlapping the uncoated, meaning their reflectance can be reduced. For urban gray nylon-cotton, all of the coatings tested overlapped the uncoated 95% CI area at some point during the tested wavelength range. The 200 nm spheres and the mushroom caps have potential for reducing reflectance of the foliage green nylon-cotton based on the overlap of the uncoated 95% CI range. The mushroom caps were the only coating that showed reduction on cotton. These results indicate that a reduction in reflectance and tailor-ability can be achieved in military camouflage.

The present invention is not to be limited in scope by the specific embodiments described herein. Indeed, various modifications of the invention in addition to those described herein will become apparent to those skilled in the art from the foregoing description. Such modifications are intended to fall within the scope of the appended claims.

All references cited herein are incorporated herein by reference in their entirety and for all purposes to the same extent as if each individual publication, patent or patent application was specifically and individually indicated to be incorporated by reference in its entirety for all purposes.

The citation of any publication is for its disclosure prior to the filing date and should not be construed as an admission that the present invention is not entitled to antedate such publication by virtue of prior invention.

1. A conformal coating for deposition on a non-planar surface of a substrate comprising a plurality of chemically functional particles, wherein:
the particles are functionalized with one or more species of spectroscopically-active molecules,
the particles have a cross-sectional diameter of 2-2000 nm,
the average distance between adjacent particles across the entire non-planar surface is no greater than 10 times the largest cross-sectional dimension of any particle in the plurality,
the attachment of the particles to the surface is through electrostatic self-assembly or covalent bonding, and
the particle-coated non-planar surface exhibits enhanced spectroscopic properties for localized spectroscopically-active molecules.

2. The coating of claim 1 wherein the species of spectroscopically-active molecules are Raman-active, SERS-active, infrared-active, SEIRA-active, SEF-active or fluorescent molecules.

3. The coating of claim 1 wherein the Raman-active, SERS-active, infrared-active or SEIRA-active molecules are spaced within 8 nm of the particle surface or have functionality that provides molecule coordination to the particles.

4. The coating of claim 1 wherein the SEF-active or fluorescent molecules are spaced at a distance of between 3 nm and 60 nm from the particle surface.

5. (canceled)

6. The coating of claim 1 wherein the particles are assembled on the non-planar surface to provide a uniform plasmon absorption band of the non-planar surface that is in the range of 400-2000 nm.

7. The coating of claim 1 wherein the substrate is a polymer.

8. The coating of claim 1 wherein the substrate comprises a plurality of fibers.

9. The coating of claim 8 wherein the fibers have cross-sectional diameters of 10 nm-100 μm.

10. The coating of claim 8 wherein the fibers are organic or inorganic.

11. The coating of claim 1 wherein the substrate is a textile.

12. The coating of claim 11 wherein the textile is a woven textile, a non-woven textile, a woven composite, a knit, a braid or a yarn.

13. The coating of claim 1 wherein the substrate comprises natural or synthetic carbohydrate-based fibers.

14. The coating of claim 13 wherein the natural or synthetic carbohydrate-based fibers comprise cellulose, cellulose acetate or cotton.

15. The coating of claim 1 wherein the substrate comprises natural protein-based fibers.

16. The coating of claim 15 wherein the natural protein-based fibers comprise wool, collagen or silk.

17. The coating of claim 1 wherein the substrate comprises organic synthetic fibers capable of participating in hydrogen bonding.

18. The coating of claim 17 wherein the organic synthetic fibers comprise polyamides, polycarboxylic acids, polysaccharides, polyalcohols, polyamines, polyaminoacids, polyvinylpyrrolidone, polyethylene oxide or specialized fibers of block copolymers having nucleobase functionality.

19. (canceled)

20. The coating of claim 1 wherein the particles comprise metal or metal oxide.

21. (canceled)

22. The coating of claim 1 wherein the metal or metal oxide is Au, Ag, Cu, Pt, or Pd, ZnO, TiO₂, or SnO.

23-26. (canceled)

27. The coating of claim 1 wherein the particles are functionalized metal particles, functionalized metal oxide particles, functionalized non-metal oxide particles or functionalized organic polymeric particles.

28. A polymeric non-planar surface comprising the conformal coating of claim 1.

29. A method for surface-bonding particles to a non-planar surface of a substrate to produce a conformal coating comprising the steps of:
(a) providing a substrate comprising a non-planar surface;
(b) chemically modifying the non-planar surface to impart a surface charge;
(c) depositing complementary charged particles on the non-planar surface, and
(d) functionalizing the surface-bonded metallic particles with one or more species of spectroscopically-active molecules, thereby producing the conformal coating of surface-bonded particles, wherein:
the surface-bonded particles have cross-sectional diameters of 2-2000 nm,
the average distance between adjacent surface-bonded particles across the entire non-planar surface is no greater than 10 times the largest cross-sectional dimension of any of the surface-bonded particles, and
the attachment of the surface-bonded particles to the surface is through electrostatic self-assembly or covalent bonding.

30. A method for surface-bonding metallic particles to a non-planar surface of a substrate to produce a conformal coating comprising the steps of:
(a) providing a substrate comprising a non-planar surface;
(b) depositing complementary charged metal ions or complementary charged metal complexes on the non-planar surface;
(c) treating the complementary charged metal ions or complementary charged metal complexes deposited on the non-planar surface with a treatment selected from the group consisting of treating with a reducing agent, treating with a base or heating; and
(d) functionalizing the surface-bonded metallic particles with one or more species of spectroscopically-active molecules, thereby producing the conformal coating of surface-bonded metallic particles, wherein:
the surface-bonded particles have cross-sectional diameters of 2-2000 nm,
the average distance between adjacent surface-bonded particles across the entire non-planar surface is no greater than 10 times the largest cross-sectional dimension of any of the surface-bonded particles, and
the attachment of the surface-bonded particles to the surface is through electrostatic bonding.

31. A method for surface-bonding particles to a chemically modified non-planar surface of a substrate to produce a conformal coating comprising the steps of:
(a) providing a substrate comprising a chemically modified non-planar surface; and
(b) covalently attaching chemically functional particles to the chemically modified non-planar surface; and
(c) functionalizing the surface-bonded metallic particles with one or more species of spectroscopically-active molecules, thereby producing the conformal coating of surface-bonded particles, wherein:
the surface-bonded particles have cross-sectional diameters of 2-2000 nm,
the average distance between adjacent surface-bonded particles across the entire non-planar surface is no greater than 10 times the largest cross-sectional dimension of any of the surface-bonded particles, and
the attachment of the surface-bonded particles to the surface is through covalent bonding.

32. A method for surface-bonding particles to a non-planar surface of a substrate to produce a conformal coating comprising the steps of:
(a) providing a substrate comprising a non-planar surface wherein the non-planar surface comprises hydrogen bond donors/acceptors; and
(b) depositing chemically functional particles on the non-planar surface; and
(c) functionalizing the surface-bonded metallic particles with one or more species of spectroscopically-active molecules, thereby producing the conformal coating of surface-bonded particles, wherein:
the chemically functional particles comprise hydrogen bond donors/acceptors,
hydrogen bonding occurs between the hydrogen bond donors/acceptors on the particles and complementary hydrogen bond donors/acceptors on the non-planar surface,
the surface-bonded particles have cross-sectional diameters of 2-2000 nm,
the average distance between adjacent surface-bonded particles across the entire non-planar surface is no greater than 10 times the largest cross-sectional dimension of any of the surface-bonded particles, and
the attachment of the surface-bonded particles to the surface is through electrostatic self-assembly mediated by hydrogen bonding.

33. A method for surface-bonding particles to a non-planar surface of a substrate to produce a conformal coating comprising the steps of:
(a) providing a substrate comprising a non-planar surface;
(b) plasma-treating the non-planar surface to impart a surface charge;
(c) depositing complementary charged particles on the non-planar surface, producing the conformal coating of surface-bonded particles; and
(d) functionalizing the surface-bonded metallic particles with one or more species of spectroscopically-active molecules, thereby producing the conformal coating of surface-bonded particles, wherein:
the surface-bonded particles have cross-sectional diameters of 2-2000 nm,
the average distance between adjacent surface-bonded particles across the entire non-planar surface is no greater than 10 times the largest cross-sectional dimension of any of the surface-bonded particles, and
the attachment of the surface-bonded particles to the surface is through electrostatic self-assembly.

34. A method for surface-bonding metallic particles to a non-planar surface of a substrate to produce a conformal coating comprising the steps of:
(a) providing a substrate comprising a non-planar surface;
(b) plasma-treating the non-planar surface to impart a surface charge;
(c) depositing complementary charged metal ions or complementary charged metal complexes on the non-planar surface;
(d) treating the complementary charged metal ions or complementary charged metal complexes deposited on the non-planar surface with a treatment selected from the group consisting of treating with a reducing agent, treating with a base or heating; and
(e) functionalizing the surface-bonded metallic particles with one or more species of spectroscopically-active molecules, thereby producing the conformal coating of surface-bonded particles, wherein:
the surface-bonded particles have cross-sectional diameters of 2-2000 nm,
the average distance between adjacent surface-bonded particles across the entire non-planar surface is no greater than 10 times the largest cross-sectional dimension of any of the surface-bonded particles, and
the attachment of the surface-bonded particles to the surface is through electrostatic bonding.

35. The method of any one of claims 29-34 wherein the species of spectroscopically-active molecules are Raman-active, SERS-active, infrared-active, SEIRA-active, SEF-active or fluorescent molecules.

36. The method of any one of claims 29-34 wherein the Raman-active, SERS-active, infrared-active or SEIRA-active molecules are spaced within 8 nm of the particle surface or have functionality that provides molecule coordination to the particles.

37. The method of any one of claims 29-34 wherein the SEF-active or fluorescent molecules are spaced at a distance of between 3 nm and 60 nm from the particle surface.

38-39. (canceled)

40. The method of any one of claims 29-34 wherein the substrate comprises a plurality of fibers.

41. The method of claim 40 wherein the fibers have cross-sectional diameters of 10 nm-100 μm.

42-48. (canceled)

49. The method of any one of claims 29-34 wherein the substrate is a textile.

50. The method of claim 49 wherein the textile is a woven textile, a non-woven textile, a woven composite, a knit, a braid or a yarn.

51-52. (canceled)

53. The method of any one of claims 29-34 wherein the metallic particles comprise metal or metal oxide.

54-59. (canceled)

60. The method of claim 29 wherein step (b) comprises using a charged organic molecule, an organic molecule that becomes charged after reacting with the non-planar surface or an ionizing chemical reagent to chemically modify the non-planar surface to impart the surface charge.

61. The method of claim 30 wherein step (c) comprises using a charged organic molecule, an organic molecule that becomes charged after reacting with the non-planar surface or an ionizing chemical reagent to treat the complementary charged metal ions or complementary charged metal complexes deposited on the non-planar surface.

62-74. (canceled)
